(19) United States
(12) Patent Application Publication
(10) Pub. No.: US 2005/0033520 A1
(43) Pub. Date: Feb. 10, 2005

(54) Methods and compositions for utilizing changes of hybridization signals during approach to equilibrium

(76) Inventors: Hongyue Dai, Bothell, WA (US); Michael Meyer, San Diego, CA (US); Roland Stoughton, San Diego, CA (US)

Correspondence Address: JONES DAY, 222 EAST 41ST ST, NEW YORK, NY, 10017, US

(21) Appl. No.: 10/475,960

(22) PCT Filed: Apr. 24, 2002
(86) PCT No.: PCT/US02/12757

Related U.S. Application Data
(60) Provisional application No. 60/286,588, filed on Apr. 26, 2001.
(60) Provisional application No. 60/309,067, filed on Jul. 31, 2001.

(51) Int. Cl. G06F 19/00

(52) U.S. Cl. 702/19

(57) ABSTRACT

The present invention provides methods for utilizing the changes of hybridization levels in time during approach to equilibrium duplex formation for identifying specific hybridization to polynucleotide probes. In the invention, the changes of hybridization levels at one or more polynucleotide probes by a sample comprising a plurality of nucleic acid molecules having different sequences are monitored during their progress towards equilibrium and the continuing increase of hybridization signals beyond cross-hybridization is used as an indication of specific binding. The invention also provides methods of comparing specificities of different polynucleotides probes. The invention further provides methods for ranking and selecting polynucleotide probes that are specific to particular nucleic acids and methods for enhancing the detection of nucleic acids. The invention further provides methods for determining the orientation of nucleotide sequences.

This application claims the benefit, under 35 U.S.C. § 119(e), of U.S. Provisional Patent Application No. 60/286,588, filed on Apr. 26, 2001, and of U.S. Provisional Patent Application No. 60/309,067, filed on Jul. 31, 2001, all of which are incorporated herein by reference in their entireties.

### 1. FIELD OF THE INVENTION

The present invention relates to methods and compositions for utilizing changes of hybridization levels during approach to hybridization equilibrium. In particular, the invention relates to methods for identifying specific hybridization to polynucleotide probes. The invention also relates to methods of comparing specificities of different polynucleotide probes. The invention further relates to methods for ranking and selecting polynucleotide probes that are specific to particular nucleic acids and methods for enhancing the detection of nucleic acids.

### 2. BACKGROUND OF THE INVENTION

Rapid and accurate determination of the identities and abundances of nucleic acid species in a sample containing many different nucleic acid sequences is of great interest in biological and medical fields, e.g., in gene discovery and expression profiling. Presently, methods based on DNA arrays are widely used for the detection and measurement of particular sequences in complex samples. In such methods the identity and abundance of a nucleic acid sequence in a sample is determined by measuring the level of hybridization of the nucleic acid sequence to probes that comprise complementary sequences.

Although various formats of DNA arrays are currently used, all DNA array technologies employ nucleic acid “probes,” (i.e., nucleic acid molecules having defined sequences) to selectively hybridize to, and thereby identifying and measuring the abundances of, complementary nucleic acid sequences in a sample. In these technologies, a set of nucleic acid probes, each of which has a defined sequence, is immobilized on a solid support in such a manner that each different probe is immobilized to a predetermined region. The set of immobilized probes or the array of immobilized probes is contacted with a sample containing labeled nucleic acid species so that nucleic acids having sequences complementary to an immobilized probe hybridize or bind to the probe. After separation of, e.g., by washing off, any unbound material, the bound, labeled sequences are detected and measured. The amount of labeled sequence hybridized to each probe in the array is used as a measure of the abundance of the sequence species in the cells (see, e.g., Schena et al., 1995, Science 270:467-470; Lockhart et al., 1996, Nature Biotechnology 14:1675-1680; Blanchard et al., 1996, Nature Biotechnology 14:1649; Ashby et al., U.S. Pat. No. 5,569,588). Using DNA array expression assays, complex mixtures of labeled nucleic acids, e.g., mRNAs or nucleic acids derived from mRNAs from a cell or a population of cells, can be analyzed.

DNA array technologies have made it possible, inter alia, to monitor the expression levels of a large number of genetic transcripts at any one time (see, e.g., Schena et al., 1995, Science 270:467-470; Lockhart etal., 1996, Nature Biotechnology 14:1675-1680; Blanchard et al, 1996, Nature Biotechnology 14:1649; Ashby et al., U.S. Pat. No. 5,569,588, issued Oct. 29, 1996; Shoemaker et al., U.S. patent application Ser. No. 09/724,538, filed on Nov. 28, 2000). DNA array technologies have also found applications in gene discovery, e.g., in identification of exon structures of genes (see, e.g., Shoemaker et al., U.S. patent application Ser. No. 09/724,538, filed on Nov. 28, 2000). Of the two main formats of DNA arrays, spotted DNA arrays are prepared by depositing DNA fragments with sizes ranging from about a few tens of bases to a few kilobases onto a suitable surface (see, e.g., DeRisi et al., 1996, Nature Genetics 14:457460; Shalon et al., 1996, Genome Res. 6:689-645; Schena et al., 1995, Proc. Natl. Acad. Sci. U.S.A. 93:10539-11286; and Duggan et al., Nature Genetics Supplement 21:10-14). For example, in blotting assays, such as dot or Southern Blotting, nucleic acid molecules may be first separated, e.g., according to size by gel electrophoresis, transferred and immobilized to a membrane filter such as a nitrocellulose or nylon membrane, and allowed to hybridize to a single labeled sequence (see, e.g., Nicoloso, M. et al., 1989, Biochemical and Biophysical Research Communications 159:1233-1241; Vernier, P. et al., 1996, Analytical Biochemistry 235:11-19). Spotted cDNA arrays are prepared by depositing PCR products of cDNA fragments with sizes ranging from about 0.6 to 2.4 kb, from full length cDNAs, ESTs, etc., onto a suitable surface (see, e.g., DeRisi et al, 1996, Nature Genetics 14:457-460; Shalon et al., 1996, Genome Res. 6:689-645; Schena et al., 1995, Proc. Natl. Acad Sci U.S.A. 93:10539-11286; and Duggan et al., Nature Genetics Supplement 21:10-14). Alternatively, high-density oligonucleotide arrays containing thousands of oligonucleotides complementary to defined sequences, at defined locations on a surface are synthesized in situ on the surface by, for example, photolithographic techniques (see, e.g., Fodor et al., 1991, Science 251:767-773; Pease et al, 1994, Proc. Natl. Acad. Sci. U.S.A. 91:5022-5026; Lockhart et al, 1996, Nature Biotechnology 14:1675; U.S. Pat. Nos. 5,578,832; 5,556,752; 5,510,270; 5,445,934; 5,744,305; and 6,040,138). Methods for generating arrays using inkjet technology for in situ oligonucleotide synthesis are also known in the art (see, e.g., Blanchard, International Patent Publication WO 98/41531, published Sep. 24, 1998; Blanchard et al., 1996, Biosensors and Bioelectronics 11:687-690; Blanchard, 1998, in Synthetic DNA Arrays in Genetic Engineering, Vol. 20, J. K. Setlow, Ed., Plenum Press, New York at pages 111-123).

However, as is well known in the art, although hybridization is selective for complementary sequences, other sequences which are not perfectly complementary may also hybridize to a given probe at some level. Binding affinity of target nucleic acids to surface immobilized probe sequences during hybridization depends on both the sequence similarity of different target sequences in a sample and the hybridization stringency condition, e.g., the hybridization temperature and the salt concentrations. Binding kinetics also depends on the relative concentrations of different nucleic acids in a sample. Therefore, when measured at a given time under a given hybridization stringency condition, different target sequences with different degrees of similarity may hybridize to a given probe at different degrees. For polynucleotide probes targeted at, i.e., complementary to, low-abundance species, or target at nucleic acid species of closely resembled (i.e., homologous) sequences, such “cross-hybridization” can significantly contaminate and confuse the results of hybridization measurements. For example, cross-hybridization is a particularly significant concern in the detection of single nucleotide polymorphisms (SNP's) since the sequence to be detected (i.e., the particular SNP) must be distinguished from other sequences that differ by only a single nucleotide.

Several approaches have been devised to reduce cross-hybridization. Cross-hybridization can be minimized by regulating either the hybridization stringency condition, e.g., the temperature and salt concentrations, during hybridization and/or during post-hybridization washings. For example, “highly stringent” wash conditions may be employed so as to destabilize the majority of but the most stable duplexes such that measured hybridization signals represent the abundances of sequences that hybridize most specifically, and are therefore the most complementary, to a given probe. Exemplary highly stringent conditions include, e.g., hybridization to filter-bound DNA in 5×SSC, 1% sodium dodecyl sulfate (SDS), 1 mM EDTA at 65° C., and washing in 0.1×SSC/0.1% SDS at 68° C. (Ausubel et al., eds., 1989, Current Protocols in Molecular Biology, Vol., Green Publishing Associates, Inc., and John Wiley & Sons, Inc., New York, N.Y., at p. 2.10.3). Highly stringent conditions allow detection of allelic variants of a nucleotide sequence, e.g., about 1 mismatches per 10-30 nucleotides. Alternatively, “moderate-” or “low-stringency” wash conditions may be used to allow identification of sequences which are similar, but not identical, to the perfectly complementary sequence to a given probe, such as sequences from different members of a multi-gene family, or homologous genes in different organisms. Moderate- or low-stringency conditions are also well known in the art (see, e.g., Sambrook et al., supra; Ausubel, F. M. et al., supra). Exemplary moderately stringent wash conditions include, e.g., washing in 0.2×SSC/0.1% SDS at 42° C. (Ausubel et al., 1989, supra). Exemplary low-stringency washing conditions include, e.g., washing in 5×SSC or in 0.2×SSC/0.1% SDS at room temperature (Ausubel et a!, 1989, supra). A ‘high’ stringency condition for one sequence could be a ‘moderate’ or even ‘low’ stringency condition for another sequence.

The effect of cross-hybridization on measured hybridization levels can also be reduced by selecting and using polynucleotide probes that are most specific for a particular target nucleic acid molecule of interest. For example, sensitivity- and specificity-based probe design and selection methods are developed (see, e.g., PCT publication WO 01/05935). Multiple different oligonucleotide probes which are complementary to different, distinct sequences of a target nucleic acid are also used (see, e.g., Lockhart et al. (1996) Nature Biotechnology 14:1675-1680; Graves et al. (1999) Trends in Biotechnology 17:127-134).

Contributions of cross-hybridization to measured hybridization levels can also be removed by subtracting signals from suitable reference probes which serve to measure the levels of cross-hybridization. In one example, polynucleotide probes having intentional mismatches are used as the reference probes. The hybridization to (or dissociation from) the target nucleic acid molecule is compared to that of the perfect match oligonucleotide probe so that a cross-hybridization component may be subtracted from the total hybridization signal (see, e.g., Graves et al., supra; Fodor et al., 1991, Science 251:767-773; Pease et al, 1994, Proc. Natl. Acad. Sci. USA. 91:5022-5026; Lockhart et al., 1996, Nature Biotechnology 14:1675; U.S. Pat. Nos. 5,578,832; 5,556,752; 5,510,270; 5,445,934; 5,744,305; and 6,040,138). In another example, polynucleotide probes of reverse complementary sequences are used as the reference probes (see, Shoemaker et al., U.S. patent application Ser. No. 09/781,814, filed on Feb. 12, 2001; and Shoemaker et al., U.S. patent application Ser. No. 09/724,538, filed on Nov. 28, 2000).

In another type of approaches, differences in equilibrium binding and wash dissociation kinetics between perfect and non-perfect match duplexes are utilized to distinguish and remove cross-hybridization from hybridization data (see, e.g., Friend et al., U.S. Pat. No. 6,171,794, issued on Jan. 9, 2001; and Burchard et al., U.S. Patent application Ser. No. 09/408,582, filed on Sep. 29, 1999). These methods are premised on the discovery that non-perfect duplexes tend to wash off more quickly, or at a lower stringency, than the perfect duplexes. Therefore, perfect and non-perfect match duplexes can be distinguished using wash dissociation histories. In U.S. Pat. No. 6,171,794, multiple cross-hybridization components are distinguished by comparison of wash dissociation curve with template dissociation histories. In U.S. patent application Ser. No. 09/408,582, a robust way of estimating the total contribution due to non-perfect duplexes using wash dissociation histories is described. Various techniques have also been developed to study the hybridization kinetics of polynucleotides immobilized in solution or agarose or polyacrylamide gels (see, e.g., Mazumder et al., 1998, Nucleic Acids Research 26:1996-2000; Ikuta S. et al., 1987, Nucleic Acids Research 15:797-811; Kunitsyn, A. et al., 1996, Journal of Biomolecular Structure and Dynamics 14:239-244; Day, 1. N. M. et al., 1995, Nucleic Acids Research 23:2404-2412), as well as hybridization to polynucleotide probes immobilized on glass plates (Beattie, W. G. et al., 1995, Molecular Biotechnology 4:213-225) including oligonucleotide microarrays (Stimpson, D. I. et al., 1995, Proc. Natl. Acad. Sci. U.S.A. 92:6379-6383). For example, the nucleotide sequence similarity of a pair of nucleic acid molecules can be distinguished by allowing the nucleic acid molecules to hybridize, and following the kinetic and equilibrium properties of duplex formation (see, e.g., Sambrook, J. et al., eds., 1989, Molecular Cloning: A Laboratory Manual, 2nd Ed., Cold Spring Harbor Laboratory Press, Cold Spring Harbor, N.Y., at pp. 9.47-9.51 and 11.55-11.61; Ausubel et al., eds., 1989, Current Protocols in Molecular Biology, Vol I, Green Publishing Associates, Inc., John Wiley & Sons, Inc., New York, at pp. 2.10.1-2.10.16; Wetmur, J. G., 1991, Critical Reviews in Biochemistry and Molecular Biology 26:227-259; Persson, B. et al., 1997, Analytical Biochemistry 246:34-44; Albretsen, C. et al., 1988, Analytical Biochemistry 170:193-202; Kajimura, Y. et al., 1990, GATA 7:71-79; Young, S. and Wagner, R. W., 1991, Nucleic Acids Research 19:2463-2470; Guo, Z. et al., 1997, Nature Biotechnology 15:331-335; Wang, S. et al., 1995, Biochemistry 34:9774-9784; Niemeyer, C. M. et al., 1998, Bioconjugate Chemistry 9:168-175).

The exact hybridization or wash conditions that are optimal for any given assay will depend on the exact nucleic acid sequence or sequences of interest, and, in general, must be empirically determined. There is no single hybridization or washing condition which is optimal for all different nucleic acid sequences. In fact, even the most optimized conditions allow only partial discrimination of similar sequences, especially when such sequences have a high degree of similarity, or when some of the similar sequences are present in excess amounts or at high concentrations. Therefore, there is a need to develop methods for determination of specific hybridization and removal of contributions from cross-hybridized species in hybridization measurements. There is also a need to develop methods for experimentally selecting and ranking probes comprising sequences that most specifically hybridize to target sequences of interest.

Discussion or citation of a reference herein shall not be construed as an admission that such reference is prior art to the present invention.

### 3. SUMMARY OF THE INVENTION

The present invention provides methods for utilizing the changes of hybridization levels during approach to equilibrium duplex formation in hybridization measurements. In the invention, changes of hybridization levels of polynucleotide probes are monitored at a plurality of hybridization times, e.g., during their progress towards equilibrium, and a continuing increase of hybridization levels beyond the time scale of cross-hybridization equilibrium is used as an indication of specific binding. The invention is based, at least in part, on the discovery that specificity of binding of nucleotide sequences to probes (i.e., the ratio of specific to non-specific duplexes) increases with time.

The invention provides methods for determining whether specific hybridization to a polynucleotide probe by a sample comprising a plurality of nucleic acid molecules having different nucleotide sequences occurs. The methods determine change of hybridization level of the probe measured at a plurality of different hybridization times. The presence of specific hybridization at the probe is identified when the value of such change of hybridization level is above a predetermined threshold level. In preferred embodiments, hybridization levels measured at a first hybridization time and a second, different hybridization time is compared. Preferably, the first hybridization time is close to the time scale for substantially reaching cross-hybridization equilibrium. More preferably, the first hybridization time is long enough for hybridization level at the probe to reach at least 80%, 90% or 95% of cross-hybridization equilibrium level. In a preferred embodiment, the first hybridization time is in the range of 14 hours. Preferably, the second hybridization time is longer than the first hybridization time. More preferably, the second hybridization time is at least 2, 4, 6, 10, 12, 16, 18, 48 or 72 times as long as the first hybridization time. In a preferred embodiment, the second hybridization time is in the range of 48-72 hours.

In one embodiment, the time scale of cross-hybridization equilibrium is determined from a measured hybridization curve representing progression of hybridization level of the probe(s) with a sample which does not contain nucleic acid molecules specifically hybridizable to said probe(s). In another embodiment, the time scale of cross-hybridization equilibrium is determined from a measured hybridization curve representing progression of hybridization level of a reference probe, which has a sequence that is not specifically hybridizable to any known or predicted sequences in the sample. In one embodiment, the reference probe is a synthetic probe. In preferred embodiments, multiple synthetic probes are used so that the hybridization curve can be more reliably determined statistically. As examples, and not intended to be limiting, the reference probe hybridizes to any known or predicted sequences in a sample with at least 3%, 5%, 10%, 20% or 30% mismatched bases in said reference probe. In other embodiments, the reference probe has a sequence that is a reverse complement of a sequence or has a sequence that has reverse nucleotide order to a sequence in said plurality of nucleic acid molecules or is a reverse complement or has a reverse nucleotide order of the probe.

In preferred embodiments, the invention provides methods for determining whether specific hybridization to polynucleotide probe occurs using polynucleotide probe arrays. In the embodiments, hybridization levels of probes are measured by contacting a polynucleotide array comprising the probes with a sample comprising a plurality of nucleic acid molecules having different nucleotide sequences. In specific embodiments, the sample comprises more than 1,000, 5,000, 10,000, 50,000, or 100,000 nucleic acid molecules of different nucleotide sequences. In one embodiment, whether specific hybridization to a polynucleotide probe by a sample comprising a plurality of nucleic acid molecules having different nucleotide sequences occurs is determined by a method comprising (1) contacting a polynucleotide array comprising said probe with said sample under conditions such that hybridization can occur; (2) determining hybridization levels of said probe at a plurality of different hybridization times; (3) determining change of hybridization level by comparing hybridization levels measured at said plurality of different hybridization times; and (4) representing specific hybridization using said change, thereby determining whether specific hybridization of said probe occurs. Alternatively, whether specific hybridization to a polynucleotide probe by a sample comprising a plurality of nucleic acid molecules having different nucleotide sequences occurs is determined by a method comprising (1) contacting a plurality of polynucleotide arrays, each comprising said probe, with said sample under conditions such that hybridization can occur; (2) determining hybridization levels of said probe at each said polynucleotide array at a plurality of different hybridization times; (3) determining change of hybridization level by comparing hybridization levels measured at said plurality of different hybridization times; and (4) representing specific hybridization using said change, thereby determined whether specific hybridization of said probe occurs. Preferably, specific hybridization at the probe is identified when the value of such change of hybridization level is above a predetermined threshold level. In a preferred embodiment, hybridization levels measured at a first hybridization time and a second hybridization time is compared and specific hybridization is identified if the change in hybridization levels is above a predetermined threshold. Preferably, the first hybridization time is close to the time scale for substantially reaching cross-hybridization equilibrium. More preferably, the first hybridization time is long enough for hybridization level at the probe to reach at least 80%, 90% or 95% of cross-hybridization equilibrium level. Preferably, the second hybridization time is longer than the first hybridization time. More preferably, the second hybridization time is at least 2, 4, 6, 10, 12, 16, 18, 48 or 72 times as long as the first hybridization time. In a preferred embodiment, the ratio of said second hybridization level and said first hybridization level is determined and used as a measure of specific hybridization of the probe. In another preferred embodiment, a quantity xdev as described by equations (7) or (8), infra, is determined and used as a measure of specific hybridization of the probe. Preferably, each different probe on the polynucleotide array comprises a different nucleotide sequence consists of 5 to 1000, 10 to 600, 10 to 200, 10 to 100, 10 to 30, 40-80 nucleotides. More preferably, each different probe on the polynucleotide array comprises a different nucleotide sequence consists of 60 nucleotides. The sample is preferably labeled. In one embodiment, the sample is labeled with fluorescent dye molecules. In another embodiment, the sample is labeled with radioactive molecules.

The present invention also provides methods for determining the relative abundance of one or more nucleotide sequences in a plurality of samples, each of said plurality of samples comprising a plurality of nucleic acid molecules having different nucleotide sequences. In one embodiment, the method comprises (1) determining for each sample difference in hybridization levels measured at a first hybridization time and a second, different hybridization time to a probe that is specific to said nucleotide sequence; and (2) comparing the differences among the plurality of samples. Preferably, the first hybridization time is close to time scale for reaching cross-hybridization equilibrium at the probe and the second hybridization time is longer than the first hybridization time. In a preferred embodiment, hybridization levels of probes are measured by contacting a polynucleotide array comprising the probes with a sample comprising a plurality of nucleic acid molecules having different nucleotide sequences under conditions such that hybridization can occur. In one embodiment, hybridization levels of probes are measured by (1) contacting one or more polynucleotide arrays comprising said probe with one or more of said plurality of samples under conditions such that hybridization can occur; (2) determining for each of said plurality of samples a first hybridization level of said probe at a first hybridization time; (3) determining for each of said plurality of samples a second hybridization level of said probe at a second, different hybridization time; (4) determining for each of said plurality of samples difference in said first and second hybridization levels; and (5) comparing said difference among said plurality of samples. Preferably, each different probe on the polynucleotide array comprises a different nucleotide sequence consists of 5 to 1000, 10 to 600, 10 to 200, 10 to 100, 10 to 30, 40-80 nucleotides. More preferably, each different probe on the polynucleotide array comprises a different nucleotide sequence consists of 60 nucleotides. The samples are preferably labeled. In one embodiment, a sample labeled with a fluorescence dye is measured. In some embodiments, more than one samples are measured using the same array, each sample is labeled with a different fluorescent dye having a distinguishable emission spectra such that different samples are labeled with different and distinguishable dyes. The differently labeled samples are contacted with a single polynucleotide array simultaneously. In preferred embodiments, at least 3, 5 or 10 samples, distinctively labeled, are measured. In other embodiments, the sample is labeled with radioactive molecules.

The present invention also provides methods for comparing hybridization specificity among different probes. In the methods, hybridization specificities of different probes are compared by comparing the hybridization curves representing progressions of hybridization levels of the probes. Such hybridization curves representing progression of hybridization level can be measured in real time. Alternatively, progression of hybridization signal can be obtained by measuring hybridization levels in different experiments, in each of which a particular hybridization time is used (time correlated measurement). Hybridization curves are preferably compared by determining the value of a metric that represents the difference between the hybridization curves. In one embodiment, the metric is the difference in areas underneath the different hybridization curves. Hybridization curves can also be compared by determining a curve that represents the difference between the hybridization curves. In one embodiment, a ratio curve is determined. In another embodiment, a curve of xdev as defined infra is determined. In some embodiments, the hybridization curve of a probe is compared with the hybridization curve of a reference probe which has a sequence that is not specifically hybridizable to any known or predicted sequences in the sample using any of the method described above. Such embodiment offers a method for identifying specific hybridization of the probe. As examples, and not intended to be limiting, the reference probe can be a probe that is not specifically hybridizable to any known or predicted sequences in the sample, e.g., a probe that hybridizes to any known or predicted sequences in the sample with at least 3%, 5%, 10%, 20% or 30% mismatched bases in the probe. In other embodiments, the reference probe has a sequence that is a reverse complement of a sequence or has a sequence that has reverse nucleotide order to a sequence in said plurality of nucleic acid molecules or is a reverse complement or has a reverse nucleotide order of the probe.

The invention also provides methods for determining the difference in time scale of reaching hybridization equilibrium between specific and non-specific hybridization to a polynucleotide probe. In one embodiment, the time scales of equilibrium specific and non-specific hybridization are determined from measured hybridization curve of the probe and a reference probe. As examples, and not intended to be limiting, the reference probe can be a probe that is not specifically hybridizable to any known or predicted sequences in the sample, e.g., a probe that hybridizes to any known or predicted sequences in the sample with at least 3%, 5%, 10%, 20% or 30% mismatched bases in the probe. In other embodiments, the reference probe has a sequence that is a reverse complement of a sequence or has a sequence that has reverse nucleotide order to a sequence in said plurality of nucleic acid molecules or is a reverse complement or has a reverse nucleotide order of the probe.

The invention further provides methods for ranking a plurality of probes according to their binding specificities to their respective complementary sequences. In one embodiment, hybridization specificities of different probes are compared pair wise by comparing pair of the hybridization curves representing progressions of hybridization levels of the probes. The hybridization curves can be measured in real time, or alternatively, in time correlated measurement. Each pair of hybridization curves is preferably compared by determining the value of a metric that represents the difference between the pair of hybridization curves. In one embodiment, the metric is the difference in areas underneath the different hybridization curves. Hybridization curves can also be compared by determining a curve that represents the difference between the hybridization curves. In one embodiment, a ratio curve is determined. In another embodiment, a curve of xdev as defined infra is determined. Probes are then ranked according to their relative specificities. In another embodiment, hybridization curve of each of the plurality of probes is compared with the hybridization curve of one or more reference probes. In one embodiment, the one or more reference probes each having a sequence that is not specifically hybridizable to any known or predicted nucleotide sequences in the sample. As examples, and not intended to be limiting, the one or more reference probes in this embodiment can be probes that are not specifically hybridizable to any known or predicted sequences in the sample, e.g., a probe that hybridizes to any known or predicted sequences in the sample with at least 3%, 5%, 10%, 20% or 30% mismatched bases in the probe. In other embodiments, the reference probe has a sequence that is a reverse complement of a sequence or has a sequence that has reverse nucleotide order to a sequence in said plurality of nucleic acid molecules or is a reverse complement or has a reverse nucleotide order of the probe. In still other embodiments, the reference probe has a sequence that is a complement of a sequence or has a sequence that is complementary to a sequence in said plurality of nucleic acid molecules. The probes are then ranked according to their relative specificities with the reference probe(s), e.g., in order of lower to higher specificities starting from the one with a specificity most close to the reference. In another embodiment, the one or more reference probes each having a sequence that is specifically hybridizable to a nucleotide sequence in the sample, i.e., having a sequence that is complementary to a sequence in the sample, with a known specificity. In such an embodiment, the specificities of probes are ranked in according to specificity as compared to the known specificity of the reference probe. In still another embodiment, hybridization curve of each of the plurality of probes is compared with the hybridization curve of a reference probe having known specificity to a sequence in the sample and probes having similar specificities as the reference probe are selected.

Preferably, hybridization curves of probes of interest and/or reference probes are measured using polynucleotide probe arrays. In such embodiments, hybridization levels of probes are measured by contacting a polynucleotide array comprising the probes of interest and/or reference probes with a sample comprising a plurality of nucleic acid molecules having nucleotide sequences that are complementary to probes of interest and/or reference probes. Preferably, each different probe on the polynucleotide array comprises a different nucleotide sequence consists of 5 to 1000, 10 to 600, 10 to 200, 10 to 100, 10 to 30, 40-80 nucleotides. More preferably, each different probe on the polynucleotide array comprises a different nucleotide sequence consists of 60 nucleotides. The sample is preferably labeled. In one embodiment, the sample is labeled with fluorescent dye molecules. In another embodiment, the sample is labeled with radioactive molecules. In one embodiment, each of the nucleotide sequences that are known to be complementary to the probes of interest and/or references probes has known abundance in said sample. In another embodiment, each of the nucleotide sequences that are known to be complementary to the probes of interest and/or references probes has equal abundance in said sample. Preferably, the sample also comprises nucleotide sequences that are not specifically hybridizable to any of probes of interest and/or references probes.

The invention also provides methods for detecting the presence or absence of nucleotide sequences in a sample comprising a plurality of different nucleotide sequences. In the method the presence of a nucleotide is identified by the presence of specific hybridizations to polynucleotide probes having predetermined sequences. The presence of specific hybridization to a probe is determined by methods described in supra. In a preferred embodiment, the presence or absence of one or more nucleotide sequences in a sample is determined using one or more microarrays comprising probes specifically hybridizable to such nucleotide sequences. In the embodiment, one or more polynucleotide arrays comprising a plurality of probes specifically hybridizable to predetermined sequences are contacted with the sample and a first hybridization level I₁ of at a first hybridization and a second hybridization level I₂ of at a second hybridization time are determined for each of the probes. Change of hybridization level from I₁ to I₂ is then measured using a suitable metric, e.g., ratio of I₂ to I₁, difference of I₂ to I₁ or the quantity xdev of I₂ to I₁, for each probe is then determined. The presence of a nucleotide sequence is then identified if the value of the metric is greater than a predetermined threshold level, whereas the absence of a nucleotide sequence is identified if the value of the metric is less than a predetermined threshold level. The threshold level depends on the metric used and the sequences of interest as well as experimental conditions, e.g., stringency condition, and may be determined by those skilled in the art. In a preferred embodiment, a threshold level of 2, 4 or 10 is used for xdev.

The invention also provides methods for determining the orientation of a nucleotide sequence in a sample by comparing specific hybridization to a forward probe comprising the sequence in forward direction and a reverse probe comprising the sequence in reverse direction. In the methods, the presence or absence of specific hybridization to one or the other probe in a pair of forward and reverse probes are determined and specific hybridization to one but not the other probe in the pair is used to identify the orientation of the sequence. In preferred embodiments, specific hybridizations to the forward and/or reverse probes are determined by the methods utilizing changes of hybridization levels during approach to hybridization equilibrium. In more preferred embodiments, kinetic methods are used to determine specific hybridizations to both the forward and reverse probes. When kinetic methods are used, hybridization levels of the forward and reverse probes are both measured at a plurality of hybridization times so that specific hybridization to the forward or the reverse probe can be determined. The hybridization levels at the forward and reverse probes can be measured concurrently or separately.

In a preferred embodiment, the method for determining the orientation of a nucleotide sequence comprises: (1) contacting a polynucleotide array comprising a forward polynucleotide probe comprising said sequence in forward direction and a reverse polynucleotide probe comprising said sequence in reverse direction with said sample under conditions such that hybridization can occur, said polynucleotide array comprising a positionally-addressable array of polynucleotide probes bound to a support, said polynucleotide probes comprising a plurality of polynucleotide probes of different predetermined nucleotide sequences; (2) determining hybridization levels of said forward polynucleotide probe at a first plurality of hybridization times, wherein each of said first plurality of hybridization times corresponds to a different length of time said sample is allowed to hybridize with said forward polynucleotide probe; (3) determining hybridization levels of said reverse polynucleotide probe at a second plurality of hybridization times, wherein each of said second plurality of hybridization times corresponds to a different length of time said sample is allowed to hybridize with said reverse polynucleotide probe; (4) determining change of hybridization level of said forward polynucleotide probe by a method comprising comparing hybridization levels measured at said first plurality of hybridization times; (5) determining change of hybridization level of said reverse polynucleotide probe by a method comprising comparing hybridization levels measured at said second plurality of hybridization times; and (6) determining the orientation of said nucleotide sequence by a method comprising comparing said change of hybridization level of said forward polynucleotide probe with said change of hybridization level of said reverse polynucleotide probe.

In preferred embodiments, the first plurality of hybridization times consists of a first hybridization time and a second hybridization times, whereas the second plurality of times consists of a third hybridization time and a fourth hybridization times. In a preferred embodiment, the first and third hybridization times are 1 to 4 hours. In another preferred embodiment, the second and the fourth hybridization times are at least 2, 4, 12, 16, 48 or 72 times as long as said first and third hybridization times, respectively. In more preferred embodiments, the first and the third hybridization times are the same, and the second and the fourth hybridization times are the same. In preferred embodiments, the orientation of the nucleotide sequence is determined by comparing the xdev's for the forward probe and the reverse probe. In another embodiment, the orientation of the nucleotide sequences is determined by comparing the hybridization levels of the forward probe and the reverse probe measured at the second hybridization times.

The invention also provides computer systems which can be used to practice the methods of the invention. In one embodiment, the invention provides a computer system for identifying specific hybridization to a polynucleotide probe, said computer system comprising
a processor, and
a memory coupled to said processor and encoding one or more programs, wherein the one or more programs cause the processor to perform a method comprising:
(1) comparing hybridization levels of said probe at a first hybridization time and a second hybridization time, wherein said first hybridization time is close to the time scale for substantially reaching cross-hybridization equilibrium and said second hybridization time is longer than said first hybridization time; and
(2) determining the difference of hybridization levels from said comparing, said difference representing a metric for identifying specific hybridization.

In another embodiment, the invention provides a computer system for comparing hybridization specificity of a first probe and a second probe, said computer system comprising
a processor, and
a memory coupled to said processor and encoding one or more programs, wherein the one or more programs cause the processor to perform a method comprising:
(1) comparing a first hybridization curve representing progression of hybridization level of said first probe and a second hybridization curve representing progression of hybridization level of said second probe; and
(2) determining the value of a metric from said comparing, said metric representing the difference between first hybridization curve and said second hybridization curve.

In still another embodiment, the invention provides a computer system for ranking a plurality of probes according to their binding specificities, said computer system comprising
a processor, and
a memory coupled to said processor and encoding one or more programs, wherein the one or more programs cause the processor to perform a method comprising:
(1) comparing each of two or more hybridization curves, each of said two or more hybridization curves representing progression of hybridization level of one of said two or more probes, to a reference hybridization curve representing progression of hybridization level of a reference probe;
(2) determining the value of a metric for each of the two or more probes from each of said comparings, the value of said metric for each of the two or more probes representing the difference between each of the two or more hybridization curves and the reference hybridization curve; and
(3) ranking the two or more probes according to the value of the metric for each of said two or more probes.

The invention also provide computer program which can be used to practice the methods of the invention. In one embodiment, the invention provides computer program product for use in conjunction with a computer having a processor and a memory connected to the processor,
said computer program product comprising a computer readable storage medium having a computer program mechanism encoded thereon,
wherein the computer program mechanism may be loaded into the memory of the computer and cause the processor to execute the steps of:
(1) comparing hybridization levels of said probe at a first hybridization time and a second hybridization time, wherein said first hybridization time is close to the time scale for substantially reaching cross-hybridization equilibrium and said second hybridization time is longer than said first hybridization time; and
(2) determining the difference of hybridization levels from said comparing, said difference representing a metric for identifying specific hybridization.

In another embodiment, the invention provides computer program product for use in conjunction with a computer having a processor and a memory connected to the processor,
said computer program product comprising a computer readable storage medium having a computer program mechanism encoded thereon,
wherein the computer program mechanism may be loaded into the memory of the computer and cause the processor to execute the steps of:
(1) comparing a first hybridization curve representing progression of hybridization level of said first probe and a second hybridization curve representing progression of hybridization level of said second probe; and
(2) determining the value of a metric from said comparing, said metric representing the difference between first hybridization curve and said second hybridization curve.

In still another embodiment, the invention provides computer program product for use in conjunction with a computer having a processor and a memory connected to the processor,
said computer program product comprising a computer readable storage medium having a computer program mechanism encoded thereon,
wherein the computer program mechanism may be loaded into the memory of the computer and cause the processor to execute the steps of:
(1) comparing each of two or more hybridization curves, each of said two or more hybridization curves representing progression of hybridization level of one of said two or more probes, to a reference hybridization curve representing progression of hybridization level of a reference probe;
(2) determining the value of a metric for each of the two or more probes from each of said comparings, the value of said metric for each of the two or more probes representing the difference between each of the two or more hybridization curves and the reference hybridization curve; and
(3) ranking the two or more probes according to the value of the metric for each of said two or more probes.

### 4. BRIEF DESCRIPTION OF FIGURES.

FIGS. 1A-B depict changes of hybridization level calculated according to Equations (5) and (6). FIG. 1A hybridization level increase during approach to equilibrium; FIG. 1B Ratio of levels of specific and non-specific hybridization. The parameters are set as: R_{T}=1, L₀₁=1, L₀₂=2, α₁=1, α₂=10, and k_{f}=0.05.

FIGS. 2A-C depict histograms of intensity ratios from Jurkat channel. FIG. 2A 16 hour to 4 hour; FIG. 2B 24 hour to 4 hour; FIG. 2C 48 hour to 4 hour. Thick line in FIG. 2C is the histogram for mRNA probes only.

FIG. 3 depicts mean log₁₀(Intensity) as a function of hybridization time: specific sequences (O), i.e., >0.7, and all other sequences (*), i.e., <0.7. The mean log10(Intensity) curves of mRNA derived polynucleotide probes (+) and EST derived polynucleotide probes (Δ) are also plotted in the same figure.

FIG. 4A shows the log intensity ratio (48 hour hybridization/4 hour hybridization) vs. log intensity of 48 hour hybridization for the jurkat sample. Spots in darker region correspond to probes with xdev>2. The data was normalized to the maximum dynamic range of the scanner. Spots near the log intensity of 0 are spots whose intensity saturated the scanner. FIG. 4B shows a histogram of xdev (for time points at 4 hour and 48 hour). Thick line is the histogram for mRNA polynucleotide probes only.

FIG. 5 shows an example of a tiling region from 63 kb to 77 kb. See text for explanation.

FIG. 6 illustrates an exemplary embodiment of a computer system useful for implementing the methods of this invention.

FIG. 7 is a plot of log intensity ratio (72 hour hybridization/3 hour hybridization) vs. log intensity of 72 hour hybridization for the jurkat sample. Horizontal line represents ratio=2. Spots below the line are the ones whose intensity did not increase with hybridization time, and hence are designated as having ‘poor’ kinetic characteristics.

FIG. 8 Call rate and accuracy as a function of threshold. (a) kinetics method for the kinetically ‘good’ group; (b) intensity method for the kinetically ‘good’ group; (c) kinetics method for the ‘poor’ group; and (d) intensity method for the ‘poor’ group.

FIGS. 9A-B show hybridization levels vs. hybridization time for perfect match probes and probes with mutations. FIG. 9A shows average hybridization signal intensity versus hybridization time. The average hybridization signal intensity for each chosen number of mismatches (mutations) in a probe was averaged over 110 probes (or 60 probes for 1 base mutation) and averaged again over the two clones. For each hybridization time, the number of mutations ranges from 0 to 20, arranged from left to right. The bars are alternated between black and white for successive even and odd number of mutations. FIG. 9B plots average hybridization curves for the same set of data as in FIG. 9A. The numbers at the right side of the curves indicate the number of mismatches for the respective curves. Symbols for the first few mutations are: circle 0 mismatch (perfect match probe); x 1 base mismatch; *2 bases mismatch; diamond 3 bases mismatch; square bases mismatch; triangle (down) 5 bases mismatch; triangle (up) 6 bases mismatch; +7 bases mismatch; and pentagram 8 bases mismatch.

FIGS. 10A-B show hybridization curves of perfect match probes and probes with deletions. FIG. 10A shows average hybridization signal intensity versus hybridization time. The average hybridization signal intensity for each chosen number of deletions in a probe was averaged over 110 probes (or 60 probes for 1 base mutation) and averaged again over the two clones. For each hybridization time, the number of deletions ranges from 0 to 20, arranged from left to right The bars are alternated between black and white for successive even and odd number of deletions. FIG. 10B plots average hybridization signal intensity versus hybridization time for the same set of data as in FIG. 10A. The numbers at the right side of the curves indicate the number of deletions for the respective curves. Symbols for the first few deletions are: circle 0 deletion (perfect match probe); x 1 base deletion; *2 bases deletion; diamond 3 bases deletion; square 4 bases deletion; triangle (down) 5 bases deletion; triangle (up) 6 bases deletion; +7 bases deletion; and pentagram 8 bases deletion.

FIGS. 11A and 11B show hybridization curves of selected individual probes. Solid lines correspond to perfect match probes and dashed lines correspond to probes with 10 mismatched bases, mutations (FIG. 11A) and deletions (FIG. 1B).

FIGS. 12A and 12B show hybridization curves of selected individual probes for the fragmented sample. Solid lines correspond to perfect match probes and dashed lines correspond to probes with 10 mismatched bases, mutations (FIG. 12A) and deletions (FIG. 12B).

FIGS. 13A-13D show a comparison of hybridization kinetics results measured by using separate identically produced microarrays (multiple microarray experiment) vs. results measured using a single microarray (single microarray experiment). FIG. 13A: “Double,” histograms of log₁₀(intensity for 72 hours/intensity for 4 hours) of data measured in a single microarray experiment, in which sample was hybridized to a single microarray for 4 hours and scanned. The microarray was then placed in the hybridization solution for another 68 hours (for a total of 72 hours) and scanned again. FIG. 13B: “Single,” histograms of log₁₀(intensity for 72 hours/intensity for 4 hours) of data measured in a multiple microarray experiment, in which each array was hybridized for a specific hybridization time and scanned. For data measured in a multiple microarray experiment shown in these figures, two identically produced arrays were used for the 2 time points, i.e., 4 hours and 72 hours. Thick lines in FIGS. 13A and 13B: histograms for mRNA polynucleotide probes. FIG. 13C shows the ratio between the Log₁₀(ratio)'s as in FIGS. 13A and 13B vs. log intensity at 72 hours. Ratio_{D} is intensity ratio for double, Ratio_{S} is intensity ratio for single. FIG. 13D shows the two color ratio (Jurkat/K562) for double vs. the two color ratio for single (72 hours).

### 5. DETAILED DESCRIPTION OF THE INVENTION

The present invention provides methods for utilizing the changes of hybridization levels in time during approach to equilibrium duplex formation in hybridization measurements. In the invention, the changes of hybridization levels at one or more polynucleotide probes by a sample comprising a plurality of nucleic acid molecules having different sequences are monitored during their progress towards equilibrium and the continuing increase of hybridization signals beyond cross-hybridization is used as an indication of specific binding. The inventors have discovered that specificity of binding of nucleotide sequences to probes (e.g., the ratio of specific to non-specific duplexes) increases with time. “Specific hybridization” generally occurs upon hybridization to a given probe of polynucleotide sequences which are completely or nearly completely complementary to the sequence in the given probe, whereas “non-specific hybridization” generally occurs upon hybridization of polynucleotide sequences that hybridize to a given probe with at least one, in most cases more than one, non-complementary base pair in the probe. In one embodiment, non-specific hybridization refers to hybridization of polynucleotide sequences which hybridize to a particular probe with at least 3%, 5%, 10%, 20% or 30% mismatched bases in the probe. As used herein, a nucleic acid molecule is said to hybridize to a probe with X % of mismatched bases in the probe if in the hybridization pairs formed between the nucleic acid molecule and the probe at least X % of bases of the probe do not base pair with respective complementary bases. Non-specific hybridization is generally referred to as “cross-hybridization.” When a complex sample is hybridized to a microarray comprising multiple probes, duplex can be formed from highly specific to highly non-specific. The methods of the invention can also be used to rank the specificity of duplexes. For example, the methods of the present invention can be used to identify nucleic acid molecules that are specific to given polynucleotide probes. In particular, the methods of the invention can be used to distinguish specific hybridization due to formation of perfect duplexes from cross-hybridization due to formation of non-perfect duplexes when the data contain a mix of both for hybridization duration short compared to the equilibrium time scale. The invention also provides methods for detecting the presence or absence of nucleotide sequences in a sample by determining the presence or absence of specific hybridization at probes having complementary sequences.

The resolution of a probe in discriminating specific and non-specific sequences depends on various factors, e.g., hybridization conditions and probe length. As is well-known to one skilled in the art, number of mismatch bases in “specific” and “non-specific” depend on the length of the probe sequence. For example, for 60 mer probe, a 1 base mismatch can be specific, whereas for a 20 mer probe, a 1 base mismatch can be non-specific. Thus, in the present invention, reference probes with a series of mismatches, e.g., 1, 2, 5, 10, 20, and 30 mismatches, can be used to calibrate the specificity of a probe of a particular length, thereby determining the resolution of the probe.

A “polynucleotide probe” or “probe” used in this invention is a nucleic acid molecule preferably comprising a predetermined sequence. Although in the specification “a probe” is often used, it is understood that the term as used herein will generally refer to a type of probe, or a population of the same probes. In the specification, “level of hybridization” or “hybridization level” of a probe is often used to refer to the amount of molecules of the probe hybridized to nucleic acid molecules. In some embodiments of the invention, probes comprising a nucleotide sequence that is complementary, or, alternatively not complementary, to a known or predicted sequence in a sample are often used. A known sequence in a sample can be any sequence in the genome of the organism that has been determined, e.g., by sequencing. A predicted sequence in a sample can be any sequence that has been predicted to exist in the sample, e.g., by using various computational gene prediction programs known in the art, such as BLAST (Altschul et al., 1990, J. Mol. Biol. 215:403-410), GeneParser (Snyder, et al., Nucl. Acids Res. 21:607-613), GRAIL (Uberbacher, et al., 1991, Proc. Natl. Acad. Sci. USA 88:11261-11265), SYBCOD (Rogozin, et al., 1999, Gene 226:129-137), GeneID (Guigo, et al., 1992, J. Mol. Biol. 226:141-157), GREAT (Gelfand, 1990, Nucleic Acids Res. 18:5865-5869; Gelfand, et al., 1993, Biosystems 30:173-182.), GenLang (Dong, et al., 1994, Genomics 23:540-551), FGENEH (Solovyev, et al., 1994, Nucleic Acids Res. 22:5156-5163), and SORFIND (Hutchinson, et al., 1992, Nucleic Acids Res. 20:3453-3462). Preferably, the size of the probes is at least the same as the average size of target molecules in a sample. More preferably, the size of the probes is less than the average size of target molecules in a sample. For example, when samples containing target molecules of an average size of 80 bases, preferably probes of 80 nucleotides, more preferably probes of less 80 nucleotides, e.g., probes of 60 nucleotides, are used.

As used herein, “hybridization time” refers to a time as measured from the beginning of a hybridization reaction, i.e., corresponding to the length or duration of time one or more nucleic acid molecules are allowed to hybridize with a probe. Therefore, a hybridization level measured at a given hybridization time reflects the hybridization level achieved after allowing the sample to hybridize to the probe for the duration of the given time. In the specification, progression of hybridization signal is also used to refer to the time course of hybridization level, i.e., hybridization level vs. hybridization time. Such progression of hybridization level is normally represented as a hybridization curve. Such progression of hybridization level can be measured in real time. Alternatively, progression of hybridization signal can be obtained by measuring hybridization levels in different experiments, in each of which a particular hybridization time is used (time correlated measurement). A combination of real time and time correlated measurements of hybridization level is also envisioned.

As used herein, “hybridization equilibrium” refers to a hybridization state to a polynucleotide probe at which the rates of binding and dissociation are substantially equal. Such hybridization equilibrium is normally identified when the measured hybridization level is no longer changing substantially. As used herein, “cross-hybridization equilibrium” refers to the hybridization equilibrium of a probe which does not specifically hybridize to any nucleic acid molecules in a sample, whereas “specific hybridization equilibrium” refers to the hybridization equilibrium of a probe which specifically hybridizes to one or more nucleic acid molecules in a sample. As known to those skilled in the art, a equilibrium hybridization level of a probe is normally identified as the hybridization level that is no longer changing substantially in time. In one embodiment, an equilibrium hybridization level can be determined by measuring the hybridization level of the probe at hybridization time range in which changes in measured hybridization levels are on the order of the levels of measurement errors.

The invention also provides methods for determining the relative abundance of nucleotide sequences in a sample utilizing the changes of hybridization signals. In particular, methods for determining the relative abundance of nucleotide sequences in a sample utilizing the rate of increase of hybridization signals are provided. In the invention, hybridization signals of specifically hybridized probes and corresponding reference probes are compared and the signal levels of reference probes after equilibrium cross-hybridization is reached are subtracted to determine the rate of signal intensity increase of specifically hybridized sequences. Such rate of increase is proportional to the abundance of the target nucleotide sequence. The invention also provides DNA arrays which can be used for determination of hybridization levels using increase of hybridization signals.

The invention also relates to methods for selecting polynucleotide probes that are most specific to target nucleic acids. In such methods, the changes of hybridization signals of different candidate polynucleotide probes are determined and compared. The probe or probes that exhibit the highest specificity are selected.

The invention further relates to methods for enhancing the detection of nucleic acids. In such methods, the changes of hybridization signals of polynucleotide probe or probes are measured and are used as a measure of the significance of the signals.

The nucleic acid molecules which may be analyzed by the methods of this invention include DNA molecules, such as, but by no means limited to genomic DNA molecules, cDNA molecules, and fragments thereof, such as oligonucleotides, expressed sequence tags (EST's), sequence tag sites (STS's), single nucleotide polymorphisms (SNP's), etc. Nucleic acid molecules which may be analyzed by the methods of this invention also include RNA molecules, such as, but by no means limited to messenger RNA (mRNA) molecules, ribosomal RNA (rRNA) molecules, cRNA molecules (i.e., RNA molecules prepared from cDNA molecules that are transcribed in vivo) and fragments thereof.

The invention is often described herein as being practiced using individual polynucleotide probes. However, it is understood that the invention may also be practiced using a plurality of polynucleotide probes each of which comprises a particular predetermined sequence. In preferred embodiments, such a plurality of polynucleotide probes are immobilized on a surface to form a polynucleotide probe array.

### 5.1. Specific and Cross-Hybridization: Changes of Hybridization Levels During Approach to Equilibrium

The inventors have discovered that time scales for formation of hybridization duplexes, i.e., binding of target nucleic acid molecules to polynucleotide probes, and dissociation of hybridization duplexes are different. The rate of binding depends, inter alia, on the densities or concentrations of the nucleic acid molecules as well as the motions, e.g., diffusions, of such nucleic acid molecules. The rate of binding also depends on structural characteristics of target nucleic acid molecules and polynucleotide probes, e.g., the fragment length, secondary structures, and the conformational dynamics of target nucleic acid molecules and polynucleotide probes. The rate of dissociation, on the other hand, is mostly governed by thermodynamics of hybridization duplexes, i.e., the difference between binding energy gain and free energy loss of the corresponding strands upon formation of hybridization duplexes. The rate of dissociation thus depends on both bond energies of bonds formed between the two strands and environmental conditions, e.g., temperature and salt concentrations. Under a given hybridization condition, more tightly bound duplexes, i.e., duplexes bound with higher specificities, have a lower dissociation rate, i.e., take longer time to spontaneously dissociate. (See, e.g., Lauffenberger et al., Receptors, Oxford University Press, 1996) As a result of these different time scales, the hybridization to a given probe under a particular hybridization condition by a sample comprising a plurality of different target sequences in which only a fraction is specifically hybridizable to the probe exhibits a time-dependent progression of hybridization specificity. As a non-limiting example, when a sample containing a plurality of target RNA or DNA molecules of different sequences, fragment lengths, and abundances is allowed to hybridize to a probe comprising a given sequence, e.g., a probe immobilized on a surface, and there is one species which has a sequence perfectly complementary to the probe and which represents a small fraction of the total abundance of molecules available for binding, the given probe will encounter a large number of non-perfect match target sequences and a small number of perfect match target sequences. In the initial stages, since there are more non-perfect partners than perfect partners, more molecules of the probe will hybridize to non-perfect match target sequences than perfect match target sequences. However, since the non-perfect duplexes are more weakly bound than perfect duplexes, dissociation of such non-perfect duplexes will occur more quickly than perfect duplexes. As a result, the ratio of perfect duplexes to non-perfect duplexes increases with time until an equilibrium is reached.

Such an approach to equilibrium process may be described by a simplified, non-limiting, model to quantitatively demonstrate the change in time from less specific to more specific binding on a given probe. The more specific binding gains relative to the less specific binding until an equilibrium state is reached in which the bound fractions reflect the relative binding energies.

A non-limiting model describing a system of on/off kinetics is illustrated by Equation (1)

$$R + L \frac{{\to }^{{k}_{f}}}{{←}_{{k}_{r}}} C \qquad ( 1 )$$

where R, L and C are the concentration of probe molecules available for hybridization, the concentration of target molecules and the concentration of hybridization duplexes, respectively, all in unit of M. k_{f} and kᵣ denote the forward [M⁻¹time⁻¹], i.e., binding, and the reverse [time⁻¹], i.e., unbinding, rates respectively. The system is described by rate equation and conservation laws (see, e.g., Lauffenberger et al., Receptors, Oxford University Press, 1996):

$$\frac{ⅆ C}{ⅆ t} = {k}_{f} RL - {k}_{r} C \qquad ( 2 )$$

Define R_{T} as the total number of probe molecules R_{T}=R+C, V as volume, and N_{AV} is Avogadro's number, the equation can be written as Eq. (3) under the condition that the number of probe molecules is large, e.g., R_{T}>>C, and that at t=0 no probe molecules are bound by target molecules

$$\frac{ⅆ C}{ⅆ t} = {k}_{f} {R}_{T} ( {L}_{0} - \frac{1}{{N}_{AV}} C ) - {k}_{r} C , {R}_{T} >> C \qquad ( 3 )$$

The solution of Eq. (3) is given by Eq. (4)

$$C ( t ) = \frac{{R}_{T} {L}_{0}}{α} [ 1 - exp ( - {k}_{f} α t ) ] \qquad ( 4 )$$

where α and K_{D} are defined as

$$\begin{matrix}α = {R}_{T} \frac{1}{{N}_{AV} V} + {K}_{D} \\ {K}_{D} = \frac{{k}_{r}}{{k}_{f}}\end{matrix}$$

K_{D} [M] is thus a dissociation constant that is smaller for hybridization duplexes bound more strongly, i.e., having higher binding specificities.

Thus, as a non-limiting example according to the model, the concentration of specific species and the concentration of non-specific species, i.e., cross-hybridization species, to a given probe are denoted as L₀₁ and L₀₂, respectively. Under the condition that R_{T} is large, that competition between perfect matches and non-perfect matches to molecules of the same probe is insignificant, and that the forward rate k_{f} is the same for the perfect matches and the non-perfect matches whereas the dissociation rate for perfect duplexes kᵣ₁ is much smaller than the dissociation rate for non-perfect duplexes kᵣ₂ as a result of much stronger binding of specifically bound duplexes as compared to non-specifically bound duplexes, i.e., kᵣ₁<<kᵣ₂ the time behaviors, or progressions, of hybridization levels of specifically bound duplexes and non-specifically bound duplexes are described respectively by

$$\begin{matrix}{C}_{1} ( t ) = \frac{{R}_{T} {L}_{01}}{{α}_{1}} [ 1 - exp ( - {k}_{f} {α}_{1} t ) ] & ( 5 ) \\ {C}_{2} ( t ) = \frac{{R}_{T} {L}_{02}}{{α}_{2}} [ 1 - exp ( - {k}_{f} {α}_{2} t ) ] & ( 6 )\end{matrix}$$

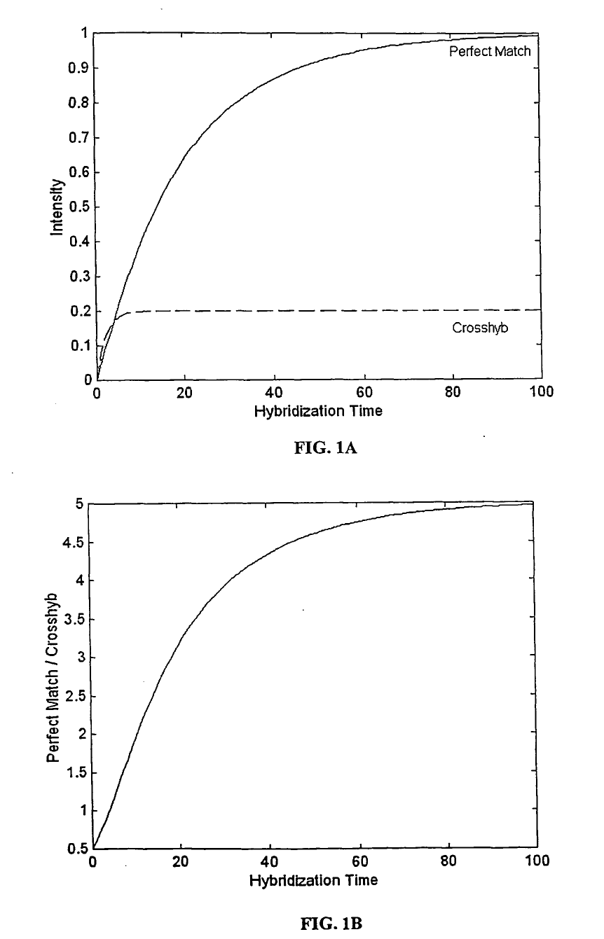

The progressions of hybridization levels of specifically bound duplexes and non-specifically bound duplexes as described by Eqs. (5) and (6) are plotted in FIG. 1A. It can be seen that hybridization due to non-specifically bound duplex formation rises more rapidly than hybridization due to specifically bound duplex formation and reach equilibrium earlier than specific hybridization. Specific hybridization rises more slowly and takes longer time to reach equilibrium. Therefore, the specificity, i.e. the ratio of the perfect match to the cross-hybridization increases and finally saturates (FIG. 1B). The competition between perfect and non-perfect binding could also be taken into account, but they do not qualitatively change the conclusions.

As a result of such increase of hybridization specificity, i.e., the ratio of specific to non-specific duplexes, with time until equilibrium of specific hybridization is reached, for hybridizations short compared to the equilibrium time scale, the change of specificity itself can be used to distinguish cross-hybridization (non-specific duplexes) from specific duplexes when the data contain a mix of both.

### 5.2. Methods for Utilizing Changes in Hybridization Levels

The inventors have discovered that a binding specificity related change in hybridization level can be utilized to aid hybridization measurement in, inter alia, distinguishing specific hybridization from cross-hybridization. For example, the rate of increase rather than the cumulative amount in hybridization level of a given probe can be used as an indicator of specific hybridization. Thus a probe whose hybridization level is still increasing, e.g., still gaining brightness if target sequences are labeled with fluorescence dyes, after a certain length of hybridization time can be used to indicate that the probe has specific hybridization rather than pure cross-hybridization. This offers a method to assign a reliability score to the probe. In another example, the rate of increase, rather than the hybridization level measured at a single length of hybridization time, can be used as a measure of abundance of the molecular species being reported by that probe.

The method of the invention is applicable to samples comprising single-stranded target nucleic acid molecules, e.g., RNA molecules, double-stranded nucleic acid molecules, e.g., dsDNA molecule, and mixtures thereof.

The methods of the invention are based on determining changes of measured hybridization levels in time. Changes in measured hybridization levels can be represented by various metrics. In one embodiment, the simple arithmetic difference of measured hybridization levels between measured hybridization times is used as a metric to represent the changes in hybridization level. In another embodiment, ratio of measured hybridization levels between measured hybridization times is used as a metric to represent the changes in hybridization level.

In a preferred embodiment, a quantity ‘xdev’ is used to better separate specific hybridization from non-specific hybridization,

$$xdev = \frac{{I}_{2} - {I}_{1}}{\sqrt{{err ( {I}_{1} )}^{2} + {err ( {I}_{2} )}^{2}}} \qquad ( 7 )$$

where I₁ and I₂ are the hybridization levels measured at time t₁ and t₂, respectively, whereas err( ) refers to expected error. This quantity is especially advantageous when measured hybridization levels are low, rendering ratios of hybridization levels less well defined. The quantity provides a hybridization level-independent metric for representing change in measured hybridization level by correcting for hybridization level-dependent errors exhibited in hybridization experiments (see, e.g., Stoughton et al., PCT publication WO 00/39339, published on Jul. 6, 2000).

The many sources of error that underlie the experiments fall into two categories —additive and multiplicative. Therefore, in one embodiment, the following statistical representation is used

$$xdev = \frac{( {I}_{2} - {I}_{1} )}{\sqrt{{σ}_{1}^{2} + {σ}_{2}^{2} + {f}^{2} ( {I}_{2}^{2} + {I}_{1}^{2} )}} \qquad ( 8 )$$

where I₁ and I₂ are hybridization levels, e.g., the signal intensities for a probe spot on a microarray, measured at hybridization times t₁ and t₂, σ₁² is a variance term for I₁ and represents the additive error level in the I₁ measurement, σ₂² is a variance term for I₂ and represents the additive error level in the I₂ measurement, and f is the fractional multiplicative error level, provides a particularly well suited model for fitting the resultant error. In some embodiments, σ comes from background fluctuation, or from spot-to-spot variations in signal intensity among negative control spots, whereas f comes from the scatter observed for ratios that should be unity. Regardless of whether a single fluorophore or a dual-fluorophore embodiment is chosen, the fractional multiplicative error, f, is empirically derived by fitting the denominator of equation (8) to the measured data.

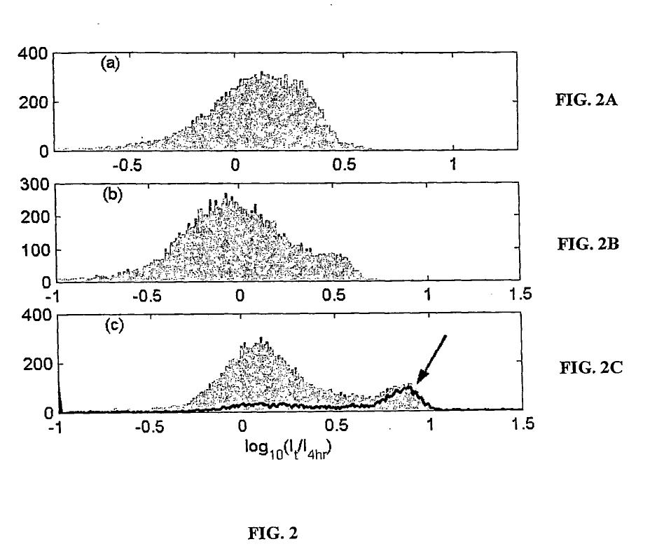

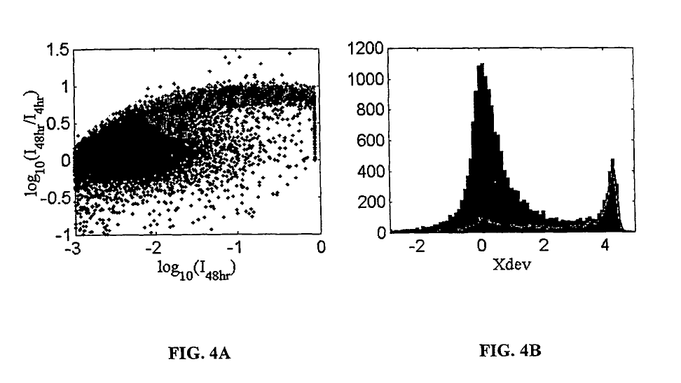

xdev is therefore an error distribution statistic that is independent of intensity, and therefore is particular useful in determine the statistical significance of the detection. The error weighting helps prevent false conclusions from probes for which measurement noise contributes large fractional error in the measured hybridization level, e.g., measured signal intensity in a microarray experiment. FIG. 4 shows a histogram of xdev between 48 hours and 4 hours of hybridization time. It should be compared with FIG. 2C where a histogram of the ratio of intensities is plotted. This error-weighted measure sharpens the distinction between the two classes of probes. This xdev quantity can be used as a measure of evidence for specific duplexes, in the presence of contamination by non-specific duplexes. Thus a xdev having a value above a predetermined threshold indicates formation of perfect specific at the probe.

In some embodiments, the threshold of xdev can be determined by reference probes with known specificity, or alternatively, by looking at the distribution of xdev as in FIG. 4.

In the present invention, hybridization curves are also utilized to compare hybridization specificities of different probes. For example, according to Eqs. (5) and (6), if the concentrations or relative concentrations of complementary sequences to two different probes are known, a comparison of the two hybridization curves provides measure of the relative specificities of the two probes to their respective perfect match sequences. Various methods can be used to compare different hybridization curves (see, e.g., Friend et al., U.S. Pat. No. 6,171,794; and Burchard et al., U.S. patent application Ser. No. 09/408,582, filed on Sep. 29, 1999).

In preferred embodiments, variable M is defined as xdev or intensity normalized by the cross-hybridization equilibrium level, or combination of both. A hybridization curve contains hybridization level as a function of time, tₙ, measured from the time of initial hybridization. If the n'th hybridization time is referred to as tₙ, M^{a}(tₙ) is the hybridization level of probe a after time tₙ from the initial hybridization measurement Preferably, M^{a}(tₙ) is normalized with respect to the hybridization level around the cross-hybridization equilibrium time.

The hybridization curves are preferably piece-wise continuous functions of the hybridization time t. Accordingly, in certain embodiments, it may be necessary to provide for interpolating the hybridization curves so that the hybridization curves are piece-wise continuous functions. Methods for interpolating functions such as the hybridization curves of the present invention are well known in the art, and are described, e.g., by Press et al. (1996, Numerical Recipes in C, 2nd Ed., see in particular Chapter 3: “Interpolation and Extrapolation”).

In one embodiment, one or more of the hybridization curves are linearly interpolated. Thus, for any time t between the n'th and (n+1)'th intervals (i.e., wherein tₙ<t<tₙ₊₁) the hybridization curve M of a particular probe is approximated by the linear function which runs through the points M(tₙ) and M(tₙ₊₁). In particular, in such an embodiment M(t) may be provided by the equation

$$\begin{matrix}M ( t ) = M ( {t}_{n + 1} ) + \frac{M ( {t}_{n} ) - M ( {t}_{n + 1} )}{{t}_{n + 1} - {t}_{n}} ( {t}_{n + 1} - t ) \\ = M ( {t}_{n} ) - \frac{M ( {t}_{n} ) - M ( {t}_{n + 1} )}{{t}_{n + 1} - {t}_{n}} ( t - {t}_{n} )\end{matrix} \qquad ( 9 )$$

Preferably, M(t) is adjusted for the cross-hybridization levels, e.g., M(t)=M(t)−M(t₁), M(t)=M(t)/M(t₁), or M(t)=xdev(t), where t₁ corresponds to the time scale of cross-hybridization equilibrium. Once piece-wise continuous hybridization curves have been provided, the hybridization curves are compared so that an objective metric is determined. The objective metric determined by this comparison is directly related to the specificities of the probes for which the hybridization curves have been obtained.

In one embodiment, two hybridization curves may be compared by means of the objective metric

$$Q = {\int }_{t = 0}^{{t}_{N}} [ {M}^{a} ( t ) - {M}^{b} ( t ) ] ⅆ t \qquad ( 10 )$$

For example, the metric Q provided by Equation 10 may be used in embodiments wherein different probes are being compared by their specificity for the same polynucleotide (i.e., wherein i=j, and a≠b). The metric Q provided in Equation 10 may also be used in embodiments wherein different polynucleotides are being compared by their specificity for the same probe (i.e. wherein i≠j, and a=b). Methods for evaluating integrals such as those in Equation 10 above are routine and well known to those skilled in the art. For example, the integrals of Equation 10 may be evaluated according to the numerical techniques described in Press et al. (1996, Numerical Recipees in C, 2nd Ed., Cambridge University Press, Chapter 4).

As one skilled in the art readily appreciates, the above method of comparing the integrals of hybridization curves is identical to comparing the areas beneath those curves. In particular, the objective metric Q in Equation 10 above is equivalent to the difference in the areas beneath the hybridization curves.

In some embodiments, the objective metric Q in Equation 10 is a monotonic function of the difference in specific hybridization levels of the two probes. Thus, larger values of the objective metric indicate that probe a detects more specific signals to its complementary sequences than probe b, whereas smaller values of the objective metric indicate that probe a detects less specific signals to its complementary sequences than probe b.

The objective metric may be used, therefore, to evaluate and/or rank the relative specificities of a plurality of probes for their respective complementary polynucleotides. For example, given a set of probes (a, b, c, etc.), one skilled in the art can readily evaluate, compare and/or rank the specificity of each probe for a particular sample by comparing and/or ranking the value of the objective metric Q for each probe. Thus, for example, if Q^{a}<Q^{b}, one skilled in the art would readily appreciate that probe a is more effective in detecting specific binding signal from its complementary sequences than is probe b.

Because those probes which are most specific for a particular polynucleotide are generally best suited for detection of the particular polynucleotide by hybridization, the objective metric of the present invention may also be used to select a probe or probes out of two or more candidate probes for detecting a particular gene by hybridization. Specifically, the probe or probes for detecting the particular gene are selected by selecting those probes having the highest value of the objective metric Q for the gene.

One skilled in the art will also appreciate that the inverse of the objective metric from Equation 10, i.e., 1/Q^{a} may also be used as an objective metric to compare and/or rank hybridization specificities. As one skilled in the art readily appreciates, smaller values of 1/Q^{a} indicate that a particular probe a is more specific for its complementary sequences, whereas larger values of 1/Q^{a} indicate that the probe is less specific. Thus, the objective metric 1/Q^{a} may likewise be used, e.g., to evaluate and/or rank the relative specificity of a particular probe for different polynucleotides, to evaluate and/or rank the relative specificity of different probes for the same polynucleotide, and to select a probe or probes for detecting a particular polynucleotide.

### 5.2.1. Determination of Hybridization Levels

To practice the methods of the present invention, hybridization levels and/or hybridization curves are obtained or provided for a sample or samples of nucleic acid molecules. Preferably, these samples comprise a mixture of different polynucleotide sequences, preferably having different specificities for a given probe, and preferably including one or more particular polynucleotide sequences of interest to a user. The concentration of nucleic acid sequences in the sample which is used to measure hybridization curves is low such that the binding sites on the microarray are not saturated. Preferably, less than about 50% of surface binding molecules form hybridization duplexes, more preferably less than about 10% of surface binding molecules form hybridization duplexes. In one, exemplary specific embodiment, the nucleic acid molecules in the sample comprise different polynucleotide sequences, each of a different, unknown abundance. In another exemplary embodiment, all the nucleic acid molecules in the sample are of known sequence and abundance.

The nucleic acid molecules may be from any source. For example, the nucleic acid molecules may be naturally occurring nucleic acid molecules such as genomic or extragenomic DNA molecules isolated from an organism, or RNA molecules, such as mRNA molecules, isolated from an organism. Alternatively, the nucleic acid molecules may be synthesized, including, e.g., nucleic acid molecules synthesized enzymatically in vivo or in vitro, such as, for example, cDNA molecules, or nucleic acid molecules synthesized by PCR, RNA molecules synthesized by in vitro transcription, etc. The sample of nucleic acid molecules can comprise, e.g., molecules of DNA, RNA, or copolymers of DNA and RNA.

In preferred embodiments, the target polynucleotides to be analyzed are prepared in vitro from nucleic acids extracted from cells. For example, in one embodiment, RNA is extracted from cells (e.g., total cellular RNA, poly(A)⁺ messenger RNA, fraction thereof) and messenger RNA is purified from the total extracted RNA Methods for preparing total and poly(A)⁺ RNA are well known in the art, and are described generally, e.g., in Sambrook et al., supra. In one embodiment, RNA is extracted from cells of the various types of interest in this invention using guanidinium thiocyanate lysis followed by CsCl centrifugation and an oligo dT purification (Chirgwin et al., 1979, Biochemistry 18:5294-5299). In another embodiment, RNA is extracted from cells using guanidinium thiocyanate lysis followed by purification on RNeasy columns (Qiagen). cDNA is then synthesized from the purified mRNA using, e.g., oligo-dT or random primers. In preferred embodiments, the target polynucleotides are cRNA prepared from purified total RNAs extracted from cells. As used herein, cRNA is defined here as RNA complementary to the source RNA. The extracted RNAs are amplified using a process in which doubled-stranded cDNAs are synthesized from the RNAs using a primer linked to an RNA polymerase promoter in a direction capable of directing transcription of anti-sense RNA. Anti-sense RNAs or cRNAs are then transcribed from the second strand of the double-stranded cDNAs using an RNA polymerase (see, e.g., U.S. Pat. Nos. 5,891,636, 5,716,785; 5,545,522 and 6,132,997; see also, U.S. patent application Ser. No. 09/411,074, filed Oct. 4, 1999 by Linsley and Schelter and U.S. Provisional Patent Application Ser. No. 60/253,641, filed on Nov. 28, 2000, by Ziman et al.). Both oligo-dT primers (U.S. Pat. Nos. 5,545,522 and 6,132,997) or random primers (U.S. Provisional Patent Application Ser. No. 60/253,641, filed on Nov. 28, 2000, by Ziman et al.) that contain an RNA polymerase promoter or complement thereof can be used. Preferably, the target polynucleotides are short and/or fragmented polynucleotide molecules which are representative of the original nucleic acid population of the cell.

Preferably, the polynucleotide molecules to be analyzed by the methods of the invention are detectably labeled. The cDNA can be labeled directly, e.g., with nucleotide analogues, or a second, labeled cDNA strand can be made using the first strand as a template. Alternatively, the double-stranded cDNA can be transcribed into cRNA and labeled.

Preferably, the detectable label is a fluorescent label, e.g., by incorporation of nucleotide analogues. Other labels suitable for use in the present invention include, but are not limited to, biotin, iminobiotin, antigens, cofactors, dinitrophenol, lipoic acid, olefinic compounds, detectable polypeptides, electron rich molecules, enzymes capable of generating a detectable signal by action upon a substrate, and radioactive isotopes. Preferred radioactive isotopes include ³²P, ³⁵S, ¹⁴C, and ¹²⁵I. Fluorescent molecules suitable for the present invention include, but are not limited to, fluorescein and its derivatives, rhodamine and its derivatives, texas red, 5′carboxy-fluorescein (“FAM”), 2′,7′-dimethoxy-4′,5′-dichloro-6-fluorescein (“JOE”), N,N,N′,N′-tetramethyl-6-carboxy-rhodamine (“TAMRA”), 6-carboxy-X-rhdoamine (“ROX”), HEX, TET, IRD40, and IRD41. Fluorescent molecules which are suitable for the invention further include: cyamine dyes, including but not limited to Cy2, Cy3, Cy3.5, Cy5, Cy5.5, Cy7 and FLUORX; BODIPY dyes including but not limited to BODIPY-FL, BODIPY-TR, BODIPY-TMR, BODIPY-630/650, and BODIPY-650/670; and ALEXA dyes, including but not limited to ALEXA-488, ALEXA-532, ALEXA-546, ALEXA-568, and ALEXA-594; as well as other fluorescent dyes which will be known to those who are skilled in the art. Electron rich indicator molecules suitable for the present invention include, but are not limited to, ferritin, hemocyanin, and colloidal gold. Alternatively, in less preferred embodiments the polynucleotide may be labeled by specifically complexing a first group to the polynucleotide. A second group, covalently linked to an indicator molecule, and which has an affinity for the first group could be used to indirectly detect the polynucleotide. In such an embodiment, compounds suitable for use as a first group include, but are not limited to, biotin and iminobiotin. Compounds suitable for use as a second group include, but are not limited to, avidin and streptavidin.

The labeled polynucleotide molecules to be analyzed by the methods of the invention are contacted to a probe, or to a plurality of probes under conditions that allow polynucleotide molecules having sequences complementary to the probe or probes to hybridize thereto.

The probes of the invention comprise polynucleotide sequences which, in general, are at least partially complementary to at least some of the polynucleotide molecules to be analyzed. In particular, the probes are preferably complementary or partially complementary to one or more polynucleotide sequences of interest to a user. The polynucleotide sequences of the probe may be, e.g., DNA sequences, RNA sequences, or sequences of a copolymer of DNA and RNA. For example, the polynucleotide sequences of the probe may be full or partial sequences of genomic DNA, cDNA, or mRNA sequences extracted from cells. The polynucleotide sequences of the probes may also be synthesized oligonucleotide sequences. The probe sequences can be synthesized either enzymatically in vivo, enzymatically in vitro, e.g., by PCR, or non-enzymatically in vitro.

In some embodiments of the invention, one or more reference probes each having a sequence that is not specifically hybridizable by nucleotide sequences in the sample, e.g., having a sequence that is different from sequences in the sample by at least one nucleotide, are used. Preferably, such reference probes have sequences that are different from any known or suspected sequences in the sample by at least 1, 5, 10, 20 or 30 nucleotides. The choice of the number of different nucleotides in a reference probe depends in part on the length of the polynucleotide probe. For example, it is well-known in the art for polynucleotide probes of sequences in the range of 5-25 nucleotides, a single nucleotide difference affects binding specificity significantly, whereas for polynucleotide probes of longer sequences, more different nucleotides is required for distinguishable difference in binding specificity. Such relationship between difference in number of mismatch nucleotides and difference in specificity can be determined using various known methods (see, e.g., Friend et al., PCT publication WO 01/05935) In a more preferred embodiment, reference probe having a sequence that is a reverse complement of a sequence or a sequence that has a sequence that has reverse nucleotide order to a sequence in the sample and that is different from any other known or predicted sequences in the sample is used. In some embodiments of the invention, probes of 60 nucleotides are used in a microarray. In a preferred embodiment, a 60mer reference probe has a sequence that is different from any known or suspected sequences in the sample by at least 5 or 10 nucleotides. In another preferred embodiment, a 60 mer reference probe has a sequence that has one mismatched base placed at a distance of 50 bases from the surface attachment. In a more preferred embodiment, a 60 mer reference probe has a sequence that is different from any known or suspected sequences in the sample by at least 18 nucleotides.

The probe or probes used in the methods of the invention are preferably immobilized to a solid support or surface such that polynucleotide sequences which are not hybridized or bound to the probe or probes may be washed off and removed without removing the probe or probes and any polynucleotide sequence bound or hybridized thereto. In one particular embodiment, the probes will comprise an array of distinct polynucleotide sequences bound to a solid support or surface, such as a glass surface. Preferably, each particular polynucleotide sequences is at a particular, known location on the surface. Alternatively, the probes may comprise double-stranded DNA comprising genes or gene fragments, or polynucleotide sequences derived therefrom, bound to a solid support or surface, such as a glass surface or a blotting membrane (e.g., a nylon or nitrocellulose membrane).

The conditions under which the polynucleotide molecules are contacted to the probe or probes preferably are selected for optimum stringency; i.e., under conditions of salt and temperature which create an environment close to the melting temperature for specifically bound duplexes of the labeled polynucleotides and the probe or probes. For example, the temperature is preferably within 10-15° C. of the approximate melting temperature (“Tₘ”) of a completely complementary duplex of two polynucleotide sequences (Le., a duplex having no mismatches). Melting temperatures may be readily predicted for duplexes by methods and equations which are well known to those skilled in the art (see, e.g., Wetmur, 1991, Critical Reviews in Biochemistry and Molecular Biology 26:227-259), or, alternatively, such melting temperatures may be empirically determined using methods and techniques well known in the art, and described, e.g., in Sambrook, J. et al., eds., 1989, Molecular Cloning: A Laboratory Manual, 2nd Ed., Cold Spring Harbor Laboratory Press, Cold Spring Harbor, N.Y., at pp. 9.47-9.51 and 11.55-11.61; Ausubel et al., eds., 1989, Current Protocols in Molecules Biology, Vol., Green Publishing Associates, Inc., John Wiley & Sons, Inc., New York, at pp. 2.10.1-2.10.16. The exact conditions will depend on the specific nucleic acid molecules to be analyzed as well as on the particular probes, and may be determined by one of skill in the art (see, e.g., Sambrook et al, supra; Ausubel, F. M. et al., supra).

Hybridization levels are most preferably measured at hybridization times spanning the range from 0 to in excess of what is required for sampling of the bound polynucleotides (i.e., the probe or probes) by the labeled polynucleotides so that the mixture is close to or substantially reached equilibrium, and duplexes are at concentrations dependent on affinity and abundance rather than diffusion. However, the hybridization times are preferably short enough that irreversible binding interactions between the labeled polynucleotide and the probes and/or the surface do not occur, or are at least limited. For example, in embodiments wherein polynucleotide arrays are used to probe a complex mixture of fragmented polynucleotides, typical hybridization times may be approximately 0-72 hours. Appropriate hybridization times for other embodiments will depend on the particular polynucleotide sequences and probes used, and may be determined by those skilled in the art (see, e.g., Sambrook, J. et al., supra).

The method of the invention relies on measurement of hybridization levels at more than one hybridization time. In one embodiment, hybridization levels at different hybridization times are measured separately on different, identical microarrays. For each such measurement, at hybridization time when hybridization level is measured, the microarray is washed briefly, preferably in room temperature in an aqueous solution of high to moderate salt concentration (e.g., 0.5 to 3 M salt concentration) under conditions which retain all bound or hybridized polynucleotides while removing all unbound polynucleotides. The detectable label on the remaining, hybridized polynucleotide molecules on each probe is then measured by a method which is appropriate to the particular labeling method used. The resulted hybridization levels are then combined to form a hybridization curve. In another embodiment, hybridization levels are measured in real time using a single microarray. In this embodiment, the microarray is allowed to hybridize to the sample without interruption and the microarray is interrogated at each hybridization time in a non-invasive manner. In still another embodiment, one can use one array, hybridize for a short time, wash and measure the hybridization level, put back to the same sample, hybridize for another period of time, wash and measure again, and repeat this process to get the hybridization time curve. It will be apparent to one skilled in art that any of these embodiments of methods for measurement of hybridization levels can be automated.

Preferably, at least two hybridization levels at two different hybridization times are measured, a first one at a hybridization time that is close to the time scale of cross-hybridization equilibrium and a second one measured at a hybridization time that is longer than the first one. The time scale of cross-hybridization equilibrium depends, inter alia, on sample composition and probe sequence and may be determined by one skilled in the art. In preferred embodiments, the first hybridization level is measured at between 1 to 10 hours, whereas the second hybridization time is measured at about 2, 4, 6, 10, 12, 16, 18, 48 or 72 times as long as the first hybridization time.

The equilibrium times for specific hybridization and non-specific hybridization also depend on the average size of target molecules in a sample. For example, target molecules of smaller sizes tend to reach hybridization equilibrium more quickly. (see, e.g., Example 6.4., infra). Preferably, the average size of target molecules in a sample is at least the same as the size of the probes. More preferably, the average size of target molecules in a sample is greater than the size of the probes. For example, when probes of 60 nucleotides are used, the average size of target molecules in a sample is preferably at least, more preferably greater than, 60 bases long. Preferably, in samples used in the present invention, all sequences are represented by target molecules of similar size distributions. In preferred embodiments of the invention, hybridization levels at hybridization times such that the equilibrium time for non-specific hybridization and hybridization times that are at least 2, 4, 8, 16, 24, 36, or 48 times longer than the equilibrium time for non-specific hybridization are measured to allow accurate characterization of the hybridization kinetics. The equilibrium time for specific hybridization and non-specific hybridization for samples containing target molecules of a particular average size can be determined using samples containing target molecules of a known average size (see, e.g., Example 6.4., infra).

In some embodiments of the invention, the average size of target nucleic acid molecules in a sample is governed by the method used for preparing the sample. In such embodiments, hybridization levels are preferably measured at hybridization times such that the equilibrium time for non-specific hybridization and hybridization times that are at least 2, 4, 8, 16, 24, 36, or 48 times longer than the equilibrium time for non-specific hybridization are measured to allow accurate characterization of the hybridization kinetics. In an exemplary embodiment, a method involving the use of ZnCl₂ is used to prepare a sample. The method yields a sample containing target molecules of an average size in the range of about 50-100 bases (see, e.g., Example 6.4., infra). In this embodiment, hybridization levels are preferably measured by microarray(s) of 60 mer probes at hybridization times at 2, 4, 8, 12, 16, 24, and 36 hours.

In some other embodiments, the period of time during which a kinetics experiment is conducted is first chosen. In such embodiments, the invention provides methods for controlling the average size of nucleic acid molecules in a sample to achieve desirable equilibrium times for specific and non-specific hybridizations such that the kinetics method is optimized for the chosen period of time during which a kinetics experiment is conducted in determining specific and non-specific hybridization in such samples. In preferred embodiments, the average sizes of target molecules in a sample is controlled such that the equilibrium time for specific hybridization is distinguishable from the equilibrium time for non-specific hybridization, e.g., the equilibrium time for specific hybridization is at least 2, 4, 8, 16, 24, 36, or 48 times longer than the equilibrium time for non-specific hybridization.

### 5.2.2. Method for Identifying Specific Hybridization

The present invention provides methods for determining whether specific hybridization to a polynucleotide probe occurs by comparing hybridization levels measured at a plurality of different hybridization times. By making use of hybridization levels measured at more than one hybridization time, such methods take advantage of the increase of hybridization specificity during approach to hybridization equilibrium. The methods are particularly useful in identifying nucleotide sequences in a sample comprising plurality of nucleic acid molecules having different nucleotide sequences.

In one embodiment, hybridization level of a given probe is measured at two or more hybridization times. The relative hybridization level at these hybridization times are compared. A metric is determined from such comparing and used to indicate change in hybridization level at the probe. An increase in hybridization level after cross-hybridization equilibrium is reached indicates specific hybridization to the probe by the sample. The metric that is used to indicate change in hybridization level can be simple arithmetic difference between the hybridization levels measured at different hybridization times. Preferably, the metric is the ratio of the hybridization levels measured at different hybridization times. More preferably, the metric is the quantity xdev as defined by Eqs. (7) or (8). The presence of specific hybridization to the probe is then identified if the value of the metric is greater than a predetermined threshold level, whereas the absence of specific hybridization to the probe is identified if the value of the metric is less than a predetermined threshold level. The threshold level depends on the metric used and the sequences of interest as well as experimental conditions, e.g., stringency condition, and may be determined by those skilled in the art. In preferred embodiments, a threshold level of 2, 3, 4, 5 or 10 is used for xdev.

Preferably, at least one hybridization level is measured at a hybridization time that is longer than the time scale for cross-hybridization to substantially reach equilibrium. More preferably, at least a first hybridization level is measured at a hybridization time that is close to the time scale for cross-hybridization to substantially reach equilibrium and at least a second hybridization level is measured at a hybridization time that is longer than the first hybridization time. In some preferred embodiments of the invention, the said first hybridization time at which hybridization levels are measured is chosen to be a hybridization time when hybridization levels reach at least 60%, 70%, 80%, or 90% of the equilibrium cross-hybridization level. Hybridization specificity is then identified if the hybridization level increase measured at the second hybridization time is substantially higher than the increase cross-hybridization can cause. In preferred embodiments, the said second hybridization time is chosen to be at least 2, 4, 6, 10, 12, 16, 18, 48 or 72 times as long as the said first hybridization time.

The time scale for substantially reaching cross-hybridization equilibrium at a given probe can be determined in situ, or, alternatively, can be determined previously and stored in a database. Any method known in the art can be used to determine the time scale of cross-hybridization equilibrium. In one embodiment, one or more reference probes each having a sequence that is not specifically hybridizable to any known or suspected nucleotide sequences in the sample, i.e., having a sequence that is different from sequences in the sample by at least one nucleotide, are used to determine the time scale for reaching cross-hybridization equilibrium. Preferably, each of such reference probes hybridizes to any known or predicted sequences in the sample with at least 3%, 5%, 10%, 20% or 30% mismatched bases in the probe. In a more preferred embodiment, reference probe having a sequence that is a reverse complement of a sequence in the sample and that is different from any other sequences in the sample is used. Hybridization levels at such reference probes are measured at a plurality of time to generate reference hybridization curves. The hybridization time at which hybridization levels of reference probes substantially reach the equilibrium hybridization level, e.g., 95% of the equilibrium level, is identified as the time scale of cross-hybridization equilibrium. The method described is equally applicable for determining the time scale for substantially reaching specific hybridization equilibrium at a given probe.

The measurement of hybridization levels can be performed by any method known in the art. In a preferred embodiment, hybridization levels are measured using microarray based methods (see, Section 5.2.1, supra). In a most preferred embodiment, measurement of hybridization levels is performed by contacting microarrays comprising probes having predetermined sequences with a sample comprising a plurality of nucleic acid molecules having different nucleotide sequences under a chosen stringency condition. A plurality of hybridization levels at different hybridization times are measured either in real time or separately on different, identical microarrays as described in Section 5.2.1.

### 5.2.3. Method for Determining Abundance

The invention also provides methods for determining relative abundances of a nucleotide sequence in different samples, e.g., different tissues or same tissue at different development stages or under different environmental conditions. This is particularly useful when ratio is used as the metric to represent the relative abundance of the nucleotide sequence. Rates of increase in hybridization levels may be more sensitive than absolute hybridization levels in that the time-independent constant background that contributes to the absolute hybridization level does not contribute to the rates.

In a preferred embodiment, the relative abundance of a nucleotide sequence in different sample is determined by determining the ratio of the rates of increase in hybridization levels of the probe specifically hybridized with the nucleotide sequence from two different samples. Preferably, the rate of increase in specific hybridization is represented by determining the difference in hybridization levels measured at a first hybridization time that is close to the time scale of cross-hybridization equilibrium and a second hybridization time that is longer than the first hybridization time.

### 5.2.4. Method for Comparing Specific Binding to Different Probes

The increase of hybridization specificity during approach to hybridization equilibrium can also be used to compare hybridization specificities of different polynucleotide probes. Such methods are based on comparison of hybridization curves representing progression of hybridization levels of respective probes.

In one embodiment, hybridization curves of one or more probes having different nucleotide sequences are measured using a sample comprising target nucleotide sequences complementary to the probes and non-target nucleotide sequences, i.e., nucleotide sequences not complementary to any of the probes. Preferably, the abundances of the target nucleotide sequences, i.e., sequences complementary to the probes in the sample, are known. In one embodiment, the abundance of each different target sequence is predetermined. In another embodiment, the abundance of each different target sequence is equal. Hybridization levels at the one or more probes are measured at a plurality of time to generate respective hybridization curves.

The measurement of hybridization levels can be performed by any method known in the art. In a preferred embodiment, hybridization levels are measured using microarray based method (see, Section 5.2.1, supra). In a most preferred embodiment, measurement of hybridization levels is performed by contacting microarrays comprising the one or more probes with the sample under a chosen stringency condition. A plurality of hybridization levels at different hybridization times are measured either in real time or separately on different, identical microarrays as described in Section 5.2.1.

The hybridization curves for the one or more different probes are then compared pair wise to determine a metric for each pair of curves. In a preferred embodiment, the metric Q as defined in Equation 10 supra, i.e., the difference in the areas beneath the hybridization curves is used. As described supra, the metric Q is a monotonic function of difference in specific hybridization the two probes compared, i.e., larger values of the objective metric indicate that probe a is relatively more specific to its complementary sequences than probe b. The metric can also be the area underneath the ratio curve of the hybridization curves or the area underneath the curve of quantity xdev as defined by Eqs. (7) or (8).

In another embodiment, comparison of the hybridization curve representing progression of hybridization level of a probe and the hybridization curve representing progression of hybridization level of a reference probe by a sample comprising a plurality of nucleic acid molecules having different nucleotide sequences is used for identifying specific hybridization to the probe. Preferably, such hybridization curves are measured using microarry based method (see, Section 5.2.1, supra). In one embodiment, one or more reference probes each having a sequence that is not complementary to any nucleotide sequences in the sample, i.e., having a sequence that is different from complementary sequences of any known or predicted sequences in the sample by at least one nucleotide, are used to determine the time scale for reaching cross-hybridization equilibrium. Preferably, such reference probes having sequences that are different from complementary sequences of any known or predicted sequences in the sample by at least 2, 5 or 10 nucleotides. In a more preferred embodiment, reference probe having a sequence that is a reverse complement of a sequence in the sample and that is different from any other sequences in the sample is used. The hybridization curves for the probe and the reference probe are then compared to determine a metric. In a preferred embodiment, the metric Q is used to indicate the difference in specificities between the probe and the reference probe. A value of Q that is larger than a predetermined threshold value indicates that the probe is relatively more specific to its complementary sequences than the reference probe. A appropriate threshold value can be obtained, e.g., by comparing probes of known specificities with the reference probe. Alternatively, reference probes specifically hybridizable to sequences in the sample with known specificities can be used. In such embodiment, a value of Q that is smaller or larger than a predetermined threshold value indicates that the probe is relatively less or more specific to its complementary sequences than the reference probe.

The methods of the invention are not limited to compare probes hybridized to complementary sequences. In one embodiment, a sample known to contain no complementary sequences to the probes is hybridized with the probes. A comparison of hybridization curves thus gives information on the relative difference in severeness of cross-hybridization to the different probes.

### 5.2.5. Method for Ranking and Selecting Probes

The methods described in Section 5.2.5. can be used to compare and rank the specificities of a plurality of different probes. Such methods are especially useful in experimentally ranking and selecting the most specific probes for the detection of a gene or exon. The methods can be used in conjunction with specificity based probe design (see, e.g., Friend et al., PCT publication 01/05935; Burchard, PCT publication 01/06013, published on Jan. 12, 2001.

In one embodiment, pair wise comparisons of hybridization curves is performed. The hybridization curves are preferably obtained by a microarry based method (see, Section 5.2.1, supra) using a sample having target nucleotide sequences complementary to the probes and non-target nucleotide sequences, i.e., nucleotide sequences not complementary to any of the probes. The hybridization curves can be as measured or already stored in a database. Preferably, the abundances of the target nucleotide sequences, i.e., sequences complementary to the probes in the sample, are known. In one embodiment, the abundance of each different target sequence is predetermined. In another embodiment, the abundance of each different target sequence is equal. The probes are then ranked according to their relative specificities.

In another embodiment, hybridization curve of each of the plurality of probes is compared with the hybridization curve of one or more reference probes. In one embodiment, the one or more reference probes each having a sequence that is not specifically hybridizable to any nucleotide sequences in the sample, i.e., having a sequence that is different from any known or predicted sequences in the sample by at least one nucleotide. Preferably, each of such reference probes hybridizes to any known or predicted sequences in the sample with at least 3%, 5%, 10%, 20% or 30% mismatched bases in the probe. In a more preferred embodiment, reference probe having a sequence that is a reverse complement of a sequence in the sample and that is different from any other sequences in the sample is used. The probes are then ranked according to their relative specificities with the reference probe(s), e.g., in order of lower to higher specificities starting from the one with a specificity most close to the reference. In another embodiment, the one or more reference probes each having a sequence that is specifically hybridizable to a nucleotide sequence in the sample, i.e., having a sequence that is complementary to a sequence in the sample, with a known specificity. In such an embodiment, the specificities of probes are ranked according to specificity as compared to the known specificity of the reference probe. This embodiment is particularly useful in selecting probes that have similar specificities.

### 5.2.6. Method for Determining Gene Structures and Expression Profiling

The invention provides an improved method for detecting the presence or absence of nucleotide sequences in a sample comprising a plurality of different nucleotide sequences. In the method the presence of a nucleotide is identified by the presence of specific hybridizations to polynucleotide probes having predetermined sequences. The presence of specific hybridization to a probe is determined by methods described in Section 5.2.2. In a preferred embodiment, the presence or absence of one or more nucleotide sequences in a sample is determining using one or more microarrays comprising probes specifically hybridizable to such nucleotide sequences. In the embodiment, one or more polynucleotide arrays comprising a plurality of probes specifically hybridizable to predetermined sequences are contacted with the sample and a first hybridization level I₁ of a first hybridization time and a second hybridization level I₂ of a second hybridization time are determined for each of the probes. Change of hybridization level from I₁ to I₂ is then measured using a suitable metric, e.g., ratio of I₂ to I₁, difference of I₂ to I₁ or the quantity xdev of I₂ to I₁, for each probe is then determined. The presence of a nucleotide sequence is then identified if the value of the metric is greater than a predetermined threshold level, whereas the absence of a nucleotide sequence is identified if the value of the metric is less than a predetermined threshold level. The threshold level depends on the metric used and the sequences of interest as well as experimental conditions, e.g., stringency condition, and may be determined by those skilled in the art. In a preferred embodiment, a threshold level of 2, 4 or 10 is used for xdev.

In one embodiment, the method can be used for determining gene structures, e.g., in exon searches using microarrays. Exons can be identified by using DNA arrays that contain polynucleotide probes of successive overlapping sequences, ie., tiled sequences, across genomic regions. See, e.g., U.S. patent application Ser. No. 09/781,814, filed on Feb. 12, 2001, which is incorporated herein by reference in its entirety. Such DNA arrays therefore scan the genomic regions to identify expressed exons in these regions. According to the method, DNA arrays are generated comprising polynucleotide probes with successive overlapping sequences which span or are tiled across genomic regions of interests, e.g., successive overlapping probe sequences can be tiled at steps of a predetermined base intervals, e.g. at steps of 1, 5, 10, or 15 bases intervals. The overlapping sequences of the DNA arrays therefore comprise probes for both exons and introns. For example, DNA arrays comprising 25,000 different polynucleotide probes of up to 60 bases in length can be synthesized on a single 1 in x 3 in glass slide by ink-jet technology. RNA samples from diverse tissues or growth conditions are then labeled using full length labeling protocols, such as the random primed reverse transcription protocols and hybridized to the DNA arrays. Exons and exon/intron boundaries can be identified by presence or absence of specific hybridization to the probes on the microarray using xdev's obtained from measured hybridization levels. In one embodiment, hybridization levels are measured at a first hybridization time of 4 hours and a second hybridization time of 72 hours and an xdev for a probe greater than 2 is used as an indication of specific hybridization to the probe. The error weighting presents in xdev's helps prevent false conclusions from probes for which measurement noise contributes large fractional error in the measured hybridization level.

### 5.2.7. Method for Determining Orientation of Nucleotide Sequences

The invention also provide methods for determining the orientation of a nucleotide sequence in a sample by comparing its specific hybridization to a forward polynuceotide probe which comprises the sequence in a forward direction and a reverse polynucleotide probe which comprises the sequence in a reverse direction. It will be understood by one skilled in the art that the designation of forward and reverse direction of the probe sequences is of no particular importance. Any one of a pair of forward and reverse sequences can be designated as the sequence in the forward direction. Once a designation of the forward sequence has been made, the other sequence in the pair is designated as the sequence in the reverse direction. In the methods, the presence or absence of hybridization to one or the other probe in a pair of forward and reverse probes are determined. The presence of hybridization to one but not the other probe in the pair is used to identify the orientation of the sequence. Any methods can be used for determining the presence of hybridization to the forward and reverse probes. In one embodiment, hybridization levels of the forward and reverse probes are measured and compared to determine the orientation of the nucleotide sequence. In preferred embodiments, kinetic methods, i.e., the methods utilizing changes of hybridization levels during approach to hybridization equilibrium as described supra are used to determine specific hybridizations to the forward and/or reverse probes. In more preferred embodiments, kinetic methods are used to determine specific hybridizations to both the forward and reverse probes. When kinetic methods are used, hybridization levels of the forward and reverse probes are both measured at a plurality of hybridization times so that specific hybridization to the forward or the reverse probe can be determined. The hybridization levels at the forward and reverse probes can be measured concurrently or separately.

In particularly preferred embodiments, microarray-based methods are used to determine specific hybridizations to the forward and reverse probes. In one preferred embodiment, the method used comprises contacting a array comprising a forward probe comprising said sequence in forward direction and a reverse probe comprising said sequence in reverse direction with a sample. The presence or absence of hybridization to the forward or the reverse probes are determined by measuring hybridization levels of the forward probe at a first plurality of hybridization times and measuring hybridization levels of the reverse probe at a second plurality of hybridization times, and determining and comparing changes of hybridization levels of the forward probe and the reverse probe. The orientation of said nucleotide sequence are then determined by comparing the changes of hybridization levels of the forward and the reverse probes. In preferred embodiments, the first plurality of hybridization times consists of a first hybridization time and a second hybridization times, whereas the second plurality of times consists of a third hybridization time and a fourth hybridization times. In a preferred embodiment, the first and third hybridization times are 1 to 4 hours. In another preferred embodiment, the second and the fourth hybridization times are at least 2, 4, 12, 16, 48 or 72 times as long as said first and third hybridization times, respectively. In more preferred embodiments, the first and the third hybridization times are the same, and the second and the fourth hybridization times are the same.

In one preferred embodiment, changes of hybridization levels of the forward and the reverse probes are determining by calculating a quantity xdev_{f} as described by equation (11)

$${xdev}_{f} = \frac{{I}_{f 2} - {I}_{f 1}}{\sqrt{{err ( {I}_{f 1} )}^{2} + {err ( {I}_{f 2} )}^{2}}} \qquad ( 11 )$$

for the forward probe and a quantity xdevᵣ as described by equation (12)

$${xdev}_{r} = \frac{{I}_{r 4} - {I}_{r 3}}{\sqrt{{err ( {I}_{r 3} )}^{2} + {err ( {I}_{r 4} )}^{2}}} \qquad ( 12 )$$

for the reverse probe, where I_{f1} and I_{f2} are hybridization levels of the forward probe measured at the first and second hybridization time, respectively, Iᵣ₃ and Iᵣ₄ are hybridization levels of the reverse polynucleotide probe at the third and fourth hybridization times, respectively, and the err(I_{f1}), err(I_{f2}), err(Iᵣ₃) and err(Ir₄) are expected errors in said hybridization levels I_{f1}, I_{f2}, Iᵣ₃ and Iᵣ₄, respectively. The orientation of the nucleotide sequence is determined as forward when
xdev_{f}>th1 xdev_{f}−xdevᵣ>th2 (13)
or as reversed when
xdevᵣ>th1 xdevᵣ−xdev_{f}>th2 (14)
where both th1 and th2 are predetermined threshold values.

In still another embodiment of the invention, when the second and the fourth hybridization times are the same, the orientation of the nucleotide sequence is determined by calculating a quantity t according to equation (15)

$$t = \frac{{I}_{f 2} - {I}_{r 4}}{{σ}_{{I}_{f 2} - {I}_{r 4}}} \qquad ( 15 )$$

where I_{f2} is the hybridization level of the forward polynucleotide probe at the second hybridization time, Iᵣ₄ is the hybridization level of the reverse polynucleotide probe at the fourth hybridization time, and σ_{I}_{_{f2}}_{-I}_{ᵣ₄} is error of the difference between I_{f2} and Iᵣ₄. The orientation of the nucleotide sequence is determined as forward if t>th, and reverse if t<−th, where th is a predetermined threshold value. Any methods known in the art can be used to determine the error of the difference between I_{f2} and Iᵣ₄.

In other embodiments, this kinetic strand orientation method can be applied to a plurality of samples, e.g., a plurality of different samples of an organism, each of the plurality of samples is under a different condition, e.g., samples from tissues of different types, different development stages, or under different environmental perturbations, e.g., drug perturbations. The results from such a plurality of samples can be combined to enhance both the oligonucleotide probe call rate and the accuracy of strand determination, e.g., for a sequence of the organism. This improvement in call rate and accuracy occurs because under some conditions, i.e., cell lines or tissues, the cRNA that will hybridize to either the forward or reverse probe sequences are at low abundance in the original mRNA sample, thus, resulting in a lower probability of accurate strand determination for probes corresponding to that mRNA. When a cRNA sample is prepared from an appropriate cellular or tissue condition, i.e., a condition in which that mRNA is at high abundance, then the kinetic hybridization method has a higher probability of accurately determining the strand orientation of probes corresponding to that mRNA. Thus, in one embodiment, the kinetic strand orientation method is repeated with a plurality of samples, each sample subject to a different condition, and the results are combined to determine the orientation of the strand. In another embodiment, nucleic acid molecules are pooled together from a plurality of samples, each subject to a different condition, and the kinetic strand orientation method is applied to the pooled sample.

### 5.3. Implementation Systems and Methods

The analytical methods of the present invention can preferably be implemented using a computer system, such as the computer system described in this section, according to the following programs and methods. Such a computer system can also preferably store and manipulate a compendium of the present invention which comprises a plurality of hybridization signal changes profiles and/or rates of changes during approach to equilibrium in different hybridization measurements and which can be used by a computer system in implementing the analytical methods of this invention. Accordingly, such computer systems are also considered part of the present invention.

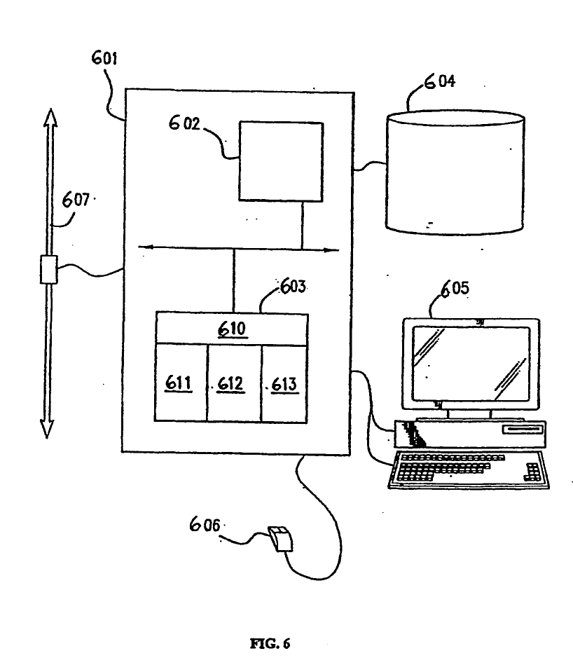

An exemplary computer system suitable from implementing the analytic methods of this invention is illustrated in FIG. 6. Computer system 601 is illustrated here as comprising internal components and as being linked to external components. The internal components of this computer system include a processor element 602 interconnected with a main memory 603. For example, computer system 601 can be an Intel Pentium®-based processor of 200 MHZ or greater clock rate and with 32 MB or more main memory. In a preferred embodiment, computer system 601 is a cluster of a plurality of computers comprising a head “node” and eight sibling “nodes,” with each node having a central processing unit (“CPU”). In addition, the cluster also comprises at least 128 MB of random access memory (“RAM”) on the head node and at least 256 MB of RAM on each of the eight sibling nodes. Therefore, the computer systems of the present invention are not limited to those consisting of a single memory unit or a single processor unit.

The external components can include a mass storage 604. This mass storage can be one or more hard disks that are typically packaged together with the processor and memory. Such hard disk are typically of 1 GB or greater storage capacity and more preferably have at least 6 GB of storage capacity. For example, in a preferred embodiment, described above, wherein a computer system of the invention comprises several nodes, each node can have its own hard drive. The head node preferably has a hard drive with at least 6 GB of storage capacity whereas each sibling node preferably has a hard drive with at least 9 GB of storage capacity. A computer system of the invention can further comprise other mass storage units including, for example, one or more floppy drives, one more CD-ROM drives, one or more DVD drives or one or more DAT drives.

Other external components typically include a user interface device 605, which is most typically a monitor and a keyboard together with a graphical input device 606 such as a “mouse.” The computer system is also typically linked to a network link 607 which can be, e.g., part of a local area network (“LAN”) to other, local computer systems and/or part of a wide area network (“WAN”), such as the Internet, that is connected to other, remote computer systems. For example, in the preferred embodiment, discussed above, wherein the computer system comprises a plurality of nodes, each node is preferably connected to a network, preferably an NFS network, so that the nodes of the computer system communicate with each other and, optionally, with other computer systems by means of the network and can thereby share data and processing tasks with one another.

Loaded into memory during operation of such a computer system are several software components that are also shown schematically in FIG. 6. The software components comprise both software components that are standard in the art and components that are special to the present invention. These software components are typically stored on mass storage such as the hard drive 604, but can be stored on other computer readable media as well including, for example, one or more floppy disks, one or more CD-ROMs, one or more DVDs or one or more DATs. Software component 610 represents an operating system which is responsible for managing the computer system and its network interconnections. The operating system can be, for example, of the Microsoft Windows™ family such as Windows 95, Window 98, Windows NT or Windows 2000. Alternatively, the operating software can be a Macintosh operating system, a UNIX operating system or the LINUX operating system. Software components 611 comprises common languages and functions that are preferably present in the system to assist programs implementing methods specific to the present invention. Languages that can be used to program the analytic methods of the invention include, for example, C and C++, FORTRAN, PERL, HTML, JAVA, and any of the UNIX or LINUX shell command languages such as C shell script language. The methods of the invention can also be programmed or modeled in mathematical software packages that allow symbolic entry of equations and high-level specification of processing, including specific algorithms to be used, thereby freeing a user of the need to procedurally program individual equations and algorithms. Such packages include, e.g., Matlab from Mathworks (Natick, Mass.), Mathematica from Wolfram Research (Champaign, Ill.) or S-Plus from MathSoft (Seattle, Wash.).

Software component 612 comprises analytic methods of the present invention, preferably programmed in a procedural language or symbolic package. For example, software component 612 preferably includes programs that cause the processor to implement steps of accepting a plurality of hybridization signal changes profiles and/or rates of changes and storing the profiles and/or rate data in the memory. For example, the computer system can accept hybridization signal changes profiles and/or rates of changes that are manually entered by a user (e.g., by means of the user interface). More preferably, however, the programs cause the computer system to retrieve hybridization signal changes profiles and/or rates of changes from a storage medium or a database. Such a database can be stored on a mass storage (e.g., a hard drive) or other computer readable medium and loaded into the memory of the computer, or the compendium can be accessed by the computer system by means of the network 607.

In an exemplary implementation to practice the methods of the present invention, hybridization level data (e.g., one or more measured hybridization levels, one or more hybridization curves, etc.) (613) contained in a database and/or loaded into the memory of the computer system is represented by a data structure comprising a plurality of data fields. In particular, the data structure for a particular hybridization signal changes profile will comprise a separate data field for each time at which a measured value, e.g., hybridization level, is an element of the hybridization signal changes profile. The analytic software component 612 comprises programs and/or subroutines which can cause the processor to perform steps of comparing said hybridization level measured at a first time to the hybridization level measured at a second time or the measured hybridization levels of more than one time in said hybridization signal changes profile, for each of said plurality of hybridization signal changes profiles. The computer then output and display the calculated differences, including but are not limited to arithmetic difference, ratio, etc., in the measured hybridization levels for each first and second time as a measure of the rate of hybridization signal changes between said first and second time.

The present invention also relates to a computer system for ranking and selecting polynucleotide probes from a plurality of probes that are most specific for given target nucleotide sequences, comprising one or more processor units and one or more memory units connected to the one or more processor units, said one or more memory units containing one or more programs that carry out the steps of: (a) receiving a first data structure of measured or stored hybridization signal changes profiles and/or rates of changes of a first polynucleotide probe and a second data structure of measured or stored hybridization signal changes profiles and/or rates of changes for a second polynucleotide probe; and (b) comparing said first and second hybridization signal changes profiles and/or rates of changes. The differences in the hybridization signal changes profiles and/or rates of changes, including but are not limited to arithmetic difference, ratio, etc., in said first and second hybridization signal changes profiles and/or rates of changes between said first and second polynucleotide probes can be used to rank the probes according to their specificity.

In other embodiments, the data field for each time point can also contain values representing the stringency condition values, e.g., the temperature and/or salt concentrations, under which the measurements were performed. The hybridization signal changes profiles and/or rates of changes may also comprise additional data fields that contain values describing the sample composition, e.g., the composition of cross-hybridization species in the sample. For example, in embodiments wherein the sample is a particular type of tissue, these fields can contain values that identify the particular tissue such that the cross-hybridization to the probes may be evaluated. The data structure representing an exon expression profile can, optionally, contain other data fields as well. For example, the data structure can further comprise one or more fields whose values indicate the measurement errors during the experiments.

The present invention also provides databases of hybridization signal changes profiles and/or rates of changes during approach to equilibrium obtained in hybridization measurements. The databases of this invention include hybridization signal changes profiles and/or rates of changes for a plurality of polynucleotides corresponding to a plurality of levels of complementarity to a particular probe, or, more generally, to a particular class of probes. More preferably, the database includes hybridization signal changes profiles and/or rates of changes for several probes, or, still more preferably, for several classes of probes. Preferably, such a database will be in an electronic form that can be loaded into a computer system 601. Such electronic forms include databases loaded into the main memory 603 of a computer system used to implement the methods of this invention, or in the main memory of other computers linked by network connection 607, or embedded or encoded on mass storage media 604, or on removable storage media such as a DVD-ROM, CD-ROM or floppy disk.

In addition to the exemplary program structures and computer systems described herein, other, alternative program structures and computer systems will be readily apparent to the skilled artisan. Such alternative systems, which do not depart from the above described computer system and programs structures either in spirit or in scope, are therefore intended to be comprehended within the accompanying claims.

### 5.4. Measurement of Hybridization Levels

In the present invention, hybridization levels are preferably measured using polynucleotide probe arrays or microarrays. On a polynucleotide array, polynucleotide probes comprising sequences of interest are immobilized to the surface of a support, e.g., a solid support. For example, the probes may comprise DNA sequences, RNA sequences, or copolymer sequences of DNA and RNA. The polynucleotide sequences of the probes may also comprise DNA and/or RNA analogues, or combinations thereof. For example, the polynucleotide sequences of the probe may be full or partial sequences of genomic DNA or mRNA derived from cells, or may be cDNA or cRNA sequences derived therefrom. The polynucleotide sequences of the probes may also be synthetic nucleotide sequences, such as synthetic oligonucleotide sequences. The probe sequences can be synthesized either enzymatically in vivo, enzymatically in vitro (e.g., by PCR), or non-enzymatically in vitro.

The probe or probes used in the methods of the invention are preferably immobilized to a solid support or surface which may be either porous or non-porous. For example, the probes of the invention may be polynucleotide sequences which are attached to a nitrocellulose or nylon membrane or filter. Such hybridization probes are well known in the art (see, e.g., Sambrook et al., Eds., 1989, Molecular Cloning: A Laboratory Manual, Vols. 1-3, 2nd ed.,, Cold Spring Harbor Laboratory, Cold Spring Harbor, N.Y.). Alternatively, the solid support or surface may be a glass or plastic surface.

### 5.4.1. Hybridization Assay Using Microarrays

A microarray is an array of positionally-addressable binding (e.g., hybridization) sites on a support. Each of such binding sites comprises a plurality of polynucleotide molecules of a probe bound to the predetermined region on the support. Microarrays can be made in a number of ways, of which several are described herein below. However produced, microarrays share certain characteristics. The arrays are reproducible, allowing multiple copies of a given array to be produced and easily compared with each other. Preferably, the microarrays are made from materials that are stable under binding (e.g., nucleic acid hybridization) conditions. The microarrays are preferably small, e.g., between about 1 cm² and 25 cm², preferably about 1 to 3 cm². However, both larger and smaller arrays are also contemplated and may be preferable, e.g., for simultaneously evaluating a very large number of different probes.

In a particularly preferred embodiment, hybridization levels are measured to microarrays of probes consisting of a solid phase on the surface of which are immobilized a population of polynucleotides, such as a population of DNA or DNA mimics or, alternatively, a population of RNA or RNA mimics. The solid phase may be a nonporous or, optionally, a porous material such as a gel. Microarrays can be employed, e.g., for analyzing the transcriptional state of a cell such as the transcriptional states of cells exposed to graded levels of a drug of interest or to graded perturbations to a biological pathway of interest. Microarrays are particularly useful in the methods of the instant invention in that they can be used to simultaneously screen a plurality of different probes to evaluate, e.g., each probe's sensitivity and specificity for a particular target polynucleotide.

Preferably, a given binding site or unique set of binding sites on the microarray will specifically bind (e.g., hybridize) to the product of a single gene or gene transcript from a cell or organism (e.g., to a specific mRNA or to a specific cDNA derived therefrom). However, as discussed above, in general other, related or similar sequences will cross hybridize to a given binding site.

The microarrays used in the methods and compositions of the present invention include one or more test probes, each of which has a polynucleotide sequence that is complementary to a subsequence of RNA or DNA to be detected Each probe preferably has a different nucleic acid sequence, and the position of each probe on the solid surface of the array is preferably known. Indeed, the microarrays are preferably addressable arrays, more preferably positionally addressable arrays. More specifically, each probe of the array is preferably located at a known, predetermined position on the solid support such that the identity (i.e., the sequence) of each probe can be determined from its position on the array (i.e., on the support or surface).

Preferably, the density of probes on a microarray is about 100 different (i.e., non-identical) probes per 1 cm² or higher. More preferably, a microarray used in the methods of the invention will have at least 550 probes per 1 cm², at least 1,000 probes per 1 cm², at least 1,500 probes per 1 cm² or at least 2,000 probes per 1 cm². In a particularly preferred embodiment, the microarray is a high density array, preferably having a density of at least about 2,500 different probes per 1 cm². The microarrays used in the invention therefore preferably contain at least 2,500, at least 5,000, at least 10,000, at least 15,000, at least 20,000, at least 25,000, at least 50,000 or at least 55,000 different (i.e., non-identical) probes.

Such polynucleotides are preferably of the length of 15 to 200 bases, more preferably of the length of 20 to 100 bases, most preferably 40-60 bases. It will be understood that each probe sequence may also comprise linker sequences in addition to the sequence that is complementary to its target sequence. As used herein, a linker sequence refers to a sequence between the sequence that is complementary to its target sequence and the surface.

In one embodiment, the microarray is an array (i.e., a matrix) in which each position represents a discrete binding site for an exon of a transcript encoded by a gene (e.g., for an exon of an mRNA or a cDNA derived therefrom). The collection of binding sites on a microarray contains sets of binding sites for sets of exons for each of a plurality of genes. For example, in various embodiments, the microarrays of the invention can comprise binding sites for products encoded by fewer than 50% of the genes in the genome of an organism. Alternatively, the microarrays of the invention can have binding sites for the products encoded by at least 50%, at least 75%, at least 85%, at least 90%, at least 95%, at least 99% or 100% of the genes in the genome of an organism. In other embodiments, the microarrays of the invention can having binding sites for products encoded by fewer than 50%, by at least 50%, by at least 75%, by at least 85%, by at least 90%, by at least 95%, by at least 99% or by 100% of the genes expressed by a cell of an organism. The binding site can be a DNA or DNA analog to which a particular RNA can specifically hybridize. The DNA or DNA analog can be, e.g., a synthetic oligomer or a gene fragment, e.g. corresponding to an exon.

Preferably, the microarrays used in the invention have binding sites (i.e., probes) for sets of genes or exons for one or more genes relevant to the action of a drug of interest or in a biological pathway of interest. As discussed above, a “gene” is identified as a portion of DNA that is transcribed by RNA polymerase, which may include a 5′ untranslated region (“UTR”), introns, exons and a 3′ UTR. The number of genes in a genome can be estimated from the number of mRNAs expressed by the cell or organism, or by extrapolation of a well characterized portion of the genome. When the genome of the organism of interest has been sequenced, the number of ORFs can be determined and mRNA coding regions identified by analysis of the DNA sequence. For example, the genome of Saccharomyces cerevisiae has been completely sequenced and is reported to have approximately 6275 ORFs encoding sequences longer the 99 amino acid residues in length. Analysis of these ORFs indicates that there are 5,885 ORFs that are likely to encode protein products (Goffeau et al., 1996, Science 274:546-567). In contrast, the human genome is estimated to contain approximately 30,000 to 130,000 genes (see Crollius et al., 2000, Nature Genetics 25:235-238; Ewing et al., 2000, Nature Genetics 25:232-234). Genome sequences for other organisms, including but not limited to Drosophila, C elegans, plants, e.g., rice and Arabidopsis, and mammals, e.g., mouse and human, are also completed or nearly completed. Thus, in preferred embodiments of the invention, array set comprising probes for all exons in the genome of an organism is provided. As a non-limiting example, the present invention provides array set comprising one or two probes for each exon in the human genome.

It will be appreciated that when a sample of target nucleic acid molecules, e.g., cDNA complementary to the RNA of a cell is made and hybridized to a microarray under suitable hybridization conditions, the level of hybridization to the site in the array will reflect the prevalence of the corresponding complementary sequences in the sample. For example, when detectably labeled (e.g., with a fluorophore) cDNA is hybridized to a microarray, the site on the array corresponding to a nucleotide sequence that is not in the sample will have little or no signal (e.g., fluorescent signal), and a nucleotide sequence that is prevalent in the sample will have a relatively strong signal. The relative abundance of different nucleotide sequences in a sample is thus determined by the signal strength pattern of probes on a microarray.

In preferred embodiments, cDNAs from cell samples from two different conditions are hybridized to the binding sites of the microarray using a two-color protocol. In the case of drug responses one cell sample is exposed to a drug and another cell sample of the same type is not exposed to the drug. In the case of pathway responses one cell is exposed to a pathway perturbation and another cell of the same type is not exposed to the pathway perturbation. The cDNA derived from each of the two cell types are differently labeled (e.g., with Cy3 and Cy5) so that they can be distinguished. In one embodiment, for example, cDNA from a cell treated with a drug (or exposed to a pathway perturbation) is synthesized using a fluorescein-labeled dNTP, and cDNA from a second cell, not drug-exposed, is synthesized using a rhodamine-labeled dNTP. When the two cDNAs are mixed and hybridized to the microarray, the relative intensity of signal from each cDNA set is determined for each site on the array, and any relative difference in abundance of a particular exon detected.

In the example described above, the cDNA from the drug-treated (or pathway perturbed) cell will fluoresce green when the fluorophore is stimulated and the cDNA from the untreated cell will fluoresce red. As a result, when the drug treatment has no effect, either directly or indirectly, on the transcription and/or post-transcriptional splicing of a particular gene in a cell, the exon expression patterns will be indistinguishable in both cells and, upon reverse transcription, red-labeled and green-labeled cDNA will be equally prevalent. When hybridized to the microarray, the binding site(s) for that species of RNA will emit wavelengths characteristic of both fluorophores. In contrast, when the drug-exposed cell is treated with a drug that, directly or indirectly, change the transcription and/or post-transcriptional splicing of a particular gene in the cell, the exon expression pattern as represented by ratio of green to red fluorescence for each exon binding site will change. When the drug increases the prevalence of an mRNA, the ratios for each exon expressed in the mRNA will increase, whereas when the drug decreases the prevalence of an mRNA, the ratio for each exons expressed in the mRNA will decrease.

The use of a two-color fluorescence labeling and detection scheme to define alterations in gene expression has been described in connection with detection of mRNAs, e.g., in Shena et al., 1995, Quantitative monitoring of gene expression patterns with a complementary DNA microarray, Science 270:467470, which is incorporated by reference in its entirety for all purposes. The scheme is equally applicable to labeling and detection of exons. An advantage of using cDNA labeled with two different fluorophores is that a direct and internally controlled comparison of the mRNA or exon expression levels corresponding to each arrayed gene in two cell states can be made, and variations due to minor differences in experimental conditions (e.g., hybridization conditions) will not affect subsequent analyses. However, it will be recognized that it is also possible to use cDNA from a single cell, and compare, for example, the absolute amount of a particular exon in, e.g., a drug-treated or pathway-perturbed cell and an untreated cell. Furthermore, labeling with of the invention, at least 5, 10, 20, or 100 dyes of different colors can be used for labeling. Such labeling permits simultaneous hybridizing of the distinguishably labeled cDNA populations to the same array, and thus measuring, and optionally comparing the expression levels of, mRNA molecules derived from more than two samples. Dyes that can be used include, but are not limited to, fluorescein and its derivatives, rhodamine and its derivatives, texas red, 5′carboxy-fluorescein (“FMA”), 2′,7′-dimethoxy-4′,5′-dichloro-6-carboxy-fluorescein (“JOE”), N,N,N′,N′-tetramethyl-6-carboxy-rhodamine (“TAMRA”), 6′carboxy-X-rhodamine (“ROX”), HEX, TET, IRD40, and IRD41, cyamine dyes, including but are not limited to Cy3, Cy3.5 and Cy5; BODIPY dyes including but are not limited to BODIPY-FL, BODIPY-TR, BODIPY-TMR, BODIPY-630/650, and BODIPY-650/670; and ALEXA dyes, including but are not limited to ALEXA488, ALEXA-532, ALEXA-546, ALEXA-568, and ALEXA-594; as well as other fluorescent dyes which will be known to those who are skilled in the art.

### 5.4.2. Preparing Probes for Microarrays

As noted above, the “probe” to which a particular polynucleotide molecule, such an exon, specifically hybridizes according to the invention is a complementary polynucleotide sequence. The probes for exon profiling arrays are selected based on known and predicted exons determined in Section 5.2. Preferably one or more probes are selected for each target exon. Depending on the probe scheme as described in Section 5.4.1., the lengths and number of probes for each exon are chosen accordingly. For example, when a minimum number of probes are to be used for the detection of an exon, the probes normally comprise nucleotide sequences greater than about 40 bases in length. Alternatively, when a large set of redundant probes is to be used for an exon, the probes normally comprise nucleotide sequences of about 40-60 bases. The probes can also comprise sequences complementary to full length exons. The lengths of exons can range from less than 50 bases to more than 200 bases. Therefore, when a probe length longer than exon is to be used, it is preferable to augment the exon sequence with adjacent constitutively spliced exon sequences such that the probe sequence is complementary to the continuous mRNA fragment that contains the target exon. This will allow comparable hybridization stringency among the probes of an exon profiling array. It will be understood that each probe sequence may also comprise linker sequences in addition to the sequence that is complementary to its target sequence.

The probes may comprise DNA or DNA “mimics” (e.g., derivatives and analogues) corresponding to a portion of each exon of each gene in an organism's genome. In one embodiment, the probes of the microarray are complementary RNA or RNA mimics. DNA mimics are polymers composed of subunits capable of specific, Watson-Crick-like hybridization with DNA, or of specific hybridization with RNA. The nucleic acids can be modified at the base moiety, at the sugar moiety, or at the phosphate backbone. Exemplary DNA mimics include, e.g., phosphorothioates. DNA can be obtained, e.g., by polymerase chain reaction (PCR) amplification of exon segments from genomic DNA, cDNA (e.g., by RT-PCR), or cloned sequences. PCR primers are preferably chosen based on known sequence of the exons or cDNA that result in amplification of unique fragments (i.e., fragments that do not share more than 10 bases of contiguous identical sequence with any other fragment on the microarray). Computer programs that are well known in the art are useful in the design of primers with the required specificity and optimal amplification properties, such as Oligo version 5.0 (National Biosciences). Typically each probe on the microarray will be between 20 bases and 600 bases, and usually between 30 and 200 bases in length. PCR methods are well known in the art, and are described, for example, in Innis et al., eds., 1990, PCR Protocols: A Guide to Methods and Applications, Academic Press Inc., San Diego, Calif. It will be apparent to one skilled in the art that controlled robotic systems are useful for isolating and amplifying nucleic acids.

An alternative, preferred means for generating the polynucleotide probes of the microarray is by synthesis of synthetic polynucleotides or oligonucleotides, e.g., using N-phosphonate or phosphoramidite chemistries (Froehler et al., 1986, Nucleic Acid Res. 14:5399-5407; McBride et al., 1983, Tetrahedron Lett. 24:246-248). Synthetic sequences are typically between about 15 and about 600 bases in length, more typically between about 20 and about 100 bases, most preferably between about 40 and about 70 bases in length. In some embodiments, synthetic nucleic acids include non-natural bases, such as, but by no means limited to, inosine. As noted above, nucleic acid analogues may be used as binding sites for hybridization. An example of a suitable nucleic acid analogue is peptide nucleic acid (see, e.g., Egholm et al., 1993, Nature 363:566-568; U.S. Pat. No. 5,539,083).

In alternative embodiments, the hybridization sites (i.e., the probes) are made from plasmid or phage clones of genes, cDNAs (e.g., expressed sequence tags), or inserts therefrom Nguyen et al., 1995, Genomics 29:207-209).

### 5.4.3. Attaching Probes to the Solid Surface

Preformed polynucleotide probes can be deposited on a support to form the array. Alternatively, polynucleotide probes can be synthesized directly on the support to form the array. The probes are attached to a solid support or surface, which may be made, e.g., from glass, plastic (e.g., polypropylene, nylon), polyacrylamide, nitrocellulose, gel, or other porous or nonporous material.

A preferred method for attaching the nucleic acids to a surface is by printing on glass plates, as is described generally by Schena et al, 1995, Science 270:467-470. This method is especially useful for preparing microarrays of cDNA (See also, DeRisi et al, 1996, Nature Genetics 14:457460; Shalon et al., 1996, Genome Res. 6:639-645; and Schena et al., 1995, Proc. Natl. Acad. Sci. U.S.A. 93:10539-11286).

A second preferred method for making microarrays is by making high-density oligonucleotide arrays. Techniques are known for producing arrays containing thousands of oligonucleotides complementary to defined sequences, at defined locations on a surface using photolithographic techniques for synthesis in situ (see, Fodor et al., 1991, Science 251:767-773; Pease et al., 1994, Proc. Natl. Acad. Sci. U.S.A. 91:5022-5026; Lockhart et al., 1996, Nature Biotechnology 14:1675; U.S. Pat. Nos. 5,578,832; 5,556,752; and 5,510,270) or other methods for rapid synthesis and deposition of defined oligonucleotides (Blanchard et al., Biosensors & Bioelectronics 11:687-690). When these methods are used, oligonucleotides (e.g., 60-mers) of known sequence are synthesized directly on a surface such as a derivatized glass slide. The array produced can be redundant, with several oligonucleotide molecules per exon.

Other methods for making microarrays, e.g., by masking (Maskos and Southern, 1992, Nucl. Acids. Res. 20:1679-1684), may also be used. In principle, and as noted supra, any type of array, for example, dot blots on a nylon hybridization membrane (see Sambrook et al., supra) could be used. However, as will be recognized by those skilled in the art, very small arrays will frequently be preferred because hybridization volumes will be smaller.

In a particularly preferred embodiment, microarrays of the invention are manufactured by means of an ink jet printing device for oligonucleotide synthesis, e.g., using the methods and systems described by Blanchard in International Patent Publication No. WO 98/41531, published Sep. 24, 1998; Blanchard et al., 1996, Biosensors and Bioelectronics 11:687-690; Blanchard, 1998, in Synthetic DNA Arrays in Genetic Engineering, Vol. 20, J. K. Setlow, Ed., Plenum Press, New York at pages 111-123; and U.S. Pat. No. 6,028,189 to Blanchard. Specifically, the oligonucleotide probes in such microarrays are preferably synthesized in arrays, e.g., on a glass slide, by serially depositing individual nucleotide bases in “microdroplets” of a high surface tension solvent such as propylene carbonate. The microdroplets have small volumes (e.g, 100 pL or less, more preferably 50 pL or less) and are separated from each other on the microarray (e.g., by hydrophobic domains) to form circular surface tension wells which define the locations of the array elements (i.e., the different probes). Polynucleotide probes are attached to the surface covalently at the 3′ end of the polynucleotide.

### 5.4.4. Target Polynucleotide Molecules

Target polynucleotides which may be analyzed by the methods and compositions of the invention include RNA molecules such as, but by no means limited to messenger RNA (mRNA) molecules, ribosomal RNA (rRNA) molecules, cRNA molecules (i.e., RNA molecules prepared from cDNA molecules that are transcribed in vivo) and fragments thereof. Target polynucleotides which may also be analyzed by the methods and compositions of the present invention include, but are not limited to DNA molecules such as genomic DNA molecules, cDNA molecules, and fragments thereof including oligonucleotides, ESTs, STSs, etc. In specific embodiments, the sample comprises more than 1,000, 5,000, 10,000, 50,000, or 100,000 nucleic acid molecules of different nucleotide sequences.

The target polynucleotides may be from any source. For example, the target polynucleotide molecules may be naturally occurring nucleic acid molecules such as genomic or extragenomic DNA molecules isolated from an organism, or RNA molecules, such as mRNA molecules, isolated from an organism. Alternatively, the polynucleotide molecules may be synthesized, including, e.g., nucleic acid molecules synthesized enzymatically in vivo or in vitro, such as cDNA molecules, or polynucleotide molecules synthesized by PCR, RNA molecules synthesized by in vitro transcription, etc. The sample of target polynucleotides can comprise, e.g., molecules of DNA, RNA, or copolymers of DNA and RNA. In preferred embodiments, the target polynucleotides of the invention will correspond to particular genes or to particular gene transcripts (e.g., to particular mRNA sequences expressed in cells or to particular cDNA sequences derived from such mRNA sequences). However, in many embodiments, particularly those embodiments wherein the polynucleotide molecules are derived from mammalian cells, the target polynucleotides may correspond to particular fragments of a gene transcript For example, the target polynucleotides may correspond to different exons of the same gene, e.g., so that different splice variants of that gene may be detected and/or analyzed.

In preferred embodiments, the target polynucleotides to be analyzed are prepared in vitro from nucleic acids extracted from cells. For example, in one embodiment, RNA is extracted from cells (e.g., total cellular RNA, poly(A)⁺ messenger RNA, fraction thereof) and messenger RNA is purified from the total extracted RNA. Methods for preparing total and poly(A)⁺ RNA are well known in the art, and are described generally, e.g., in Sambrook et al., supra. In one embodiment, RNA is extracted from cells of the various types of interest in this invention using guanidinium thiocyanate lysis followed by CsCl centrifugation and an oligo dT purification (Chirgwin et al., 1979, Biochemistry 18:5294-5299). In another embodiment, RNA is extracted from cells using guanidinium thiocyanate lysis followed by purification on RNeasy columns (Qiagen). cDNA is then synthesized from the purified mRNA using, e.g., oligo-dT or random primers. In preferred embodiments, the target polynucleotides are cRNA prepared from purified messenger RNA or from total RNA extracted from cells. As used herein, cRNA is defined here as RNA complementary to the source RNA. The extracted RNAs are amplified using a process in which doubled-stranded cDNAs are synthesized from the RNAs using a primer linked to an RNA polymerase promoter in a direction capable of directing transcription of anti-sense RNA. Anti-sense RNAs or cRNAs are then transcribed from the second strand of the double-stranded cDNAs using an RNA polymerase (see, e.g., U.S. Pat. Nos. 5,891,636, 5,716,785; 5,545,522 and 6,132,997; see also, U.S. patent application Ser. No. 09/411,074, filed Oct. 4, 1999 by Linsley and Schelter and U.S. Provisional Patent Application Ser. No. 60/253,641, filed on Nov. 28, 2000, by Ziman et al.). Both oligo-dT primers (U.S. Pat. Nos. 5,545,522 and 6,132,997) or random primers (U.S. Provisional Patent Application Ser. No. 60/253,641, filed on Nov. 28, 2000, by Ziman et al.) that contain an RNA polymerase promoter or complement thereof can be used. Preferably, the target polynucleotides are short and/or fragmented polynucleotide molecules which are representative of the original nucleic acid population of the cell. In one embodiment, total RNA is used as input for cRNA synthesis. An oligo-dT primer containing a T7 RNA polymerase promoter sequence was used to prime first strand cDNA synthesis, and random hexamers were used to prime second strand cDNA synthesis by MMLV Reverse Transcriptase (RT). This reaction yielded a double-stranded cDNA that contained the T7 RNA polymerase promoter at the 3′ end. The double-stranded cDNA was then transcribed into cRNA by T7RNAP.

The target polynucleotides to be analyzed by the methods and compositions of the invention are preferably detectably labeled. For example, cDNA can be labeled directly, e.g., with nucleotide analogs, or indirectly, e.g., by making a second, labeled cDNA strand using the first strand as a template. Alternatively, the double-stranded cDNA can be transcribed into cRNA and labeled.

Preferably, the detectable label is a fluorescent label, e.g., by incorporation of nucleotide analogs. Other labels suitable for use in the present invention include, but are not limited to, biotin, imminobiotin, antigens, cofactors, dinitrophenol lipoic acid, olefinic compounds, detectable polypeptides, electron rich molecules, enzymes capable of generating a detectable signal by action upon a substrate, and radioactive isotopes. Preferred radioactive isotopes include ³²P, ³⁵S, ¹⁴C, ¹⁵N and ¹²⁵I. Fluorescent molecules suitable for the present invention include, but are not limited to, fluorescein and its derivatives, rhodamine and its derivatives, texas red, 5′carboxy-fluorescein (“FMA”), 2′,7′-dimethoxy-4′,5′-dichloro-6-carboxy-fluorescein (“JOE”), N,N,N′,N′-tetramethyl-6-carboxy-rhodamine (“TAMRA”), 6′carboxy-X-rhodamine (“ROX”), HEX, TET, IRD40, and IRD41. Fluroescent molecules that are suitable for the invention further include: cyamine dyes, including by not limited to Cy3, Cy3.5 and Cy5; BODIPY dyes including but not limited to BODIPY-FL, BODIPY-TR, BODIPY-TMR, BODIPY-630/650, and BODIPY-650/670; and ALEXA dyes, including but not limited to ALEXA-488, ALEXA-532, ALEXA-546, ALEXA-568, and ALEXA-594; as well as other fluorescent dyes which will be known to those who are skilled in the art. Electron rich indicator molecules suitable for the present invention include, but are not limited to, ferritin, hemocyanin, and colloidal gold. Alternatively, in less preferred embodiments the target polynucleotides may be labeled by specifically complexing a first group to the polynucleotide. A second group, covalently linked to an indicator molecules and which has an affinity for the first group, can be used to indirectly detect the target polynucleotide. In such an embodiment, compounds suitable for use as a first group include, but are not limited to, biotin and iminobiotin. Compounds suitable for use as a second group include, but are not limited to, avidin and streptavidin.

### 5.4.5. Hybridization to Microarrays

As described supra, nucleic acid hybridization and wash conditions are chosen so that the polynucleotide molecules to be analyzed by the invention (referred to herein as the “target polynucleotide molecules) specifically bind or specifically hybridize to the complementary polynucleotide sequences of the array, preferably to a specific array site, wherein its complementary DNA is located.

Arrays containing double-stranded probe DNA situated thereon are preferably subjected to denaturing conditions to render the DNA single-stranded prior to contacting with the target polynucleotide molecules. Arrays containing single-stranded probe DNA (e.g., synthetic oligodeoxyribonucleic acids) may need to be denatured prior to contacting with the target polynucleotide molecules, e.g., to remove hairpins or dimers which form due to self complementary sequences.

Optimal hybridization conditions will depend on the length (e.g. oligomer versus polynucleotide greater than 200 bases) and type (e.g., RNA, or DNA) of probe and target nucleic acids. General parameters for specific (i.e., stringent) hybridization conditions for nucleic acids are described in Sambrook et al., (supra), and in Ausubel et al., 1987, Current Protocols in Molecular Biology, Greene Publishing and Wiley-Interscience, New York. When the cDNA microarrays of Schena et al. are used, typical hybridization conditions are hybridization in 5×SSC plus 0.2% SDS at 65° C. for four hours, followed by washes at 25° C. in low stringency wash buffer (1×SSC plus 0.2% SDS), followed by 10 minutes at 25° C. in higher stringency wash buffer (0.1×SSC plus 0.2% SDS) (Shena et al., 1996, Proc. Natl. Acad. Sci U.S.A. 93:10614). Useful hybridization conditions are also provided in, e.g., Tijessen, 1993, Hybridization With Nucleic Acid Probes, Elsevier Science Publishers B. V. and Kricka, 1992, Nonisotopic DNA Probe Techniques, Academic Press, San Diego, Calif.

Particularly preferred hybridization conditions for use with the screening and/or signaling chips of the present invention include hybridization at a temperature at or near the mean melting temperature of the probes (e.g., within 5° C., more preferably within 2° C.) in 1 M NaCl, 50 M MES buffer (pH 6.5), 0.5% sodium Sarcosine and 30% formamide.

### 5.4.6. Signal Detection and Data Analysis

It will be appreciated that when target sequences, e.g., cDNA or cRNA, complementary to the RNA of a cell is made and hybridized to a microarray under suitable hybridization conditions, the level of hybridization to the site in the array corresponding to an exon of any particular gene will reflect the prevalence in the cell of mRNA or mRNAs containing the exon transcribed from that gene. For example, when detectably labeled (e.g., with a fluorophore) cDNA complementary to the total cellular mRNA is hybridized to a microarray, the site on the array corresponding to an exon of a gene (i.e., capable of specifically binding the product or products of the gene expressing) that is not transcribed or is removed during RNA splicing in the cell will have little or no signal (e.g., fluorescent signal), and an exon of a gene for which the encoded mRNA expressing the exon is prevalent will have a relatively strong signal. The relative abundance of different mRNAs produced by the same gene by alternative splicing is then determined by the signal strength pattern across the whole set of exons monitored for the gene.

In preferred embodiments, target sequences, e.g., cDNAs or cRNAs, from two different cells are hybridized to the binding sites of the microarray. In the case of drug responses one cell sample is exposed to a drug and another cell sample of the same type is not exposed to the drug. In the case of pathway responses one cell is exposed to a pathway perturbation and another cell of the same type is not exposed to the pathway perturbation. The cDNA or cRNA derived from each of the two cell types are differently labeled so that they can be distinguished. In one embodiment, for example, cDNA from a cell treated with a drug (or exposed to a pathway perturbation) is synthesized using a fluorescein-labeled dNTP, and cDNA from a second cell, not drug-exposed, is synthesized using a rhodamine-labeled DNTP. When the two cDNAs are mixed and hybridized to the microarray, the relative intensity of signal from each cDNA set is determined for each site on the array, and any relative difference in abundance of a particular exon detected.

In the example described above, the cDNA from the drug-treated (or pathway perturbed) cell will fluoresce green when the fluorophore is stimulated and the cDNA from the untreated cell will fluoresce red. As a result, when the drug treatment has no effect, either directly or indirectly, on the transcription and/or post-transcriptional splicing of a particular gene in a cell, the exon expression patterns will be indistinguishable in both cells and, upon reverse transcription, red-labeled and green-labeled cDNA will be equally prevalent. When hybridized to the microarray, the binding site(s) for that species of RNA will emit wavelengths characteristic of both fluorophores. In contrast, when the drug-exposed cell is treated with a drug that, directly or indirectly, changes the transcription and/or post-transcriptional splicing of a particular gene in the cell, the exon expression pattern as represented by ratio of green to red fluorescence for each exon binding site will change. When the drug increases the prevalence of an mRNA, the ratios for each exon expressed in the mRNA will increase, whereas when the drug decreases the prevalence of an mRNA, the ratio for each exons expressed in the mRNA will decrease.

The use of a two-color fluorescence labeling and detection scheme to define alterations in gene expression has been described in connection with detection of mRNAs, e.g., in Shena et al., 1995, Quantitative monitoring of gene expression patterns with a complementary DNA microarray, Science 270:467-470, which is incorporated by reference in its entirety for all purposes. The scheme is equally applicable to labeling and detection of exons. An advantage of using target sequences, e.g., cDNAs or cRNAs, labeled with two different fluorophores is that a direct and internally controlled comparison of the mRNA or exon expression levels corresponding to each arrayed gene in two cell states can be made, and variations due to minor differences in experimental conditions (e.g., hybridization conditions) will not affect subsequent analyses. However, it will be recognized that it is also possible to use cDNA from a single cell, and compare, for example, the absolute amount of a particular exon in, e.g., a drug-treated or pathway-perturbed cell and an untreated cell.

In other preferred embodiments, single channel detection methods, e.g., using one-color fluorescence labeling, are used (see U.S. patent application Ser. No. 09/781,814, filed on Feb. 12, 2001). In this embodiment, arrays comprising reverse-complement (RC) probes are designed and produced. Because a reverse complement of a DNA sequence has sequence complexity that is equivalent to the corresponding forward-strand (FS) probe that is complementary to a target sequence with respect to a variety of measures (e.g., measures such as GC content and GC trend are invariant under the reverse complement), a RC probe is used to as a control probe for determination of level of non-specific cross hybridization to the corresponding FS probe. The significance of the FS probe intensity of a target sequence is determined by comparing the raw intensity measurement for the FS probe and the corresponding raw intensity measurement for the RC probe in conjunction with the respective measurement errors. In a preferred embodiment, an exon is called present if the intensity difference between the FS probe and the corresponding RC probe is significant. More preferably, an exon is called present if the FS probe intensity is also significantly above background level. Single channel detection methods can be used in conjunction with multi-color labeling. In one embodiment, a plurality of different samples, each labeled with a different color, is hybridized to an array. Differences between FS and RC probes for each color are used to determine the level of hybridization of the corresponding sample.

When fluorescently labeled probes are used, the fluorescence emissions at each site of a transcript array can be, preferably, detected by scanning confocal laser microscopy. In one embodiment, a separate scan, using the appropriate excitation line, is carried out for each of the two fluorophores used. Alternatively, a laser can be used that allows simultaneous specimen illumination at wavelengths specific to the two fluorophores and emissions from the two fluorophores can be analyzed simultaneously (see Shalon et al., 1996, Genome Res. 6:639-645). In a preferred embodiment, the arrays are scanned with a laser fluorescence scanner with a computer controlled X-Y stage and a microscope objective. Sequential excitation of the two fluorophores is achieved with a multi-line, mixed gas laser, and the emitted light is split by wavelength and detected with two photomultiplier tubes. Such fluorescence laser scanning devices are described, e.g., in Schena et al., 1996, Genome Res. 6:639-645. Alternatively, the fiber-optic bundle described by Ferguson et al., 1996, Nature Biotech 14:1681-1684, may be used to monitor mRNA abundance levels at a large number of sites simultaneously.

Signals are recorded and, in a preferred embodiment, analyzed by computer, e.g., using a 12 bit or 16 bit analog to digital board. In one embodiment, the scanned image is despeckled using a graphics program (e.g., Hijaak Graphics Suite) and then analyzed using an image gridding program that creates a spreadsheet of the average hybridization at each wavelength at each site. If necessary, an experimentally determined correction for “cross talk” (or overlap) between the channels for the two fluors may be made. For any particular hybridization site on the transcript array, a ratio of the emission of the two fluorophores can be calculated. The ratio is independent of the absolute expression level of the cognate gene, but is useful for genes whose expression is significantly modulated by drug administration, gene deletion, or any other tested event.

According to the method of the invention, the relative abundance of an mRNA and/or an exon expressed in an mRNA in two cells or cell lines is scored as perturbed (i.e., the abundance is different in the two sources of mRNA tested) or as not perturbed (i.e., the relative abundance is the same). As used herein, a difference between the two sources of RNA of at least a factor of about 25% (i.e., RNA is 25% more abundant in one source than in the other source), more usually about 50%, even more often by a factor of about 2 (i.e., twice as abundant), 3 (three times as abundant), or 5 (five times as abundant) is scored as a perturbation. Present detection methods allow reliable detection of difference of an order of about 3-fold to about 5-fold, but more sensitive methods are expected to be developed.

It is, however, also advantageous to determine the magnitude of the relative difference in abundances for an mRNA and/or an exon expressed in an mRNA in two cells or in two cell lines. This can be carried out, as noted above, by calculating the ratio of the emission of the two fluorophores used for differential labeling, or by analogous methods that will be readily apparent to those of skill in the art.

### 6. EXAMPLES

The following examples are presented by way of illustration of the present invention, and are not intended to limit the present invention in any way. In particular, the examples presented herein below describe the analysis of the changes of hybridization signals of specific and non-specific hybridization and the uses of such changes of hybridization signals to enhance the search for exons using microarrays

### 6.1. Changes of Hybridization Signals of Specific and Non-Specific Hybridization

This example shows hybridization time titration experiments performed using Rosetta-manufactured microarrays with 22,000 spots. cRNA samples from Jurkat and K562 cell lines were generated from total RNA using an oligo-dT primer containing a T7 RNA polymerase promoter sequence which was used to prime first strand cDNA synthesis, and random hexamers which were used to prime second strand cDNA synthesis by MMLV Reverse Transcriptase (RT). This reaction yielded a double-stranded cDNA that contained the T7 RNA polymerase promoter at the 3′ end. The double-stranded cDNA was then transcribed into cRNA by T7RNAP. cRNA samples were than labeled with Cy3 or Cy5. In hybridization measurements, each sample contains 5 ug of Jurkat cRNA and 5 ug of C562 cRNA in 3 ml of hybridization buffer (1M NaCl, 50 mM MES buffer (pH 6.5), 0.5% sodium Sarcosine, and 30% formamide). Fluor-reversed pairs of hybridization measurements were performed for each hybridization time. The hybridization levels are measured at hybridization times 4, 16, 24 and 48 hours. These hybridizations were carried out in different containers with identically produced chips and RNA samples, but the parameters were nominally the same except for duration. Each array contained 4005 probes designed to be complementary to mRNA sequences, and 13461 probes for EST sequences. The rest of the probes are included on the microarray as control probes. About 90% of the EST probes are known to be in the reverse (improper) direction with respect to the RNA sample molecules, because the sequences used for probe design were reverse strand. The sample RNA preparation procedure we used generates largely single stranded (forward direction) cRNA. Thus we expect most of the EST probes to be dominated by cross-hybridization. The mRNA sequence probes, on the other hand, are expected to find perfect-match duplexes in most cases.

FIGS. 2A-2C show the histograms of intensity over all the probes from signal in the Jurkat channel measured at 16, 24 and 48 hours, respectively, and normalized to the intensity at 4 hours. The figures shows that there was a group of probes which continuously gained intensities with time (the group indicated by the arrow in FIG. 2C). The majority of probes in this group are probes derived from the known mRNA sequences. If we make a cut at log₁₀(Intensity(48 hr)/Intensity(4 hr)) greater than 0.7, there are 2309 spots that pass the cut: 1825 are mRNA probes. These mRNA derived polynucleotide probes continuously gained intensities with time and gradually separated out from the intensities representing the rest of the polynucleotide probes. The mRNA polynucleotide probes were synthesized in the correct orientation with respect to the cognate cRNA sample and hence represent the specific polynucleotide probes. Given the fact that mRNA polynucleotide probes constitute only ˜20% of total polynucleotide probes on the microarray, and nearly 80% of polynucleotide probes having log₁₀(Intensity(48 hr)/Intensity(4 hr)) greater than 0.7 are mRNAs, the data demonstrated the difference in kinetic properties between specific and non-specific binding.

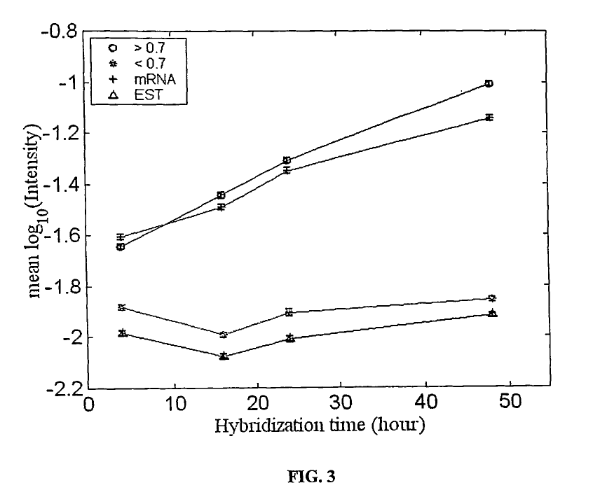

By making the cut at 0.7 on the horizontal axis of FIG. 2, two groups are defined. The trend of the intensities for these two groups is shown in FIG. 3. The ‘specific’ group shows a steady increase with time, and did not reach equilibrium even at 48 hours, whereas the other group reached equilibrium within 4 hours. For comparison, the average intensities of mRNA derived polynucleotide probes and EST derived polynucleotide probes are also plotted in the same figure. This example demonstrates that the kinetics parameters are well defined and clearly distinguishable for the two groups of polynucleotide probes under a typical hybridization condition.

### 6.2. Using Signal Changes for Enhancing the Search for Exons Using Microarrays

Change of hybridization signals during approach to equilibrium is used to enhance the search for exons using microarrays. Probes for overlapping short regions of a genomic sequence region are selected and hybridization to RNA sample is performed to see which parts of the region were actually transcribed. Probes complementary to the human Retinoblastoma (Rb) gene region were selected and were printed with the Rosetta IJS arrayer. Probes passing a filter for repetitive sequence were selected at 8 base separation over the entire 180 kilobase region. The Rb gene is well studied and it is commonly known that there are 28 exons in this 180 kilobase range. Samples are prepared by the random primer protocol to generate transcripts more uniformly covering the entire length of the gene. Samples containing nucleic acid molecules are prepared from Jurkat cell line (labeled with Cy3) and K562 cell line (labeled with Cy5). One sample containing nucleic acid molecules from the two cell lines is hybridized to an array for 4 hours. Another sample containing nucleic acid molecules from the two cell lines is hybridized to an identically produced array for 72 hours. FIG. 4A shows log intensity ratio (48 hour hybridization/4 hour hybridization) vs. log intensity of 48 hour hybridization for the jurkat sample. Spots in the darker region correspond to probes with xdev>2. The data were normalized to the maximum dynamic range of the scanner. Spots near the log intensity of 0 are spots whose intensity saturated the scanner. FIG. 4B shows a histogram of xdev (for time points at 4 hours and 48 hours). Thick line is the histogram for mRNA derived polynucleotide probes only.

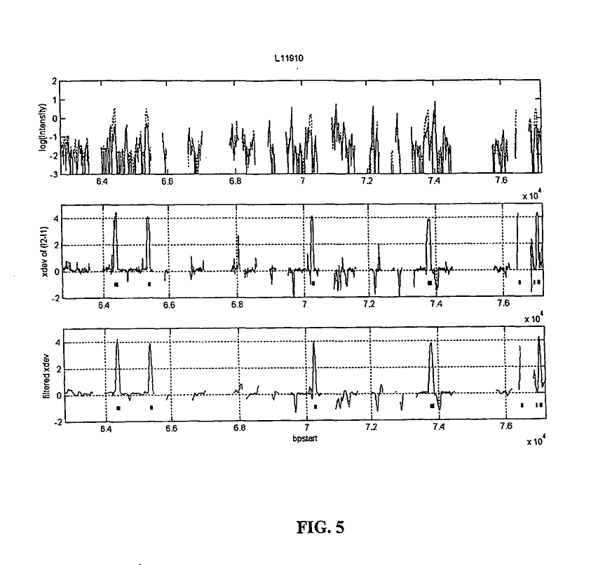

FIG. 5 shows the intensities vs. base pair location over a tiling region from −64 kb to 77 kb from the 5′ end of the gene measured in the Cy3 channel(the signals from the Jurkat cell). In the top panel, two intensity curves are displayed, one for 4-hour hybridization, one for 72-hour hybridization. The middle panel shows the xdev between those two intensities for each probe. The known exons are also indicated by the line segments near y=−1. Bottom panel are the same as middle panel except the overlap probes are averaged together.

There are 7 known exons in the particular region shown in FIG. 5. The intensity plot in this region is very ‘spiky.’ However, the derived quantity ‘xdev’ shows peaks at each known exon position. The filtered ‘xdev’ shows almost no false positives in this region and missed only one very narrow exon out of seven if we set a threshold of xdev=2. The use of two hybridization times reduced false detections of exons substantially.

Statistics for the whole 180 k region: At threshold of xdev=2 (filtered xdev): Total of 28 regions (blocks) above threshold. Among those 28 regions, 24 correspond to known exons. False positives: 4, false negatives: 4.

### 6.3. Using Hybridization Kinetics to Determine Sequence Orientation

This example demonstrates an application of the methods of the invention in determining the proper orientation of gene sequences. In this example, 2450 mRNA sequences (with known orientation) and 8280 EST sequences (from public databases, unknown orientation) were used to design oligonucleotide probes. For each sequence, two 60 mer oligonucleotide probes were designed, one in the forward direction and one in the reverse direction. Inkjet microarrays of the collection of forward and reverese oligo probes were synthesized and hybridized to two cRNA samples (Jurkat vs. K562) labeled with two different fluorescent dyes. The sample preparation method used generates largely single stranded cRNA (Hughes et al., 2001, Nature Biotech. 19:342-347). Two microarrays were used in this experiment, one was hybridized with the sample for 3 hours and one for 72 hours.

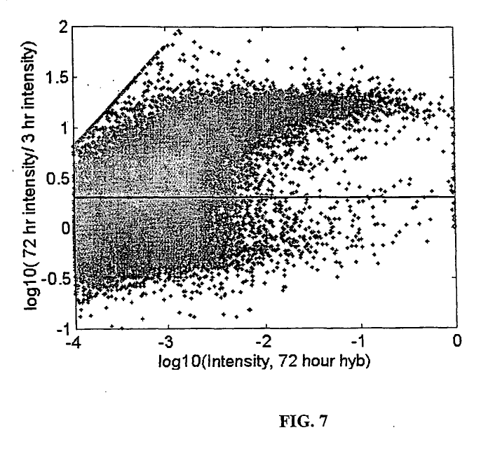

FIG. 7 shows a scatter plot of ratio of intensities at two hybridization times (72 hours hybridization/3 hours hybridization) vs. the intensity of 72 hour from the Jurkat sample. The spots can be roughly divided into two groups by the ratio (ratio>2 and ratio<2). The spots above the line are those spots with ‘good’ kinetics characteristics (intensity increases with time), and the spots below the lines are the ones with ‘poor’ kinetics characteristics (intensity does not increase with time). 24% of the probes homologous to mRNA and 40% of the probes homologous to ESTs fall in the ‘poor’ group.

The two groups of probe sequences, designated as having good or poor kinetic properties, were oriented, i.e. the strand represented in mRNA determined, based upon two hybridization data analysis methods: kinetics of hybridization of each probe sequence and intensity of hybridization signal of each probe sequence. To determine the orientation by kinetics, an xdev (difference of intensity from two hybridization times divided by the error of difference, see Equation 8) was computed for each probe sequence. In order for a sequence to be called ‘forward’ (relative to the input sequence), the xdev for the forward and reverse probe had to satisfy the following conditions:
xdev_{f}>th1 xdev_{f}−xdevᵣ>th2
where xdev_{f} and xdevᵣ are the xdev (as described by equations 11 and 12) for the forward and reverse probes, th1 and th2 are the thresholds (‘reverse’ direction were called by the parallel argument). The call rate (fraction of sequences above the thresholds) and the accuracy of orientation depend on the thresholds. To determine the orientation of an EST (unknown) or mRNA (known) by the intensity method, only the 72 hour hybridization was used. A quantity t for each sequence is defined in this case:

$$t = \frac{{I}_{f} - {I}_{r}}{{σ}_{{I}_{f} - {I}_{r}}}$$

where I_{f} and Iᵣ are the intensities for the forward and reverse probes and the σ represents the error of I_{f}−Iᵣ. A sequence is called ‘forward’ if t>th, and ‘reverse’ if t<−th, with th being the threshold.

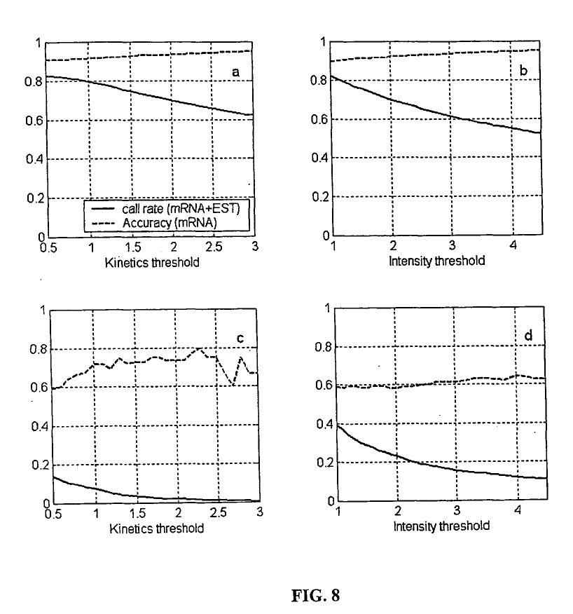

FIG. 8 shows the call rate and accuracy as a function of threshold. Plot (a) and (b) are for the group with ‘good’ kinetics characteristics, (c) and (d) are for the group with ‘poor’ kinetics characteristics. The call rate was determined from the mRNA and EST derived sequences in each group, and accuracy was determined using only the mRNA sequences since their directions are already known. To simplify the picture for the kinetics, th2 was fixed at 0.8 in this plot and only th1 was varied. From the data displayed in FIG. 8, it can be seen that the orientation accuracy is quite different for the kinetically ‘good’ probe sequence group compared to the kinetically ‘poor’ probe sequence group. For the ‘good’ group, both the intensity and kinetics methods perform almost equally well in terms of accuracy and call rate. For example, at call rate of 80%, both methods can yield an accuracy of 90% or better. However, for the kinetically ‘poor’ group, the accuracy was not much better than the random calls, especially for the intensity method. Compared to the intensity method, the hybridization kinetics method for determining strand orientation of a sequence can improve the results in two aspects:
(1) It can determine which sequences are likely to be in the correct orientation based on the hybridization (‘good’ group vs. ‘poor’ group).
(2) For the ‘poor’ group, the kinetics method has a lower call rate compared to the intensity method, yielding fewer low quality calls.

It's worth noting that in this example, the oligonucleotide probes were simply divided into binary groups of ‘good’ vs. ‘poor’. In practice, probe sequences can be divided into many groups or can be ranked by their kinetic hybridization properties. In addition, for this Example, two hybridization samples were used to perform the kinetic microarray hybridization experiments, i.e., cRNA was prepared from mRNA isolated from jurkat and K562 human cell lines. In other tests of the this kinetic strand orientation method, both the oligonucleotide probe call rate and the accuracy of strand determination were improved by kinetic hybridization of the additional cRNA samples, prepared from additional cell lines or from different tissues (data not shown), to the oligonucleotide test array. This improvement in call rate and accuracy occurs because under some conditions, i.e., cell lines or tissues, the cRNA that will hybridize to either the forward or reverse probe sequences are at low abundance in the original mRNA sample, thus, resulting in a lower probability of accurate strand determination for probes corresponding to that mRNA. When a cRNA sample is prepared from a sample subject to an appropriate cellular or tissue condition, i.e., a condition in which that mRNA is at high abundance, then the kinetic hybridization method has a higher probability of accurately determining the strand orientation of probes corresponding to that mRNA.

### 6.4. Hybridization Kinetics of Perfect Match and Mismatch Probes

Two synthetic mRNA sequences were prepared for the study of the hybridization kinetics of specific versus non-specific probe sequences. A portion of adenovirus E1A (nt 560-972) was PCR subcloned into the vector pSP64 polyA. Random 60-mer polynucleotide probes were cloned into the XbaI/BamHI sites of this subclone, adjacent to the polyA sequence. Two clones designated as ‘clone10’ and ‘clone11’′ were isolated and identified by nucleotide sequences.

The sequence of
‘Clone10’ is as follows:

| | |
|---|---|
| TCTAGACTGTGTTCGAGTTAAGCAGCAGGGCCGCAC | (SEQ ID NO: 1) |
| TGGTTAGCCTTATAATTCCCGGTATAGAGGATCC | |
| and the sequence | |
| of ‘Clone11’ is as follows: | |
| TCTAGACTGTTAAATCCTGGAATAAGCCTCGCTTAG | (SEQ ID NO: 2) |
| TTGCTGGTGGAAGGATTCGGCTCGTAGAAAGGATCC | |
| GTCAAACGTTGAATTTTATGCCGACCACTCTCCGCT | |
| ATTCACTTCTACACGGCTCTAGAGATGCGAAAGGGT | |
| CTTCGAGGAGTCTGATATAGAAGGTTGTCCGACAGT | |
| ATGGTATGGCTGGATCC. | |

A microarray consisting of perfect match and mismatch probes to a sixty base sequence of each of the two synthetic mRNA sequences was designed and synthesized. The 60-mer perfect match oligonucleotide probe sequence for clone 10 (complementary to the underlined portion of SEQ ID NO:1) is (SEQ ID NO:3): TCCTCTATACCGGGAATTA AAGGCTAACCAGTGCGGCCCTGCTGCTTAACTCGAACACA. The 60-mer perfect match oligonucleotide probe sequence for clone 11 (complementary to the underlined portion of SEQ ID NO:2) is (SEQ ID NO:4): TTTCTACGAGCCGAATCCTFC CACCAGCAACTAAGCGAGGCTTATTCCAGGATTTAACAG. For each synthetic polynucleotide sequence included in the hybridization sample (“synthetic mRNA sequences”), two types of mismatch probe sequences were generated: mutations and deletions. For each mismatch probe type, the number of altered bases ranged from 0 to 20. For each selected number of mismatches in a given mismatch type of a given probe except for the 1 base mismatch case, 110 different probe sequences with random mismatch positions were synthesized on the microarray. For probes with 1 mismatch base, only 60 probe sequences (corresponding to every possible position) were synthesized. For the perfect match probes, the same probe sequence was repeated at 110 locations on the microarray. Perfect match synthetic sequences homologous to two different synthetic mRNA sequences were represented on the microarray chip.

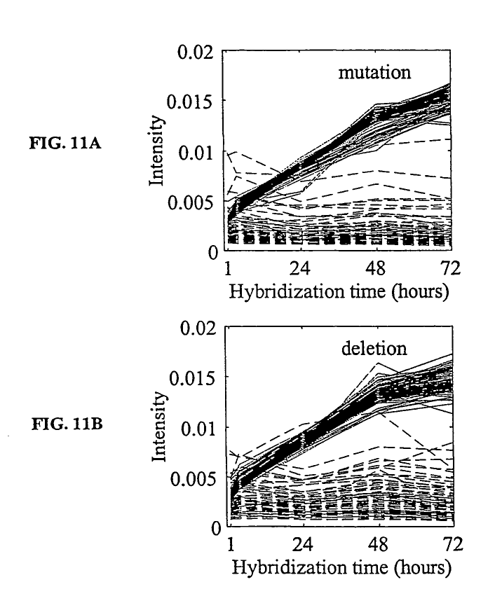

Synthetic mRNA for hybridization to the perfect match/mismatch microarray was generated from clones 10 and 11 by first linearizing with EcoRI and then carrying out an SP6 transcription reaction, followed by DNAse treatment. Synthetic mRNA was purified on Rneasy columns and mRNA concentration quantified. Synthetic mRNA from clone11 was labeled with Cy3 and synthetic mRNA from clone 10 was labeled with Cy5. The mixture of the two labeled mRNAs was spiked into a pre-labeled mixture of Jurkat and K562 cRNA to mimic the actual complexity of mammalian cell hybridization samples (2 ng of each synthetic mRNA was spiked into 10 ug Jurkat/K562 complex sample at a composition of 5 ug for each dye channel. The Cy3 and Cy5 labeled samples were hybridized to the perfect match/mismatch microarray for different lengths of time (1, 4, 24, 48 and 72 hours). FIGS. 11A and 11B show hybridization intensities of individual polynucleotide probes derived from synthetic mRNA clone 10 as a function of hybridization time for perfect match and 10 base mismatch polynucleotide probes.

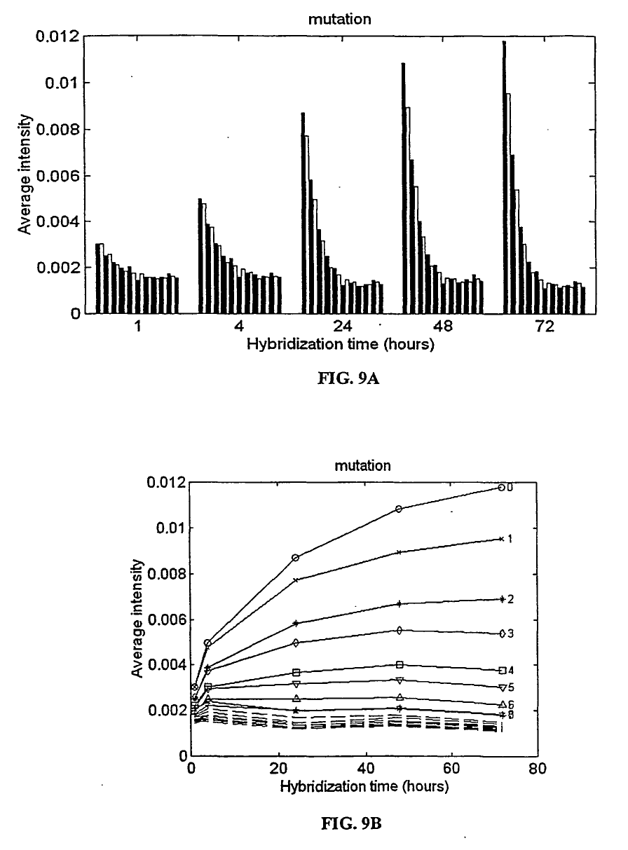

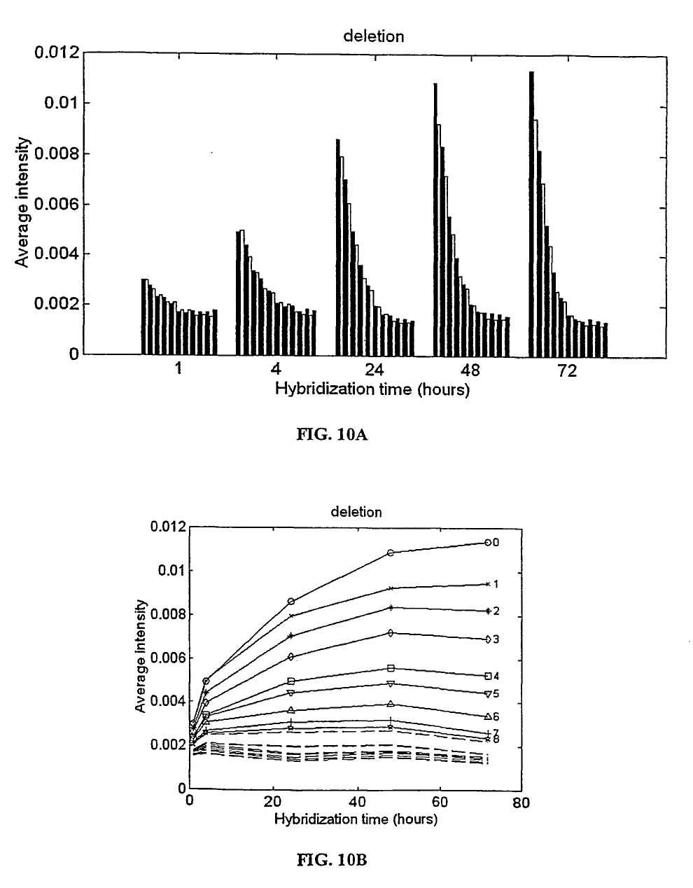

The average intensity for each number of mismatch bases in the probes was obtained by averaging the intensities measured on the 110 mismatch probes that have the number of mismatch bases, and further averaged over the two synthetic mRNAs. Results are plotted in FIG. 9A (bar charts) and FIG. 9B (hybridization curves) for mutation type mismatch and in FIGS. 10A and 10B for deletion type of mismatch. The kinetics curves for the mutations and deletions are quite similar to each other. From the plots, it can be seen that the differences in hybridization signal intensity between the long and short hybridization times are greater for more specific probes. In other words, the gain in hybridization signal intensity over hybridization time is due to increase in specific hybridization. It can also be seen that, for probes that are specific, as less as 1 base difference between two 60 mer probes can be distinguished by comparing the gains in intensities over hybridization time or by comparing the hybridization curves.

For probes with 6 or more mismatch bases, the hybridization signal intensities do not change significantly after 4 hours of hybridization time. That is, they reached hybridization equilibrium within 4 hours. Thus, if we define specific hybridization in this case as formation of hybridization duplexes with 5 or less mismatch bases, the hybridization curves of probes that form duplexes with more than 5 mismatch bases can be used to determine the level of cross hybridization.

The results also demonstrate that for probes with fewer base mismatches (<5), the hybridization signal intensities take a long time (24 hours or more) to reach equilibrium.

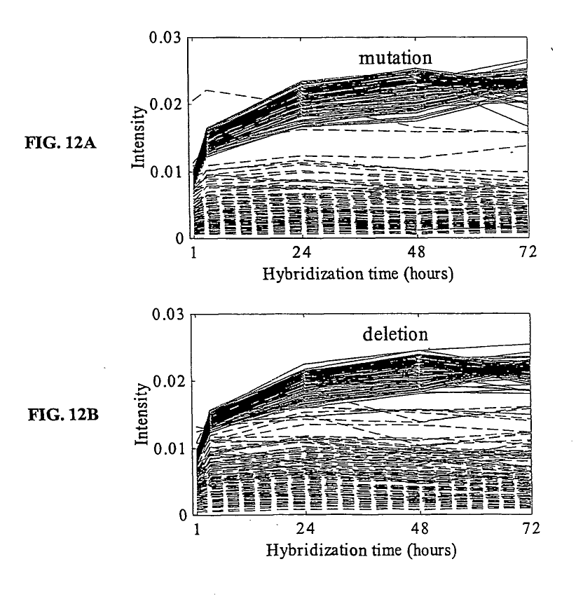

Size of nucleic acid fragments in the sample also affects equilibrium time. To show the effect of size of fragments on equilibrium time, the above experiment was repeated with the modification that the synthetic mRNAs were fragmented by ZnCl₂ to an average size of 50˜100 bases long (see, e.g., Wodicka et al., 1997, Nature Biotech. 15:1359). As a comparison, the sequence length for synthetic mRNA clone10 before fragmentation is 533 bases. FIGS. 12A and 12B show hybridization intensities for individual polynucleotide probes derived from synthetic mRNA clone 10 as a function of hybridization time for perfect match and 10 base mismatch polynucleotide probes. It can be seen by comparing these two plots with FIGS. 11A and 11C that the perfect match polynucleotide probes when hybridized with sample containing fragmented molecules did not gain much intensity after 24 hours, whereas the perfect match polynucleotide probes when hybridized with sample containing unfragmented molecules continuously gained substantial intensity even after 48 hours. Therefore, fragmenting the sample effectively reduces the time required to reach hybridization equilibrium. In can also be seen that in this case, specific and non-specific hybridizations can be distinguished by kinetics data within 24 to 36 hours.

In summary, this example shows that sequence specific hybridization takes a longer time to reach equilibrium than non-specific hybridization; therefore, increasing hybridization time will increase the level of specific hybridization to a microarray probe. Therefore, the increase in hybridization signal intensity over a hybridization time course measured at a particular probe can be used to screen for sequences in a sample that specifically hybridize to the probe. Alternatively, the increase in hybridization signal intensity over a hybridization time course can be used to screen prospective microarray probe sequences to distinguish specific probe sequences from non-specific probe sequence.

### 6.5. Hybridization Kinetics Measurements Using a Single Microarray

This example demonstrates that hybridization kinetics measurements over time can be carried out on the same microarray. In this example, a labeled sample pair was hybridized to a single microarray to generate all hybridization kinetics data. Using a single microarray to measure hybridization levels at multiple hybridization time points has the added benefit of minimizing any inter-array variations that might exist when multiple microarrays are used.

To examine the feasibility of obtaining hybridization kinetics using a single microarray and a single pair of labeled samples, a microarray as described in Example 6.1., supra, was hybridized with Cy3 labeled Jurkat cRNA and Cy5 labeled K562 cRNA. The microarray was hybridized for four hours after which time it was removed from the hybridization solution, washed and scanned. During the washing and scanning of the microarray, the hybridization solution was stored at the hybridization temperature. After scanning, the slide was returned to the hybridization solution and left to hybridize for an additional 68 hours (72 hour total hybridization time). For comparison, one pair of control microarrays were hybridized with the labeled Jurkat/K562 cRNA separately, one for 4 hours and another for 72 hours.

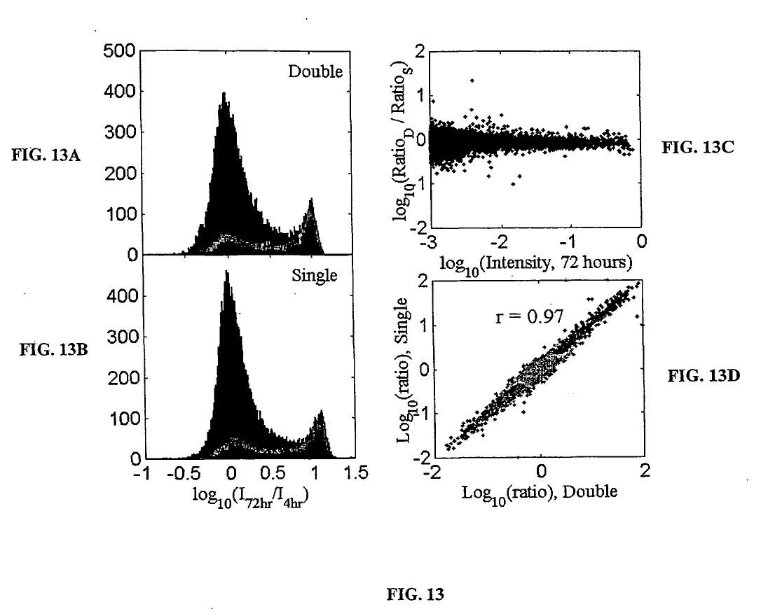

The hybridization kinetics observed for the specific and non-specific polynucleotide probes in the single microarray experiment is identical to the kinetics measured using the control slides (FIGS. 13A & 13B). FIGS. 13A and 13B show that the histograms of log ratio obtained in the two experiments are very similar: in both histograms two peaks were displayed and the mRNA derived polynucleotide probes behave similarly. FIG. 13C shows the ratio (double, i.e., the single microarray experiment, over single, i.e., the multiple microarray experiment) of the kinetics ratios (defined as in FIGS. 4B and 13A/13B) for each probe. The spread is typically 0.1 or less in log scale, which indicates that the two ratios in FIGS. 13A and 13B are very similar. FIG. 13D shows a comparison of the conventional two color ratio (Jurkat/K562) for 72 hour hybridizations. Data measured using a microarray that went through double hybridizations, i.e., the single microarray experiment, correlate with data measured using the single hybridization control arrays, i.e., the multiple microarray experiment, with a correlation coefficient of 0.97 in the log(Ratio).

These results demonstrate that multi-time-point kinetics experiments can be performed on a single microarray, and using a single sample.

### 7. REFERENCES CITED

All references cited herein are incorporated herein by reference in their entirety and for all purposes to the same extent as if each individual publication or patent or patent application was specifically and individually indicated to be incorporated by reference in its entirety for all purposes.

Many modifications and variations of the present invention can be made without departing from its spirit and scope, as will be apparent to those skilled in the art. The specific embodiments described herein are offered by way of example only, and the invention is to be limited only by the terms of the appended claims along with the full scope of equivalents to which such claims are entitled.

1. A method for determining whether specific hybridization to a polynucleotide probe by one or more nucleic acid molecules in a sample occurs, said sample comprising a plurality of nucleic acid molecules having different nucleotide sequences, said method comprising
(1) contacting a plurality of molecules of said probe with said sample under conditions such that hybridization can occur;
(2) determining change in hybridization levels of said probe measured at at least two different hybridization times, wherein each of said at least two different hybridization times corresponds to a different length of time said one or more nucleic acid molecules in said sample is allowed to hybridize with said probe; and
(3) comparing said change with a threshold value, said threshold value indicating specific hybridization of one or more nucleic acid molecules in said sample to said probe, wherein specific hybridization is determined to have occurred when said change is above said threshold value.

2. The method of claim 1, wherein said at least two different hybridization times consists of a first hybridization time and a second hybridization time.

3. The method of claim 2, wherein said first hybridization time is close to the time scale for substantially reaching cross-hybridization equilibrium and said second hybridization time is longer than said first hybridization time.

4. The method of claim 3, wherein said first hybridization time is long enough for hybridization level of said probe to reach at least 80% of cross-hybridization equilibrium level and said second hybridization time is longer than said first hybridization time.

5. The method of claim 4, wherein said first hybridization time is long enough for hybridization level of said probe to reach at least 90% of cross-hybridization equilibrium level and said second hybridization time is longer than said first hybridization time.

6. The method of claim 5, wherein said first hybridization time is long enough for hybridization level of said probe to reach at least 95% of cross-hybridization equilibrium level and said second hybridization time is longer than said first hybridization time.

7. The method of claim 2, wherein said first hybridization time is 1 to 4 hours.

8. The method of claim 3, wherein said time scale of cross-hybridization equilibrium is determined from a measured hybridization curve representing progression of level of hybridization of said probe with a second sample, said second sample not containing nucleic acid molecules specifically hybridizable to said probe.

9. The method of claim 3, wherein said time scale of cross-hybridization equilibrium is determined from a measured hybridization curve representing progression of level of hybridization of a reference probe, wherein said reference probe has a sequence which is not specifically hybridizable to any known or predicted sequences in said plurality of nucleic acid molecules.

10. The method of claim 9, wherein said reference probe hybridizes to any known or predicted sequences in said plurality of nucleic acid molecules with at least 3% mismatched bases in said reference probe.

11. The method of claim 10, wherein said reference probe hybridizes to any known or predicted sequences in said plurality of nucleic acid molecules with at least 10% mismatched bases in said reference probe.

12. The method of claim 11, wherein said reference probe hybridizes to any known or predicted sequences in said plurality of nucleic acid molecules with at least 30% mismatched bases in said reference probe.

13. The method of claim 9, wherein said reference probe has a sequence which is a reverse complement of a sequence in said plurality of nucleic acid molecules.

14. The method of claim 9, wherein said reference probe has a sequence which is a reverse complement of said probe.

15. The method of any one of claims 2-14, wherein said second hybridization time is at least 2 times as long as said first hybridization time.

16. The method of claim 15, wherein said second hybridization time is at least 10 times as long as said first hybridization time.

17. The method of claim 15, wherein said second hybridization time is at least 16 times as long as said first hybridization time.

18. A method for determining whether specific hybridization to a polynucleotide probe by one or more nucleic acid molecules in a sample comprising a plurality of nucleic acid molecules having different nucleotide sequences occurs, said method comprising
(1) contacting a polynucleotide array comprising said probe with said sample under conditions such that hybridization can occur, said polynucleotide array comprising a positionally-addressable array of polynucleotide probes bound to a support, said polynucleotide probes comprising a plurality of polynucleotide probes of different predetermined nucleotide sequences;
(2) determining hybridization levels of said probe at at least two different hybridization times, wherein each of said at least two different hybridization times corresponds to a different length of time said one or more nucleic acid molecules in said sample is allowed to hybridize with said probe;
(3) determining change of hybridization level by comparing hybridization levels measured at said at least two different hybridization times; and
(4) comparing said change with a threshold value, said threshold value indicating specific hybridization of one or more nucleic acid molecules in said sample to said probe, wherein specific hybridization is determined to have occurred when said change is above said threshold.

19. The method of claim 18, wherein said at least two hybridization times consists of a first Hybridization time and a second hybridization time.

20. The method of claim 19, wherein said comparing comprises determining the ratio of said second hybridization level 12 and said first hybridization level I₁.

21. The method of claim 19, wherein said comparing comprises determining a quantity as described by equation
$$xdev = \frac{{I}_{2} - {I}_{1}}{\sqrt{{err ( {I}_{1} )}^{2} + {err ( {I}_{2} )}^{2}}}$$
wherein I₂ is said second hybridization level and I₁ is said first hybridization level, and wherein said err(I₁) and err(I₂) are expected error in I₁ and I₂, respectively.

22. The method of claim 21, wherein said err(I₁)²+err(I₂)₂ is defined by equation
err(I₁)²+err(I₂)²=σ₁²+σ₂²+f²(I₂²+I₁²)
wherein σ₁² is the variance for I₁, σ₂² is the variance for I₂ and f is the fractional multiplicative error level.

23. The method of claim 19, wherein said first hybridization time is close to the time scale for substantially reaching cross-hybridization equilibrium and said second hybridization time is longer than said first hybridization time.

24. The method of claim 23, wherein said first hybridization time is long enough for hybridization level of said probe to reach at least 80% of cross-hybridization equilibrium level and said second hybridization time is longer than said first hybridization time.

25. The method of claim 24, wherein said first hybridization time is long enough for hybridization level of said probe to reach at least 90% of cross-hybridization equilibrium level and said second hybridization time is longer than said first hybridization time.

26. The method of claim 25, wherein said first hybridization time is long enough for hybridization level of said probe to reach at least 95% of cross-hybridization equilibrium level and said second hybridization time is longer than said first hybridization time.

27. The method of claim 19, wherein said first hybridization time is 1 to 4 hours.

28. The method of any one of claims 19-27, wherein said second hybridization time is at least 2 times as long as said first hybridization time.

29. The method of any one of claims 19-27, wherein said second hybridization time is at least 10 times as long as said first hybridization time.

30. The method of any one of claims 19-27, wherein said second hybridization time is at least 16 times as long as said first hybridization time.

31. A method for determining whether specific hybridization to a polynucleotide probe by one or more nucleic acid molecules in a sample comprising a plurality of nucleic acid molecules having different nucleotide sequences occurs, said method comprising
(1) contacting a polynucleotide array comprising said probe and at least one reference probe with said sample under conditions such that hybridization can occur, said polynucleotide array comprising a positionally-addressable array of polynucleotide probes bound to a support, said polynucleotide probes comprising a plurality of polynucleotide probes of different predetermined nucleotide sequences;
(2) determining time scale of cross-hybridization equilibrium by measuring a hybridization curve representing progression of level of hybridization of said reference probe, wherein said reference probe has a sequence which is not complementary to any known or predicted sequences in said plurality of nucleic acid molecules;
(3) determining hybridization level of said probe at at least two different hybridization times, wherein each of said at least two different hybridization times corresponds to a different length of time said one or more nucleic acid molecules in said sample is allowed to hybridize with said probe;
(4) determining change of hybridization level by comparing hybridization levels measured at said at least two different hybridization times; and
(5) comparing said change with a threshold value, said threshold value indicating specific hybridization of one or more nucleic acid molecules in said sample to said probe, wherein specific hybridization is determined to have occurred when said change is above said threshold value.

32. The method of claim 31, wherein said at least two different hybridization times consists of a first hybridization time and a second hybridization time.

33. The method of claim 32, wherein said first hybridization time is close to the time scale for substantially reaching cross-hybridization equilibrium and said second hybridization time is longer than said first hybridization time.

34. The method of claim 33, wherein said first hybridization time is long enough for hybridization level of said probe to reach at least 80% of cross-hybridization equilibrium level and said second hybridization time is longer than said first hybridization time.

35. The method of claim 34, wherein said first hybridization time is long enough for hybridization level of said probe to reach at least 90% of cross-hybridization equilibrium level and said second hybridization time is longer than said first hybridization time.

36. The method of claim 35, wherein said first hybridization time is long enough for hybridization level of said probe to reach at least 95% of cross-hybridization equilibrium level and said second hybridization time is longer than said first hybridization time.

37. The method of claim 32, wherein said first hybridization time is 1 to 4 hours.

38. The method of claim 31, wherein said reference probe hybridizes to any known or predicted sequences in said plurality of nucleic acid molecules with at least 3% mismatched bases in said reference probe.

39. The method of claim 38, wherein said reference probe hybridizes to any known or predicted sequences in said plurality of nucleic acid molecules with at least 10% mismatched bases in said reference probe.

40. The method of claim 39, wherein said reference probe hybridizes to any known or predicted sequences in said plurality of nucleic acid molecules with at least 30% mismatched bases in said reference probe.

41. The method of claim 31, wherein said reference probe has a sequence which is a reverse complement of a sequence in said plurality of nucleic acid molecules.

42. The method of claim 31, wherein said reference probe has a sequence which is a reverse complement of said probe.

43. The method of any one of claims 32-42, wherein said second hybridization time is at least 2 times as long as said first hybridization time.

44. The method of claim 43, wherein said second hybridization time is at least 10 times as long as said first hybridization time.

45. The method of claim 44, wherein said second hybridization time is at least 16 times as long as said first hybridization time.

46. The method of claim 32, wherein said comparing comprises determining the ratio of said second hybridization level and said first hybridization level.

47. The method of claim 32, wherein said comparing comprises determining a quantity as described by equation
$$xdev = \frac{{I}_{2} - {I}_{1}}{\sqrt{{err ( {I}_{1} )}^{2} + {err ( {I}_{2} )}^{2}}}$$
wherein I₂ is said second hybridization level and I₁ is said first hybridization level, and wherein said err(I₁) and err(I₂) are expected error in I₁, and I₂, respectively.

48. The method of claim 47, wherein said err(I₁)²+err(I₂)² is defined by equation
err(I₁)²+err(I₂)²=σ₁²+σ₂²+f²(I₂²+I₁²)
wherein σ₁² is the variance for I₁, σ₂² is the variance for I₂ and f is the fractional multiplicative error level.

49. A method for determining the relative abundance of a nucleotide sequence in a plurality of samples, each of said plurality of samples comprising a plurality of nucleic acid molecules having different nucleotide sequences, said method comprising
(1) determining for each sample a difference in hybridization levels measured at a first hybridization time and a second, different hybridization time to a probe that is specific to said nucleotide sequence; and
(2) comparing said difference among said plurality of samples, thereby determining the relative abundance of said nucleotide sequence;
wherein each of said first hybridization time and second hybridization time corresponds to a different length of time said sample is allowed to hybridize with said probe.

50. The method of claim 49, wherein said first hybridization time is close to time scale for reaching cross-hybridization equilibrium and said second hybridization time is longer than said first hybridization time.

51. A method for determining the relative abundance of a nucleotide sequence in a plurality of samples, each of said plurality of samples comprising a plurality of nucleic acid molecules having different nucleotide sequences, said method comprising
(1) contacting one or more polynucleotide arrays comprising said probe with one or more of said plurality of samples under conditions such that hybridization can occur, said polynucleotide arrays comprising a positionally-addressable array of polynucleotide probes bound to a support, said polynucleotide probes comprising a plurality of polynucleotide probes of different predetermined nucleotide sequences;
(2) determining for each of said plurality of samples a first hybridization level of said probe at a first hybridization time;
(3) determining for each of said plurality of samples a second hybridization level of said probe at a second hybridization time, said second hybridization time is different from said first hybridization time;
(4) determining for each of said plurality of samples a difference in said first and second hybridization levels; and
(5) comparing said difference among said plurality of samples, thereby determining the relative abundance of said nucleotide sequence;
wherein each of said first hybridization time and second hybridization time corresponds to a different length of time said sample is allowed to hybridize with said probe.

52. The method of claim 51, wherein each of said plurality of samples is labeled with a distinguishable dye, and wherein said plurality of samples are contacted with a single polynucleotide array simultaneously.

53. The method of claim 51 or 52, wherein said plurality of samples consists of at least 3 samples.

54. The method of claim 53, wherein said plurality of samples consists of at least 5 samples.

55. The method of claim 54, wherein said plurality of samples consists of at least 10 samples.

56. A method for comparing hybridization specificity of a first probe and a second probe, said method comprising comparing (a) a first hybridization curve representing progression of level of hybridization of said first probe and (b) a second hybridization curve representing progression of level of hybridization of said second probe, wherein each said hybridization curve comprises hybridization levels measured at a plurality of different hybridization time, wherein each of said plurality of hybridization times corresponds to a different length of time said probe is allowed to hybridize with a sample.

57. The method of claim 56, wherein each of said plurality of hybridization curves is measured in real time.

58. The method of claim 56, wherein each of said plurality of hybridization curves is measured in a plurality of different experiments.

59. A method for comparing hybridization specificity of a first probe and a second probe, said method comprising
(1) determining a first hybridization curve representing progression of level of hybridization of said first probe;
(2) determining a second hybridization curve representing progression of level of hybridization of said second probe; and
(3) comparing said first hybridization curve and said second hybridization curve, hereby comparing hybridization specificity of said first probe and said second probe.

60. The method of claim 59, wherein said comparing comprises determining the value of a metric representing the difference between said first hybridization curve and said second hybridization curve.

61. The method of claim 60, wherein said metric is the difference in areas underneath said first hybridization curve and said second hybridization curve.

62. A method for comparing hybridization specificity of a first probe and a second probe, said method comprising
(1) contacting a polynucleotide array comprising said first probe and second probe with a sample comprising a plurality of nucleic acid molecules under conditions such that hybridization can occur, wherein said plurality comprises at least one nucleic acid molecule comprising a nucleotide sequence complementary to said first probe and at least one nucleic acid molecule comprising a nucleotide sequence complementary to said second probe, said polynucleotide array comprising a positionally-addressable array of polynucleotide probes bound to a support, said polynucleotide probes comprising a plurality of polynucleotide probes of different predetermined nucleotide sequences;
(2) determining a first hybridization curve I₁(t) representing progression of level of hybridization of said sample to said first probe;
(3) determining a second hybridization curve I₂(t) representing progression of level of hybridization of said sample to said second probe; and
(4) comparing said first curve and said second curve, thereby comparing hybridization specificity of said first probe and said second probe.

63. The method of claim 62, wherein said comparing comprises determining a curve representing the ratio of said first hybridization curve and said second hybridization curve.

64. The method of claim 62, wherein said comparing comprises determining a curve as described by equation
$$xdev = \frac{{I}_{2} ( t ) - {I}_{1} ( t )}{\sqrt{{err ( {I}_{1} ( t ) )}^{2} + {err ( {I}_{2} ( t ) )}^{2}}}$$
wherein said err(I₁(t)) and err(I₂(t)) are expected error in I₁ and I₂, respectively.

65. The method of claim 64, wherein said err(I₁(t))²+err(I₂(t))² is defined by equation
err(I₁(t))²+err(I₂(t))²=σ₁²+σ₂²+f²(I₂(t)²+I₁(t)²)
wherein σ₁² is the variance for I₁(t), σ₂² is the variance for I₂(t) and f is the fractional multiplicative error level.

66. The method of claim 62, wherein said comparing comprises determining the value of a metric representing the difference between said first hybridization curve and said second hybridization curve.

67. The method of claim 66, wherein said metric is the difference in areas underneath said first hybridization curve and said second hybridization curve.

68. A method for determining whether specific hybridization to a polynucleotide probe by a sample comprising a plurality of nucleic acid molecules having different nucleotide sequences occurs, said method comprising comparing-(a) a first hybridization curve representing progression of level of hybridization of said probe and (b) a second hybridization curve representing progression of level of hybridization of a reference probe, wherein said reference probe has a sequence which is not complementary to any known or predicted sequences in said sample.

69. The method of claim 68, wherein said reference probe hybridizes to any known or predicted sequences in said plurality of nucleic acid molecules with at least 3% mismatched bases in said reference probe.

70. The method of claim 69, wherein said reference probe hybridizes to any known or predicted sequences in said plurality of nucleic acid molecules with at least 10% mismatched bases in said reference probe.

71. The method of claim 70, wherein said reference probe hybridizes to any known or predicted sequences in said plurality of nucleic acid molecules with at least 30% mismatched bases in said reference probe.

72. The method of claim 68, wherein said reference probe has a sequence which is a reverse complement of a sequence in said plurality of nucleic acid molecules.

73. The method of claim 68, wherein said reference probe has a sequence which is a reverse complement of said probe.

74. The method of claim 68, wherein said comparing comprises determining the value of a metric representing the difference between said first hybridization curve and said second hybridization curve.

75. The method of claim 74, wherein said metric is the difference in areas underneath said first hybridization curve and said second hybridization curve.

76. A method for determining whether specific hybridization to a polynucleotide probe by one or more nucleic acid molecules in a sample comprising a plurality of nucleic acid molecules having different nucleotide sequences occurs, said method comprising
(1) determining a first hybridization curve representing progression of level of hybridization of said probe;
(2) determining a second hybridization curve representing progression of level of hybridization of a reference probe, wherein said reference probe has a sequence which is not complementary to any known or predicted sequences in said sample; and
(3) comparing said first hybridization curve and said second hybridization curve, thereby determining whether specific hybridization to said polynucleotide probe by one or more nucleic acid molecules in said sample occurs.

77. The method of claim 76, wherein said comparing comprises determining the value of a metric representing the difference between said first hybridization curve and said second hybridization curve.

78. The method of claim 77, wherein said metric is the difference in areas underneath said first hybridization curve and said second hybridization curve.

79. A method for determining whether specific hybridization to a polynucleotide probe by one or more nucleic acid molecules in a sample comprising a plurality of nucleic acid molecules having different nucleotide sequences occurs, said method comprising
(1) contacting a polynucleotide array comprising said probe and at least one reference probe with said sample under conditions such that hybridization can occur, said reference probe having a sequence which is not complementary to any known or predicted sequences in said sample, said polynucleotide array comprising a positionally-addressable array of polynucleotide probes bound to a support, said polynucleotide probes comprising a plurality of polynucleotide probes of different predetermined nucleotide sequences;
(2) determining a first hybridization curve representing progression of level of hybridization of said sample to said probe;
(3) determining a second hybridization curve representing progression of level of hybridization of said sample to said reference probe; and
(4) comparing said first hybridization curve and said second hybridization curve, thereby determining whether specific hybridization to said polynucleotide probe by said one or more nucleic acid molecules in said sample occurs.

80. The method of claim 78, wherein said comparing comprises determining a curve representing the ratio of said first hybridization curve and said second hybridization curve.

81. The method of claim 78, wherein said comparing comprises determining a curve as described by equation
$$xdev = \frac{{I}_{2} ( t ) - {I}_{1} ( t )}{\sqrt{{err ( {I}_{1} ( t ) )}^{2} + {err ( {I}_{2} ( t ) )}^{2}}}$$
wherein I₂ is said second hybridization level and I₁ is said first hybridization level, and wherein said err(I₁) and err(I₂) are expected error in I₁ and I₂, respectively.

82. The method of claim 81, wherein said err(I₁(t))²+err(I₂(t))² is defined by equation
err(I₁(t))²+err(I₂(t))²=σ₁²+σ₂²+f²(I₂(t)²+I₁(t)²
wherein σ₁² is the variance for I₁(t), σ₂² is the variance for I₂(t) and f is the fractional multiplicative error level.

83. The method of claim 78, wherein said comparing comprises determining the value of a metric representing the difference between said first hybridization curve and said second hybridization curve.

84. The method of claim 83, wherein said metric is the difference in areas underneath said first hybridization curve and said second hybridization curve.

85. A method for determining the difference in time scale of reaching hybridization equilibrium between specific and non-specific hybridization to a polynucleotide probe by a sample comprising a plurality of nucleic acid molecules having different nucleotide sequences, said method comprising
(1) determining time scale of reaching hybridization equilibrium from a first hybridization curve representing progression of level of hybridization of said probe, wherein said probe has a sequence which is specifically hybridizable to one or more sequences in said sample;
(2) determining time scale of reaching hybridization equilibrium from a second hybridization curve representing progression of level of hybridization of a reference probe, wherein said reference probe has a sequence which is not complementary to any known or predicted sequences in said sample; and
(3) determining the difference in time scales of reaching hybridization equilibrium at said probe and said reference probe.

86. The method of claim 85, wherein said reference probe hybridizes to any known or predicted sequences in said plurality of nucleic acid molecules with at least 3% mismatched bases in said reference probe.

87. The method of claim 86, wherein said reference probe hybridizes to any known or predicted sequences in said plurality of nucleic acid molecules with at least 10% mismatched bases in said reference probe.

88. The method of claim 87, wherein said reference probe hybridizes to any known or predicted sequences in said plurality of nucleic acid molecules with at least 30% mismatched bases in said reference probe.

89. The method of claim 85, wherein said reference probe has a sequence which is a reverse complement of a sequence in said sample and which is different from any known or predicted sequence in said sample.

90. The method of claim 85, wherein said reference probe has a sequence which is a reverse complement of said probe and which is different from any other known or predicted sequences in said sample.

91. A method for ranking a plurality of probes according to their binding specificities to their respective complementary sequence, said method comprising comparing hybridization curves representing progression of level of hybridizations of said probes.

92. A method for ranking a plurality of probes according to their binding specificities to heir respective complementary sequences, said method comprising
(1) determining a plurality of hybridization curves, each representing progression of level of hybridization of one of said plurality of probes; and
(2) comparing pair wise said plurality of curves, thereby ranking said plurality of probes according to their binding specificities.

93. The method of claim 92, wherein said comparing pair wise comprises determining the value of a metric representing the difference between said pair of hybridization curves.

94. The method of claim 93, wherein said metric is the difference in areas underneath said pair of hybridization curves.

95. A method for ranking a plurality of probes according to their binding specificities to their respective complementary sequence, said method comprising
(1) contacting a polynucleotide array comprising said plurality of probes with a sample comprising a plurality of nucleotide sequences under conditions such that hybridization can occur, wherein said plurality of nucleotide sequences comprises nucleotide sequences that are complementary to said plurality of probes, said polynucleotide array comprising a positionally-addressable array of polynucleotide probes bound to a support, said polynucleotide probes comprising a plurality of polynucleotide probes of different predetermined nucleotide sequences;
(2) determining a plurality of hybridization curves, each representing progression of level of hybridization of one of said plurality of probes; and
(3) comparing pair wise said plurality of curves, thereby ranking said plurality of probes according to their binding specificities.

96. The method of claim 95, wherein each of said plurality of nucleotide sequences that are complementary to said plurality of probes has known abundance in said sample.

97. The method of claim 95, wherein each of said plurality of nucleotide sequences that are complementary to said plurality of probes has equal abundance in said sample.

98. The method of claim 95, wherein said plurality of nucleotide sequences further comprises nucleotide sequences that are not complementary to any of said plurality of probes.

99. The method of claim 95, wherein said comparing pair wise comprises determining the value of a metric representing the difference between said pair of hybridization curves.

100. The method of claim 99, wherein said metric is the difference in areas underneath said pair of hybridization curves.

101. A method for ranking a plurality of probes according to their binding specificities to their respective complementary sequences, said method comprising
(1) determining a plurality of hybridization curves, each representing progression of level of hybridization of one of said plurality of probes;
(2) determining a hybridization curve representing progression of level of hybridization of a reference probe;
(3) comparing each of said plurality of hybridization curves of said plurality of probes with said hybridization curve of said reference probe;
(4) ranking said plurality of probes according their relative specificities to said reference probe, thereby ranking said plurality of probes according to their binding specificities.

102. The method of claim 101, wherein said comparing comprises determining the value of a metric representing the difference between said hybridization curve in said plurality of hybridization curves and said hybridization curve of said reference probe.

103. The method of claim 102, wherein said metric is the difference in areas underneath said hybridization curve in said plurality of hybridization curves and said hybridization curve of said reference probe.

104. The method of claim 101, wherein said reference curve represents cross-hybridization.

105. The method of claim 101, wherein said reference curve represents specific hybridization with known specificity.

106. A method for ranking a plurality of probes according to their binding specificities to their respective complementary sequence, said method comprising
(1) contacting a polynucleotide array comprising said plurality of probes and at least one reference probe with a sample comprising a plurality of nucleotide sequences under conditions such that hybridization can occur, wherein said plurality of nucleotide sequences in said sample comprises nucleotide sequences that are complementary to said plurality of probes, and wherein said reference probe has a sequence which is not complementary to any known or predicted sequences in said sample, said polynucleotide array comprising a positionally-addressable array of polynucleotide probes bound to a support, said polynucleotide probes comprising a plurality of polynucleotide probes of different predetermined nucleotide sequences;
(2) determining a plurality of hybridization curves, each representing progression of level of hybridization of one of said plurality of probes, and a reference hybridization curve representing progression of level of hybridization of said reference probe;
(3) comparing each of said plurality of curves representing progression of level of hybridization of said plurality of probes and said reference hybridization curve representing progression of level of hybridization of said reference probe; and
(4) ranking said plurality of probes according to their respective relative specificity with said reference probe, thereby ranking said plurality of probes according to their binding specificities.

107. The method of claim 106, wherein each of said plurality of nucleotide sequences that are complementary to said plurality of probes has known abundance in said sample.

108. The method of claim 106, wherein each said plurality of nucleotide sequences that are complementary to said plurality of probes has equal abundance in said sample.

109. The method of claim 106, wherein said plurality of nucleotide sequences further comprises nucleotide sequences that are not complementary to any of said plurality of probes.

110. The method of claim 106, wherein said comparing comprises determining the value of a metric representing the difference between each of said hybridization curves and said reference hybridization curve.

111. The method of claim 110, wherein said metric is the difference in areas underneath said pair of hybridization curves.

112. The method of claim 106, wherein said reference probe has a sequence which is not specifically hybridizable to any known or predicted sequences in said sample.

113. The method of claim 106, wherein said reference probe has a sequence which is specifically hybridizable to a sequence in said sample with known specificity.

114. A method for selecting a plurality of probes having similar binding specificities to their respective complementary sequence, said method comprising
(1) contacting a polynucleotide array comprising said plurality of probes and at least 2 one reference probe with a sample comprising a plurality of nucleotide sequences under conditions such that hybridization can occur, wherein said plurality of nucleotide sequences comprises nucleotide sequences that are complementary to said plurality of probes, and wherein said reference probe has a sequence which is specifically hybridizable to a sequence in said sample with a known specificity, said polynucleotide array comprising a positionally-addressable array of polynucleotide probes bound to a support, said polynucleotide probes comprising a plurality of polynucleotide probes of different predetermined nucleotide sequences;
(2) determining a plurality of hybridization curves, each representing progression of level of hybridization of one of said plurality of probes, and a reference hybridization curve representing progression of level of hybridization of said reference probe;
(3) comparing each of said plurality of curves representing progression of level of hybridization of said plurality of probes and said reference hybridization curve representing progression of level of hybridization of said reference probe; and
(4) selecting probes that have similar specificities as compared to said reference probe, thereby selecting probes having similar binding specificities.

115. The method of claim 114, wherein said comparing comprises determining the value of a metric representing the difference between each of said hybridization curves and said reference hybridization curve.

116. The method of claim 115, wherein said metric is the difference in areas underneath said pair of hybridization curves.

117. A method for determining the presence or absence of each of one or more nucleotide sequences in a sample comprising a plurality of nucleic acid molecules having different nucleotide sequences, said method comprising
(1) contacting a polynucleotide array comprising a plurality of probes specifically hybridizable to said one or more sequences with said sample under conditions such that hybridization can occur, said polynucleotide array comprising a positionally-addressable array of polynucleotide probes bound to a support, said polynucleotide probes comprising a plurality of polynucleotide probes of different predetermined nucleotide sequences;
(2) determining for each of said probes hybridization level at at least two different hybridization times, wherein each of said at least two different hybridization times corresponds to a different length of time said sample is allowed to hybridize with said probe;
(3) determining for each of said probes change of hybridization level by comparing hybridization levels measured at said at least two different hybridization times; and
(5) comparing each said change with a threshold value, said threshold value indicating presence of said nucleotide sequences in said sample.

118. The method of claim 117, wherein said at least two different hybridization times consists of a first hybridization time and a second hybridization time.

119. The method of claim 118, wherein said comparing comprises determining for each of said plurality of probes the ratio of said second hybridization level 12 and said first hybridization level I₁.

120. The method of claim 118, wherein said comparing comprises determining for each of said plurality of probes a quantity as described by equation
$$xdev = \frac{{I}_{2} - {I}_{1}}{\sqrt{{err ( {I}_{1} )}^{2} + {err ( {I}_{2} )}^{2}}}$$
wherein I₂ is said second hybridization level and I₁ is said first hybridization level and wherein said err(I₁) and err(I₂) are expected error in I₁ and I₂, respectively.

121. The method of claim 120, wherein said err(I₁)²+err(I₂)² is defined by equation
err(I₁)²+err(I₂)²=σ₁²+σ₂²+f² (I₂²+I₁²)
wherein σ₁² is the variance for I₁, σ₂² is the variance for I₂ and f is the fractional multiplicative error level.

122. The method of claim 118, wherein said first hybridization time is close to the time scale for substantially reaching cross-hybridization equilibrium and said second hybridization time is longer than said first hybridization time.

123. The method of claim 122, wherein said first hybridization time is long enough for hybridization level of said probe to reach at least 80% of cross-hybridization equilibrium level and said second hybridization time is longer than said first hybridization time.

124. The method of claim 123, wherein said first hybridization time is long enough for hybridization level of said probe to reach at least 90% of cross-hybridization equilibrium level and said second hybridization time is longer than said first hybridization time.

125. The method of claim 124, wherein said first hybridization time is long enough for hybridization level of said probe to reach at least 95% of cross-hybridization equilibrium level and said second hybridization time is longer than said first hybridization time.

126. The method of claim 118, wherein said first hybridization time is 1 to 4 hours.

127. The method of any one of claims 118-126, wherein said second hybridization time is at least 2 times as long as said first hybridization time.

128. The method of any one of claims 118-126, wherein said second hybridization time is at least 10 times as long as said first hybridization time.

129. The method of any one of claims 118-126, wherein said second hybridization time is at least 16 times as long as said first hybridization time.

130. A method for determining the orientation of a nucleotide sequence in a sample, said method comprising
(1) contacting a polynucleotide array comprising a forward polynucleotide probe comprising said sequence in forward direction and a reverse polynucleotide probe comprising said sequence in reverse direction with said sample under conditions such that hybridization can occur, said polynucleotide array comprising a positionally-addressable array of polynucleotide probes bound to a support, said polynucleotide probes comprising a plurality of polynucleotide probes of different predetermined nucleotide sequences;
(2) determining hybridization levels of said forward polynucleotide probe at a first plurality of hybridization times, wherein each of said first plurality of hybridization times corresponds to a different length of time said sample is allowed to hybridize with said forward polynucleotide probe;
(3) determining hybridization levels of said reverse polynucleotide probe at a second plurality of hybridization times, wherein each of said second plurality of hybridization times corresponds to a different length of time said sample is allowed to hybridize with said reverse polynucleotide probe;
(4) determining change of hybridization level of said forward polynucleotide probe by a method comprising comparing hybridization levels measured at said first plurality of hybridization times;
(5) determining change of hybridization level of said reverse polynucleotide probe by a method comprising comparing hybridization levels measured at said second plurality of hybridization times; and
(6) determining the orientation of said nucleotide sequence by a method comprising comparing said change of hybridization level of said forward polynucleotide probe with said change of hybridization level of said reverse polynucleotide probe.

131. The method of claim 130, wherein said first plurality of hybridization times consists of a first hybridization time and a second hybridization time and wherein said second plurality of hybridization times consists of a third hybridization time and a fourth hybridization time.

132. The method of claim 131, wherein said first and said third hybridization times are 1 to 4 hours, respectively.

133. The method of claim 132, wherein said second hybridization time is at least 2 times as long as said first hybridization time, and wherein said fourth hybridization time is at least 2 times as long as said third hybridization time.

134. The method of claim 133, wherein said second hybridization time is at least 16 times as long as said first hybridization time, and wherein said fourth hybridization time is at least 16 times as long as said third hybridization time.

135. The method of claim 134, wherein said second hybridization time is at least 48 times as long as said first hybridization time, and wherein said fourth hybridization time is at least 48 times as long as said third hybridization time.

136. The method of claim 135, wherein said second hybridization time is at least 72 times as long as said first hybridization time, and wherein said fourth hybridization time is at least 72 times as long as said third hybridization time.

137. The method of claim 131, wherein said comparing in said step (4) comprises determining the ratios of said second hybridization level and said first hybridization level, and wherein said comparing in said step (5) comprises determining the ratios of said fourth hybridization level and said third hybridization level.

138. The method of claim 131, wherein said comparing in said step (6) comprises determining (i) for said forward polynucleotide probe a quantity xdev_{f} as described by equation
$${xdev}_{f} = \frac{{I}_{f 2} - {I}_{f 1}}{\sqrt{{err ( {I}_{f 1} )}^{2} + {err ( {I}_{f 2} )}^{2}}}$$
and (ii) for said reverse polynucleotide probe a quantity xdev, as described by equation
$${xdev}_{r} = \frac{{I}_{r4} - {I}_{r3}}{\sqrt{{err ( {I}_{r3} )}^{2} + {err ( {I}_{r4} )}^{2}}}$$
wherein said I_{f1} and I_{f2} are hybridization levels of said forward polynucleotide probe at said first and second hybridization times, respectively, wherein said Iᵣ₃ and Iᵣ₄ are hybridization levels of said reverse polynucleotide probe at said third and fourth hybridization times, respectively, and said err(I_{f1}), err(_{f2}), err(Iᵣ₃) and err(Iᵣ₄) are expected errors in said hybridization levels I_{f1}, I_{f2}, Iᵣ₃ and Iᵣ₄, respectively.

139. The method of claim 138, wherein said nucleotide sequence is determined as forward when
xdev_{f}>th1 xdev_{f}−xdevᵣ>th2
or as reverse when
xdevᵣ>th1 xdevᵣ−xdev_{f}>th2
wherein th1 and th2 are predetermined threshold values.

140. The method of any one of claims 131-135, wherein said first hybridization time and said third hybridization time are the same, and wherein said second hybridization time and said fourth hybridization time are the same.

141. The method of claim 140, wherein the orientation of said nucleotide sequence is determined by calculating a quantity t according to equation
$$t = \frac{{I}_{f2} - {I}_{r4}}{{σ}_{{I}_{f2} - {I}_{r4}}}$$
wherein said I_{f2} is hybridization level of said forward polynucleotide probe at said second hybridization time and said Iᵣ₄ is hybridization level of said reverse polynucleotide probe at said fourth hybridization time, wherein said σₜ_{_{f2}}_{-I}_{ᵣ₄} is error of the difference between I_{f2} and Iᵣ₄, and wherein said nucleotide sequence is determined as forward if t>th, and reverse if t<−th, th being a predetermined threshold value.

142. The method of any one of claims 136-139, wherein said first hybridization time and said third hybridization time are the same, and wherein said second hybridization time and said fourth hybridization time are the same.

143. The method of claim 141, wherein hybridization levels of said forward and reverse polynucleotide probes are measured concurrently at said second and fourth hybridization times.

144. The method of claim 142, wherein hybridization levels of said forward and reverse polynucleotide probes are measured concurrently at said first and third hybridization times and at said second and fourth hybridization times.

145. A method of determining the orientation of a nucleotide sequence in the genome of an organism, comprising (i) repeating the method of any one of claims 130-139 with a plurality of samples of said organism, each said sample being subject to a different condition, and (ii) determining said orientation of said nucleotide sequence by combining results from said plurality of samples.

146. The method of any one of claims 130-139, wherein said sample comprising nucleic acid molecules pooled from a plurality of samples of an organism, each said sample being subject to a different condition.

147. The method of any one of claims 18, 31, 51, 62, 79, 95, 106, 114, or 117, wherein each probe on said array comprises a different nucleotide sequence consists of 5 to 1,000 nucleotides.

148. The method of any one of claims 18, 31, 51, 62, 79, 95, 106, 114, or 117, wherein each probe on said array comprises a different nucleotide sequence consists of 10 to 600 nucleotides.

149. The method of any one of claims 18, 31, 51, 62, 79, 95, 106, 114, or 117, wherein each probe on said array comprises a different nucleotide sequence consists of 10 to 200 nucleotides.

150. The method of any one of claims 18, 31, 51, 62, 79, 95, 106, 114, or 117, wherein each probe on said array comprises a different nucleotide sequence consists of 10 to 1100 nucleotides.

151. The method of any one of claims 18, 31, 51, 62, 79, 95, 106, 114, or 117, wherein each probe on said array comprises a different nucleotide sequence consists of 110 to 30 nucleotides.

152. The method of any one of claims 18, 31, 51, 62, 79, 95, 106, 114, or 117, wherein each probe on said array comprises a different nucleotide sequence consists of 40 to 80 nucleotides.

153. The method of any one of claims 18, 31, 51, 62, 79, 95, 106, 114, or 1117, wherein each probe on said array comprises a different nucleotide sequence consists of 60 nucleotides.

154. The method of any one of claims 18, 31, 51, 62, 79, 95, 106, 114, or 117, wherein said nucleic acid molecules in said sample are labeled.

155. The method of any one of claims 18, 31, 51, 62, 79, 95, 106, 114, or 117, wherein said nucleic acid molecules in said sample are labeled with dye molecules.

156. The method of any one of claims 18, 31, 51, 62, 79, 95, 106, 114, or 1117, wherein said nucleic acid molecules in said sample are labeled with radioactive molecules.

157. A computer system for identifying specific hybridization to a polynucleotide probe, said computer system comprising
a processor, and
a memory coupled to said processor and encoding one or more programs, wherein the one or more programs cause the processor to perform a method comprising:
(1) comparing hybridization levels of said probe at a first hybridization time and a second hybridization time, wherein said first hybridization time is close to the time scale for substantially reaching cross-hybridization equilibrium and said second hybridization time is longer than said first hybridization time; and
(2) determining the difference of hybridization levels from said comparing, said difference representing a metric for identifying specific hybridization.

158. A computer system for comparing hybridization specificity of a first probe and a second probe, said computer system comprising
a processor, and
a memory coupled to said processor and encoding one or more programs, wherein the one or more programs cause the processor to perform a method comprising:
(1) comparing a first hybridization curve representing progression of level of hybridization of said first probe and a second hybridization curve representing progression of level of hybridization of said second probe; and
(2) determining the value of a metric from said comparing, said metric representing the difference between first hybridization curve and said second hybridization curve.

159. A computer system for ranking a plurality of probes according to their binding specificities, said computer system comprising
a processor, and
a memory coupled to said processor and encoding one or more programs, wherein the one or more programs cause the processor to perform a method comprising:
(1) comparing each of two or more hybridization curves, each of said two or more hybridization curves representing progression of level of hybridization of one of said two or more probes, to a reference hybridization curve representing progression of level of hybridization of a reference probe;
(2) determining the value of a metric for each of the two or more probes from each of said comparings, the value of said metric for each of the two or more probes representing the difference between each of the two or more hybridization curves and the reference hybridization curve; and
(3) ranking the two or more probes according to the value of the metric for each of said two or more probes.

160. A computer program product for use in conjunction with a computer having a processor and a memory connected to the processor,
said computer program product comprising a computer readable storage medium having a computer program mechanism encoded thereon,
wherein the computer program mechanism may be loaded into the memory of the computer and cause the processor to execute the steps of:
(1) comparing hybridization levels of said probe at a first hybridization time and a second hybridization time, wherein said first hybridization time is close to the time scale for substantially reaching cross-hybridization equilibrium and said second hybridization time is longer than said first hybridization time; and
(2) determining the difference of hybridization levels from said comparing, said difference representing a metric for identifying specific hybridization.

161. A computer program product for use in conjunction with a computer having a processor and a memory connected to the processor,
said computer program product comprising a computer readable storage medium having a computer program mechanism encoded thereon,
wherein the computer program mechanism may be loaded into the memory of the computer and cause the processor to execute the steps of:
(1) comparing a first hybridization curve representing progression of level of hybridization of said first probe and a second hybridization curve representing progression of level of hybridization of said second probe; and
(2) determining the value of a metric from said comparing, said metric representing the difference between first hybridization curve and said second hybridization curve.

162. A computer program product for use in conjunction with a computer having a processor and a memory connected to the processor,
said computer program product comprising a computer readable storage medium having a computer program mechanism encoded thereon,
wherein the computer program mechanism may be loaded into the memory of the computer and cause the processor to execute the steps of:
(1) comparing each of two or more hybridization curves, each of said two or more hybridization curves representing progression of level of hybridization of one of said two or more probes, to a reference hybridization curve representing progression of level of hybridization of a reference probe;
(2) determining the value of a metric for each of the two or more probes from each of said comparings, the value of said metric for each of the two or more probes representing the difference between each of the two or more hybridization curves and the reference hybridization curve; and
(3) ranking the two or more probes according to the value of the metric for each of said two or more probes.
